(19) United States
(12) Patent Application Publication
(10) Pub. No.: US 2016/0268064 A1
(43) Pub. Date: Sep. 15, 2016

(54) POWER STORAGE DEVICE AND ELECTRONIC DEVICE

(71) Applicant: SEMICONDUCTOR ENERGY LABORATORY CO., LTD., Atsugi-shi (JP)

(72) Inventors: Jun ISHIKAWA, Isehara (JP); Kazuhei NARITA, Atsugi (JP); Teppei OGUNI, Atsugi (JP)

(21) Appl. No.: 15/056,353

(22) Filed: Feb. 29, 2016

(30) Foreign Application Priority Data
Mar. 9, 2015 (JP) 2015-045692
May 29, 2015 (JP) 2015-110615

(51) Int. Cl. H01G 11/62; H01G 11/52; H01M 4/587; H01M 2/16; H01M 10/0568; H01G 11/10; H01M 10/0525

(52) U.S. Cl. CPC H01G 11/62; H01G 11/10; H01G 11/52; H01M 10/0525; H01M 2/162; H01M 10/0568; H01M 4/587; H01M 2220/30; H01M 2220/20

(57) ABSTRACT

To provide a power storage device exhibiting excellent charge and discharge characteristics at high temperature. To provide a power storage device exhibiting excellent charge and discharge characteristics at a wide range of temperature. Such a power storage device includes a positive electrode, a negative electrode, a separator, and an electrolytic solution. The separator is located between the positive electrode and the negative electrode and contains polyphenylene sulfide. The electrolytic solution contains an ionic liquid and an alkali metal salt.

### BACKGROUND OF THE INVENTION

1. Field of the Invention

Embodiments of the present invention relate to a power storage device and an electronic device.

Note that one embodiment of the present invention is not limited to the above technical field. Examples of the technical field of one embodiment of the present invention include a semiconductor device, a display device, a light-emitting device, a power storage device, a storage device, an imaging device, a driving method thereof, and a manufacturing method thereof.

In this specification, the power storage device is a collective term describing elements and devices that have a power storage function. For example, a storage battery (also referred to as a secondary battery) such as a lithium-ion secondary battery, a lithium-ion capacitor, and an electric double layer capacitor are included in the category of the power storage device.

2. Description of the Related Art

In recent years, a variety of power storage devices, for example, lithium-ion secondary batteries, lithium-ion capacitors, and air cells have been actively developed. In particular, demand for lithium-ion secondary batteries with high output and high energy density has rapidly grown with the development of the semiconductor industry, for portable information terminals such as mobile phones, smartphones, and laptop computers, portable music players, and digital cameras; medical equipment; next-generation clean energy vehicles such as hybrid electric vehicles (HEV), electric vehicles (EV), and plug-in hybrid electric vehicles (PHEV); and the like. The lithium-ion secondary batteries are essential as rechargeable energy supply sources for today's information society.

As described above, lithium-ion secondary batteries have been used for a variety of purposes in various fields. Properties necessary for such lithium-ion secondary batteries are high energy density, excellent cycle performance, safety in a variety of operation environments, and the like.

Many of the widely used lithium-ion secondary batteries contain an electrolytic solution including a nonaqueous solvent and a lithium salt containing lithium ions. An example of an organic solvent often used in the electrolytic solution is an organic solvent which has a high dielectric constant and excellent ionic conductivity, such as ethylene carbonate.

However, the above organic solvents each have volatility and a low flash point; thus, when any of the organic solvents is used in a lithium-ion secondary battery, the lithium-ion secondary battery could internally short out or the internal temperature of the lithium-ion secondary battery could increase owing to overcharging or the like, so that the lithium-ion secondary battery would explode or catch fire.

In view of the above, the use of an ionic liquid (also referred to as a room temperature molten salt) with non-flammability and non-volatility as a solvent of an electrolytic solution of a lithium-ion secondary battery has been proposed. Examples of such an ionic liquid are an ionic liquid containing ethylmethylimidazolium (EMI) cation, an ionic liquid containing an N-methyl-N-propylpyrrolidinium (P13) cation, and an ionic liquid containing an N-methyl-N-propylpiperidinium (PP13) cation (see Patent Document 1)

Improvements have been made to an anion component and a cation component of an ionic liquid to provide a lithium-ion secondary battery which uses an ionic liquid with low viscosity, a low melting point, and high conductivity (see Patent Document 2).

### REFERENCE

### [Patent Document 1] Japanese Published Patent Application No. 2003-331918

[Patent Document 2] PCT International Publication No. WO2005063773

### SUMMARY OF THE INVENTION

Electronic devices are used in a variety of environments; therefore, secondary batteries that can be used for electronic devices at a wide range of temperature are required. For example, secondary batteries that can be used even in the following environment are required: a place exposed to direct sunlight, such as a dashboard of a car or by the window, inside of a sun-heated car, at high temperature, e.g., a desert, or a low-temperature environment, e.g., a cold region with a glacier.

An object of one embodiment of the present invention is to provide a power storage device exhibiting excellent charge and discharge characteristics at high temperature. Another object of one embodiment of the present invention is to provide a power storage device exhibiting excellent charge and discharge characteristics at a wide range of temperature.

Another object of one embodiment of the present invention is to provide a power storage device having high long-term reliability at high temperature. Another object of one embodiment of the present invention is to provide a power storage device having high long-term reliability at a wide range of temperature.

Another object of one embodiment of the present invention is to provide a power storage device having a high level of safety at high temperature. Another object of one embodiment of the present invention is to provide a power storage device having a high level of safety at a wide range of temperature.

Another object of one embodiment of the present invention is to provide a power storage device having high flexibility. Another object of one embodiment of the present invention is to provide a novel power storage device, a novel electronic device, or the like.

Note that the description of these objects do not disturb the existence of other objects. In one embodiment of the present invention, there is no need to achieve all the objects. Other objects can be derived from the description of the specification, the drawings, and the claims.

One embodiment of the present invention is a power storage device including a positive electrode, a negative electrode, a separator, and an electrolytic solution. The separator is located between the positive electrode and the negative electrode. The separator contains polyphenylene sulfide. The electrolytic solution contains an ionic liquid and an alkali metal salt.

In the above structure, the alkali metal salt is preferably a lithium salt.

In the above structure, the ionic liquid contains a cation and an anion. The cation preferably contains a five-membered heteroaromatic ring with one or more substituents, and the total number of carbons in the one or more substituents is preferably more than or equal to 2 and less than or equal to 10. The cation is particularly preferably an imidazolium cation, more preferably a 1-butyl-3-methylimidazolium cation.

In the above structure, the negative electrode preferably contains graphite.

The power storage device with the above structure preferably has flexibility.

The discharge capacity at 0° C. of the power storage device with the above structure is preferably 80% or more of that at 25° C., and the discharge capacity at 100° C. thereof is preferably 80% or more of that at 25° C.

Another embodiment of the present invention is an electronic device that includes the power storage device with the above structure, and a display device, an operation button, an external connection port, an antenna, a speaker, or a microphone.

One embodiment of the present invention can provide a power storage device having excellent charge and discharge characteristics at high temperature. One embodiment of the present invention can provide a power storage device having excellent charge and discharge characteristics at a wide range of temperature.

One embodiment of the present invention can provide a power storage device having high long-term reliability at high temperature. One embodiment of the present invention can provide a power storage device having high long-term reliability at a wide range of temperature.

One embodiment of the present invention can provide a power storage device having a high level of safety at high temperature. One embodiment of the present invention can provide a power storage device having a high level of safety at a wide range of temperature.

One embodiment of the present invention can provide a power storage device having high flexibility. One embodiment of the present invention can provide a novel power storage device, a novel electronic device, or the like.

Note that the description of these effects does not disturb the existence of other effects. One embodiment of the present invention does not necessarily have all the effects listed above. Other effects can be derived from the description of the specification, the drawings, and the claims.

### BRIEF DESCRIPTION OF THE DRAWINGS

FIGS. 1A to 1C illustrate an example of a power storage device and examples of electrodes.

FIGS. 2A and 2B each show an example of a power storage device.

FIGS. 3A and 3B each show an example of a power storage device.

FIG. 4 illustrates an example of a power storage device.

FIGS. 5A and 5B illustrate an example of a method for fabricating a power storage device.

FIGS. 6A to 6C illustrate an example of a method for fabricating a power storage device.

FIG. 7 illustrates an example of a method for fabricating a power storage device.

FIGS. 8A and 8B illustrate an example of a power storage device.

FIGS. 9A and 9B illustrate an example of a power storage device.

FIGS. 10A and 10B illustrate an example of a power storage device.

FIGS. 11A and 11B illustrate an example of a cylindrical storage battery.

FIGS. 12A to 12C illustrate an example of a coin-type storage battery.

FIGS. 13A and 13B illustrate an example of a power storage system.

FIGS. 14A1, 14A2, 14B1, and 14B2 each illustrate an example of a power storage system.

FIGS. 15A and 15B each illustrate an example of a power storage system.

FIGS. 16A and 16B illustrate an example of a power storage device.

FIGS. 17A and 17B illustrate an example of a power storage device.

FIG. 18 illustrates an example of a power storage device.

FIGS. 19A to 19D illustrate an example of a method for fabricating a power storage device.

FIGS. 20A, 20B, 20C1, and 20C2 illustrate an example of a power storage device.

FIG. 21 illustrates an example of a power storage device.

FIGS. 22A to 22D illustrate an example of a method for fabricating a power storage device.

FIG. 23 illustrates an example of a power storage device.

FIGS. 24A to 24G illustrate examples of electronic devices.

FIGS. 25A to 25C illustrate an example of an electronic device.

FIG. 26 illustrates examples of electronic devices.

FIGS. 27A to 27G illustrate examples of electronic devices.

FIG. 28 is a graph showing charge and discharge cycle performances in Example 1.

FIG. 29 is a graph showing charge and discharge cycle performances in Example 1.

FIG. 30 shows results of weight loss measurement in Example 2.

FIG. 31 shows results of differential thermal analysis in Example 2.

FIG. 32 shows weight decrease amounts in Example 2.

FIGS. 33A to 33D each show discharge curves in Example 3.

FIGS. 34A to 34D each show discharge curves in Example 3.

FIGS. 35A to 35C each show rate characteristics in Example 3.

FIGS. 36A to 36D each show discharge curves in Example 3.

FIGS. 37A to 37D each show discharge curves in Example 3.

FIGS. 38A to 38C each show temperature characteristics in Example 3.

FIGS. 39A to 39D each show charge and discharge curves in Example 3.

FIGS. 40A to 40C each show charge and discharge cycle performance in Example 3.

FIGS. 41 to 41C each show charge and discharge cycle performance in Example 3.

FIGS. 42A and 42B each show charge and discharge curves in Example 3.

FIGS. 43A to 43C each show charge and discharge cycle performance in Example 3.

FIGS. 44A to 44D each show charge and discharge curves in Example 3.

FIGS. 45A to 45C each show charge and discharge cycle performance in Example 3.

FIG. 46 shows charge and discharge cycle performances in Example 4.

FIG. 47 shows rate characteristics in Example 5.

FIG. 48 shows charge and discharge cycle performances in Example 6.

FIG. 49 shows charge and discharge cycle performances in Example 6.

FIGS. 50A to 50D are each a SEM image of a negative electrode in Example 6.

FIG. 51 shows rate characteristics in Example 7.

FIG. 52 shows charge and discharge curves in Example 8.

FIGS. 53A and 53B each show charge and discharge cycle performance in Example 8.

FIGS. 54A and 54B show a light-emitting device in Example 9.

FIGS. 55A and 55B show a light-emitting device in Example 9.

FIGS. 56A and 56B each show charge and discharge curves in Example 3.

FIGS. 57A to 57C each show charge and discharge cycle performance in Example 3.

FIGS. 58A to 58C each show charge and discharge cycle performance in Example 3.

FIGS. 59A to 59C each show charge and discharge curves in Example 10.

FIGS. 60A and 60B each show charge and discharge cycle performance in Example 10.

FIGS. 61A and 61B each show charge and discharge cycle performance in Example 10.

FIGS. 62A and 62B each show charge and discharge cycle performance in Example 10.

FIGS. 63A to 63D each show charge and discharge curves in Example 11.

FIGS. 64A and 64B each show rate characteristics in Example 11.

FIGS. 65A to 65D each show discharge curves in Example 11.

FIGS. 66A and 66B each show temperature characteristics in Example 11.

FIGS. 67A to 67F are photographs each showing a result of a combustion test in Example 12.

FIGS. 68A to 68E illustrate a power storage device in Example 13.

FIGS. 69A to 69C show a test machine in Example 13.

FIGS. 70A and 70B each show discharge curves in Example 13.

FIGS. 71A to 71D are X-ray CT images in Sample 13A.

FIGS. 72A to 72C each show results of thermogravimetry-differential thermal analysis mass spectrometry in Example 2.

FIGS. 73A to 73C each show results of thermogravimetry-differential thermal analysis mass spectrometry in Example 2.

FIGS. 74A to 74C each show results of thermogravimetry-differential thermal analysis mass spectrometry in Example 2.

FIGS. 75A to 75D show charge and discharge curves and a charge curve in Example 14.

### DETAILED DESCRIPTION OF THE INVENTION

Embodiments will be described in detail with reference to drawings. Note that the present invention is not limited to the description below, and it is easily understood by those skilled in the art that various changes and modifications can be made without departing from the spirit and scope of the present invention. Accordingly, the present invention should not be interpreted as being limited to the content of the embodiments below.

Note that in the structures of the invention described below, the same portions or portions having similar functions are denoted by the same reference numerals in different drawings, and the descriptions of such portions are not repeated. Furthermore, the same hatching pattern is applied to portions having similar functions, and the portions are not specially denoted by reference numerals in some cases.

In addition, the position, size, range, or the like of each structure illustrated in drawings is not accurately represented in some cases for easy understanding. Therefore, the disclosed invention is not necessarily limited to the position, size, range, or the like disclosed in the drawings.

Note that the terms “film” and “layer” can be interchanged with each other depending on the case or circumstances. For example, the term “conductive layer” can be changed into the term “conductive film”. Also, the term “insulating film” can be changed into the term “insulating layer”.

### Embodiment 1

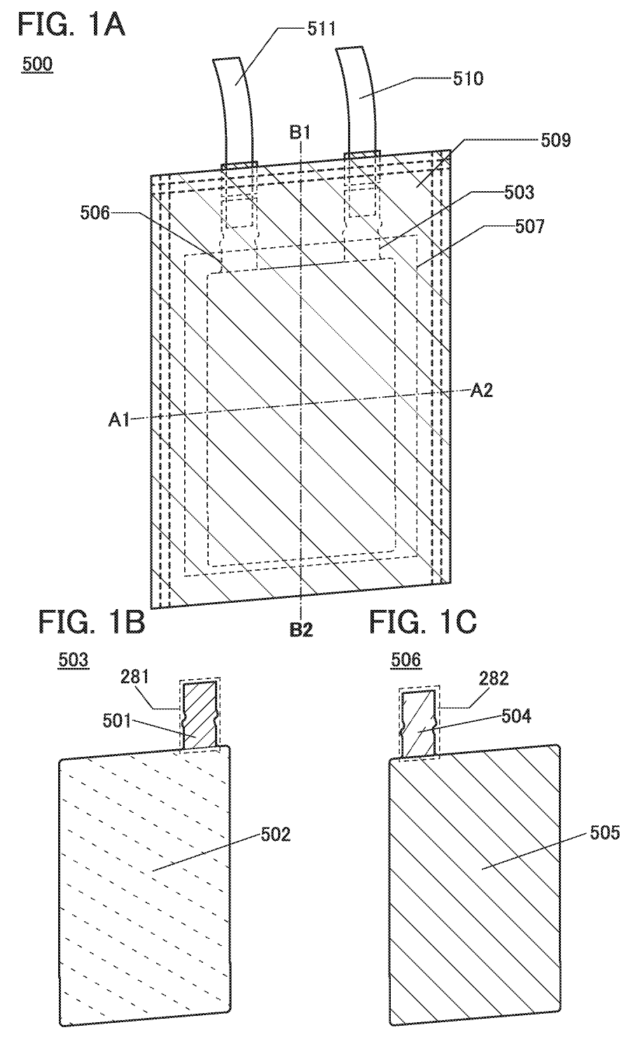

In this embodiment, a power storage device of one embodiment of the present invention will be described with reference to FIGS. 1A to 1C to FIG. 7.

Although a lithium-ion secondary battery is described as an example in this embodiment, one embodiment of the present invention is not limited to this example. One embodiment of the present invention can be used for any of a battery, a primary battery, a secondary battery, a lithium air battery, a lead storage battery, a lithium-ion polymer secondary battery, a nickel-hydrogen storage battery, a nickel-cadmium storage battery, a nickel-iron storage battery, a nickel-zinc storage battery, a silver oxide-zinc storage battery, a solid-state battery, an air cell, a zinc-air battery, a capacitor, a lithium-ion capacitor, an electric double layer capacitor, an ultracapacitor, a supercapacitor, and the like.

The power storage device of one embodiment of the present invention includes a positive electrode, a negative electrode, a separator, and an electrolytic solution.

Note that in this specification and the like, the electrolytic solution is not limited to a liquid one and may be a gelled or solid one.

The use of a nonflammable, nonvolatile ionic liquid as a solvent of the electrolytic solution allows the safety of the power storage device to be improved compared with the use of an organic solvent.

In a power storage device, an electrolytic solution might be decomposed by charge and discharge. The decomposition reaction of an electrolytic solution is an irreversible reaction in many cases and thus might lead to the loss of the capacity of a power storage device.

For example, an irreversible reaction in charging reduces the discharge capacity such that it is lower than the charge capacity.

Furthermore, an irreversible reaction in discharging might reduce the charge capacity in the next charge and discharge cycle such that it is lower than the discharge capacity. That is to say, when irreversible reactions repeatedly occur, the capacity might gradually decrease with the increasing number of charge and discharge cycles.

Cellulose and the like generally used for a separator are weak against heat. Thus, an electrolytic solution using an ionic liquid and such a separator react with each other at high temperature in some cases. This reaction might decompose the electrolytic solution. Thus, when a power storage device including a separator and an electrolytic solution using an ionic liquid is operated at high temperature, the electrolytic solution might be decomposed; consequently, the irreversible capacity might increase, resulting in a decrease in capacity with the increasing number of charge and discharge cycles.

In view of the above problems, in the power storage device of one embodiment of the present invention, a separator containing polyphenylene sulfide and an electrolytic solution containing an ionic liquid and an alkali metal salt are used. Here, the electrolytic solution contains an ionic liquid and an alkali metal salt, but the ionic liquid and the alkali metal salt are not necessarily bonded to each other.

The separator containing polyphenylene sulfide has high heat resistance and high chemical resistance.

Furthermore, the separator containing polyphenylene sulfide has lower reactivity with an ionic liquid at high temperature than a separator containing cellulose, or the like. Thus, even when the power storage device is operated at high temperature, the decomposition of the electrolytic solution can be inhibited, leading to inhibition of degradation of the output characteristics and the charge and discharge cycle performance.

For example, the use of the separator containing polyphenylene sulfide can more effectively improve the charge and discharge cycle performance at 100° C. of the power storage device than the use of a separator containing polyolefin, glass, or cellulose. Note that the power storage device of one embodiment of the present invention may be operated at temperatures higher than 100° C.

The use of the separator containing polyphenylene sulfide can achieve high charge and discharge capacity and high charge and discharge cycle performance at a wide range of temperature. That is, the power storage device of one embodiment of the present invention is capable of operating even at temperatures close to room temperature and at low temperature as well as at high temperature.

For example, the use of the separator containing polyphenylene sulfide allows fabrication of a power storage device that is capable of operating at temperatures in the range of 0° C. to 80° C. inclusive, 0° C. to 100° C. inclusive, or −25° C. to 125° C. inclusive. Note that the power storage device of one embodiment of the present invention may be operated at temperatures lower than −25° C.

Covering the power storage device of one embodiment of the present invention with a film or a case of plastic or the like enables its operation in water at higher than or equal to 0° C. and lower than or equal to 100° C., for example.

### <<Separator>>

The separator can have either a single-layer structure or a layered structure and may have a layered structure of a separator containing polyphenylene sulfide and another separator.

Examples of a material that can be used for the separator include paper, nonwoven fabric, glass fiber, ceramics, synthetic fiber such as nylon (polyamide), vinylon (a polyvinyl alcohol based fiber), polyester, acrylic, polyolefin, or polyurethane, and the like in addition to polyphenylene sulfide.

More specifically, as a material for the separator, one or more of the following can be used: polyphenylene sulfide, a fluorine-based polymer, polyethers such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, nonwoven fabric, and fiberglass.

### <<Electrolytic Solution>>

The electrolytic solution contains an ionic liquid and an alkali metal salt. The electrolytic solution may contain another material. Alternatively, the electrolytic solution may contain a plurality of kinds of ionic liquids and some kinds of alkali metal salts.

The use of one or more kinds of ionic liquids can prevent a power storage device from exploding or catching fire even when a power storage device internally shorts out or the internal temperature increases owing to overcharging or the like. An ionic liquid contains a cation and an anion. The ionic liquid of one embodiment of the present invention contains an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

A cation in an ionic liquid preferably contains a five-membered heteroaromatic ring with one or more substituents, and the total number of carbons in the one or more substituents is preferably more than or equal to 2 and less than or equal to 10. The total number of carbons is preferably less than or equal to 10 because too large a number of carbons increases the viscosity of an ionic liquid and reduces the conductivity thereof in some cases.

In particular, the cation is preferably a 1-butyl-3-methylimidazolium (BMI) cation.

Graphite, which can be used for the negative electrode, is preferable because of its advantages such as relatively high capacity per volume, small volume expansion, low cost, and greater safety than that of a lithium metal. A cation and an anion in an ionic liquid are intercalated between layers of an intercalation compound typified by graphite in some cases. The reactions is irreversible in many cases. The cation and the anion intercalated between the layers of the intercalation compound might be decomposed or deintercalated after the intercalation. When the cation and the anion are decomposed between graphite layers, a gap between the graphite layers might be widened and graphite might be expanded. When the graphite particles are expanded, they cannot be charged or discharged, leading to a decrease in charge and discharge capacity. Furthermore, the expanded graphite particles have large surface area; therefore, the electrolytic solution is more likely to be decomposed at the negative electrode.

Charge consumption for the decomposition reaction of a cation and an anion might inhibit the battery reaction of carrier ions (e.g., lithium ions), reducing charge and discharge capacity. Furthermore, the decomposition of the electrolytic solution on a surface of an active material layer or a current collector might increase irreversible capacity, resulting in a decrease in capacity with an increasing number of charge and discharge cycles.

A BMI cation is less likely to be intercalated between graphite layers than an EMI cation. For this reason, the use of BMI cations can inhibit generation of expanded graphite, which causes a decrease in charge and discharge capacity, and can inhibit the decomposition of the electrolytic solution. Thus, the use of BMI cations allows graphite to be effectively used for the negative electrode, so that a power storage device having favorable charge and discharge cycle performance can be fabricated.

The alkali metal salt is preferably a lithium salt.

When an electrolytic solution containing a sodium salt is used, favorable output characteristics tend to be obtained at high temperature (e.g., at higher than or equal to 100° C. and lower than or equal to 200° C.), but inferior output characteristics tend to be obtained at room temperature (e.g., at 25° C.).

In the power storage device of one embodiment of the present invention, a lithium salt is used, whereby favorable output characteristics and favorable charge and discharge cycle performance both at temperatures close to a room temperature and at high temperature can be achieved. The use of one embodiment of the present invention enables a discharge capacity that is 80% or more of the discharge capacity at 25° C. both at 0° C. and at 100° C., for example.

In the case of using lithium ions as carriers, as a salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(FSO₂)₂, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolytic solution used for a power storage device is preferably highly purified and contains a small amount of dust particles and elements other than the constituent elements of the electrolytic solution (hereinafter, also simply referred to as impurities). Specifically, the weight ratio of impurities to the electrolytic solution is less than or equal to 1%, preferably less than or equal to 0.1%, and more preferably less than or equal to 0.01%.

Furthermore, an additive agent such as vinylene carbonate (VC), propane sultone (PS), tert-butylbenzene (TBB), fluoroethylene carbonate (FEC), or LiBOB may be added to the electrolytic solution. The concentration of such an additive agent in the whole solvent can be, for example, higher than or equal to 0.1 wt % and lower than or equal to 5 wt %.

Alternatively, a polymer gelled electrolyte obtained in such a manner that a polymer is swelled with an electrolytic solution may be used.

Examples of a host polymer include a polymer having a polyalkylene oxide structure, such as polyethylene oxide (PEO); poly(vinylidene fluoride) (PVdF); polyacrylonitrile; and a copolymer containing any of them. For example, PVdF-HFP, which is a copolymer of PVdF and hexafluoropropylene (HFP) can be used. The polymer may be porous.

An electrolytic solution may be gelated by adding a polymerization initiator and a cross-linking agent to the electrolytic solution. For example, the ionic liquid itself may be polymerized in such a manner that a polymerizable functional group is introduced into a cation or an anion of the ionic liquid and polymerization thereof is caused with the polymerization initiator. Then, the polymerized ionic liquid may be gelated with a cross-linking agent.

In combination with the electrolytic solution, a solid electrolyte including an inorganic material such as a sulfide-based inorganic material and an oxide-based inorganic material, or a solid electrolyte including a macromolecular material such as a polyethylene oxide (PEO)-based macromolecular material may alternatively be used. For example, the solid electrolyte may be formed over a surface of the active material layer. In the case of using the solid electrolyte and the electrolytic solution in combination, at least one of a separator and a spacer does not need to be provided in some cases.

When a macromolecular material that undergoes gelation is used as the solvent for the electrolytic solution, safety against liquid leakage and the like is improved. Furthermore, the power storage device can be thinner and more lightweight. For example, a polyethylene oxide-based polymer, a polyacrylonitrile-based polymer, a polyvinylidene fluoride-based polymer, a polyacrylate based polymer, and a polymethacrylate-based polymer can be used. A polymer which can gelate the electrolytic solution at normal temperature (e.g., 25° C.) is preferably used. Alternatively, a silicone gel may be used. In this specification and the like, the term polyvinylidene fluoride-based polymer, for example, refers to a polymer including polyvinylidene fluoride (PVdF), and includes a poly(vinylidene fluoride-hexafluoropropylene) copolymer and the like.

The above polymer can be qualitatively analyzed using a Fourier transform infrared (FT-IR) spectrometer or the like. For example, the polyvinylidene fluoride-based polymer has an absorption peak showing a C—F bond in a spectrum obtained with the FT-IR spectrometer. Furthermore, the polyacrylonitrile-based polymer has an absorption peak showing a C≡N bond in a spectrum obtained with the FT-IR spectrometer.

As a solvent of the electrolytic solution, an aprotic organic solvent can be used. For example, one of ethylene carbonate (EC), propylene carbonate (PC), butylene carbonate, chloroethylene carbonate, vinylene carbonate (VC), γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Next, a specific structure of the power storage device of one embodiment of the present invention will be described below.

FIG. 1A illustrates a battery cell 500, which is a power storage device of one embodiment of the present invention. Although FIG. 1A illustrates a mode of a thin storage battery as an example of the battery cell 500, one embodiment of the present invention is not limited to this example.

As illustrated in FIG. 1A, the battery cell 500 includes a positive, a negative electrode 506, a separator 507, and an exterior body 509. The battery cell 500 may include a positive electrode lead 510 and a negative electrode lead 511.

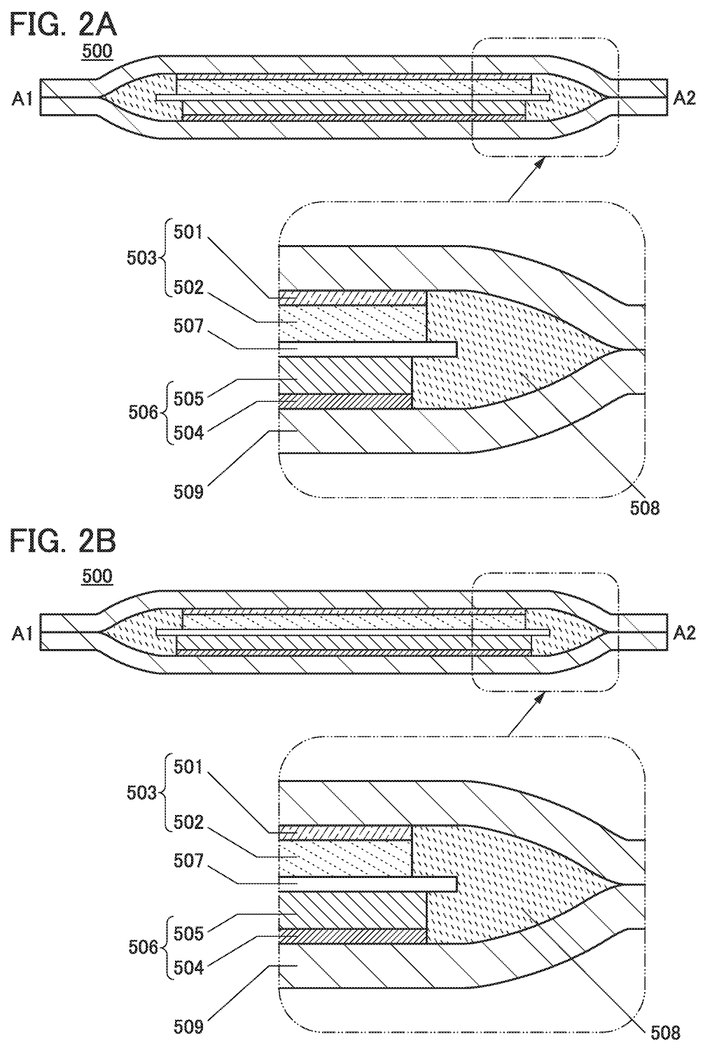

FIGS. 2A and 2B each illustrate an example of a cross-sectional view along dashed-dotted line A1-A2 in FIG. 1A. FIGS. 2A and 2B each illustrate a cross-sectional structure of the battery cell 500 that is formed using a pair of the positive electrode 503 and the negative electrode 506.

As illustrated in FIGS. 2A and 2B, the battery cell 500 includes the positive electrode 503, the negative electrode 506, the separator 507, an electrolytic solution 508, and the exterior bodies 509. The separator 507 is interposed between the positive electrode 503 and the negative electrode 506. A region surrounded by the exterior bodies 509 is filled with the electrolytic solution 508.

The positive electrode 503 includes a positive electrode active material layer 502 and a positive electrode current collector 501. The negative electrode 506 includes a negative electrode active material layer 505 and a negative electrode current collector 504. The active material layer is formed on one surface or opposite surfaces of the current collector. The separator 507 is positioned between the positive electrode current collector 501 and the negative electrode current collector 504.

The battery cell includes one or more positive electrodes and one or more negative electrodes. For example, the battery cell can have a layered structure including a plurality of positive electrodes and a plurality of negative electrodes.

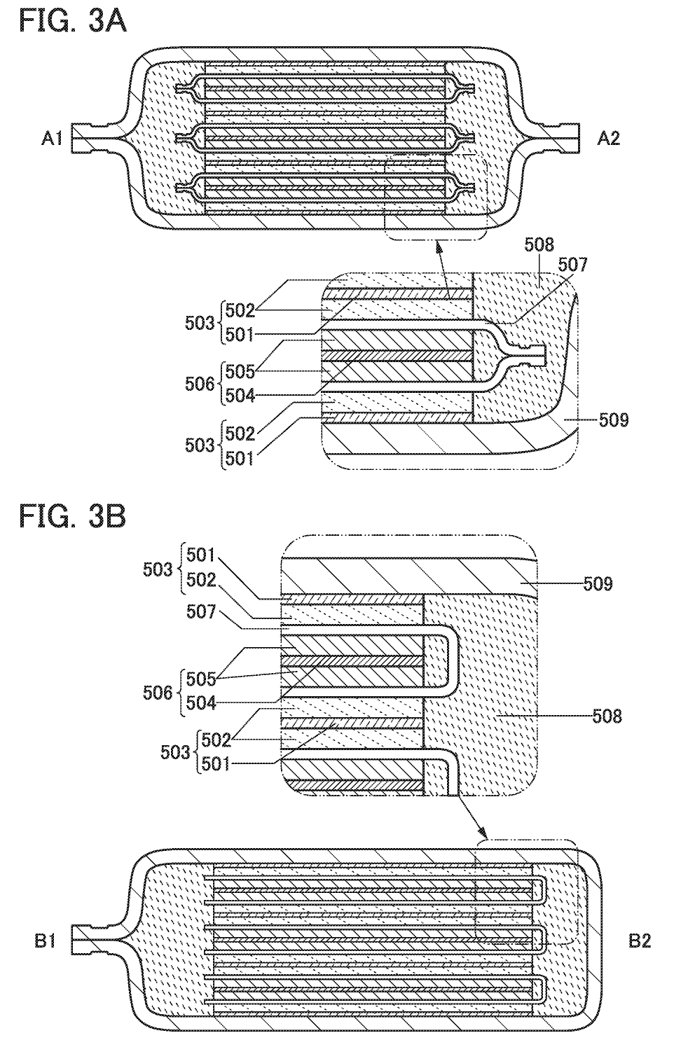

FIG. 3A illustrates another example of a cross-sectional view along dashed-dotted line A1-A2 in FIG. 1A. FIG. 3B is a cross-sectional view along dashed-dotted line B1-B2 in FIG. 1A.

FIGS. 3A and 3B each illustrate a cross-sectional structure of the battery cell 500 that is formed using a plurality of pairs of the positive and negative electrodes 503 and 506. There is no limitation on the number of electrode layers of the battery cell 500. In the case of using a large number of electrode layers, the power storage device can have high capacity. In contrast, in the case of using a small number of electrode layers, the power storage device can have a small thickness and high flexibility.

The examples in FIGS. 3A and 3B each include two positive electrodes 503 in each of which the positive electrode active material layer 502 is provided on one surface of the positive electrode current collector 501; two positive electrodes 503 in each of which the positive electrode active material layers 502 are provided on opposite surfaces of the positive electrode current collector 501; and three negative electrodes 506 in each of which the negative electrode active material layers 505 are provided on opposite surfaces of the negative electrode current collector 504. In other words, the battery cell 500 includes six positive electrode active material layers 502 and six negative electrode active material layers 505. Note that although the separator 507 has a bag-like shape in the examples illustrated in FIGS. 3A and 3B, the present invention is not limited to this example and the separator 507 may have a strip shape or a bellows shape.

FIG. 1B illustrates the appearance of the positive electrode 503. The positive electrode 503 includes the positive electrode current collector 501 and the positive electrode active material layer 502.

FIG. 1C illustrates the appearance of the negative electrode 506. The negative electrode 506 includes the negative electrode current collector 504 and the negative electrode active material layer 505.

The positive electrode 503 and the negative electrode 506 preferably include tab regions so that a plurality of stacked positive electrodes can be electrically connected to each other and a plurality of stacked negative electrodes can be electrically connected to each other. Furthermore, a lead electrode is preferably electrically connected to the tab region.

As illustrated in FIG. 1B, the positive electrode 503 preferably includes the tab region 281. The positive electrode lead 510 is preferably welded to part of the tab region 281. The tab region 281 preferably includes a region where the positive electrode current collector 501 is exposed. When the positive electrode lead 510 is welded to the region where the positive electrode current collector 501 is exposed, contact resistance can be further reduced. Although FIG. 1B illustrates the example where the positive electrode current collector 501 is exposed in the entire tab region 281, the tab region 281 may partly include the positive electrode active material layer 502.

As illustrated in FIG. 1C, the negative electrode 506 preferably includes the tab region 282. The negative electrode lead 511 is preferably welded to part of the tab region 282. The tab region 282 preferably includes a region where the negative electrode current collector 504 is exposed. When the negative electrode lead 511 is welded to the region where the negative electrode current collector 504 is exposed, contact resistance can be further reduced. Although FIG. 1C illustrates the example where the negative electrode current collector 504 is exposed in the entire tab region 282, the tab region 282 may partly include the negative electrode active material layer 505.

Although FIG. 1A illustrates the example where the ends of the positive electrode 503 and the negative electrode 506 are substantially aligned with each other, part of the positive electrode 503 may extend beyond the end of the negative electrode 506.

In the battery cell 500, the area of a region where the negative electrode 506 does not overlap with the positive electrode 503 is preferably as small as possible.

In the example illustrated in FIG. 2A, the end of the negative electrode 506 is located inward from the end of the positive electrode 503. With this structure, the entire negative electrode 506 can overlap with the positive electrode 503 or the area of the region where the negative electrode 506 does not overlap with the positive electrode 503 can be small.

The areas of the positive electrode 503 and the negative electrode 506 in the battery cell 500 are preferably substantially equal. For example, the areas of the positive electrode 503 and the negative electrode 506 that face each other with the separator 507 therebetween are preferably substantially equal. For example, the areas of the positive electrode active material layer 502 and the negative electrode active material layer 505 that face each other with the separator 507 therebetween are preferably substantially equal.

For example, as illustrated in FIGS. 3A and 3B, the area of the positive electrode 503 on the separator 507 side is preferably substantially equal to the area of the negative electrode 506 on the separator 507 side. When the area of a surface of the positive electrode 503 on the negative electrode 506 side is substantially equal to the area of a surface of the negative electrode 506 on the positive electrode 503 side, the region where the negative electrode 506 does not overlap with the positive electrode 503 can be small (does not exist, ideally), whereby the battery cell 500 can have reduced irreversible capacity. Alternatively, as illustrated in FIGS. 3A and 3B, the area of the surface of the positive electrode active material layer 502 on the separator 507 side is preferably substantially equal to the area of the surface of the negative electrode active material layer 505 on the separator 507 side.

As illustrated in FIGS. 3A and 3B, the end of the positive electrode 503 and the end of the negative electrode 506 are preferably substantially aligned with each other. Ends of the positive electrode active material layer 502 and the negative electrode active material layer 505 are preferably substantially aligned with each other.

In the example illustrated in FIG. 2B, the end of the positive electrode 503 is located inward from the end of the negative electrode 506. With this structure, the entire positive electrode 503 can overlap with the negative electrode 506 or the area of the region where the positive electrode 503 does not overlap with the negative electrode 506 can be small. In the case where the end of the negative electrode 506 is located inward from the end of the positive electrode 503, a current sometimes concentrates at the end portion of the negative electrode 506. For example, concentration of a current in part of the negative electrode 506 results in deposition of lithium on the negative electrode 506 in some cases. By reducing the area of the region where the positive electrode 503 does not overlap with the negative electrode 506, concentration of a current in part of the negative electrode 506 can be inhibited. As a result, for example, deposition of lithium on the negative electrode 506 can be inhibited, which is preferable.

As illustrated in FIG. 1A, the positive electrode lead 510 is preferably electrically connected to the positive electrode 503. Similarly, the negative electrode lead 511 is preferably electrically connected to the negative electrode 506. The positive electrode lead 510 and the negative electrode lead 511 are exposed to the outside of the exterior body 509 so as to serve as terminals for electrical contact with an external portion.

The positive electrode current collector 501 and the negative electrode current collector 504 can double as terminals for electrical contact with an external portion. In that case, the positive electrode current collector 501 and the negative electrode current collector 504 may be arranged such that part of the positive electrode current collector 501 and part of the negative electrode current collector 504 are exposed to the outside of the exterior body 509 without using lead electrodes.

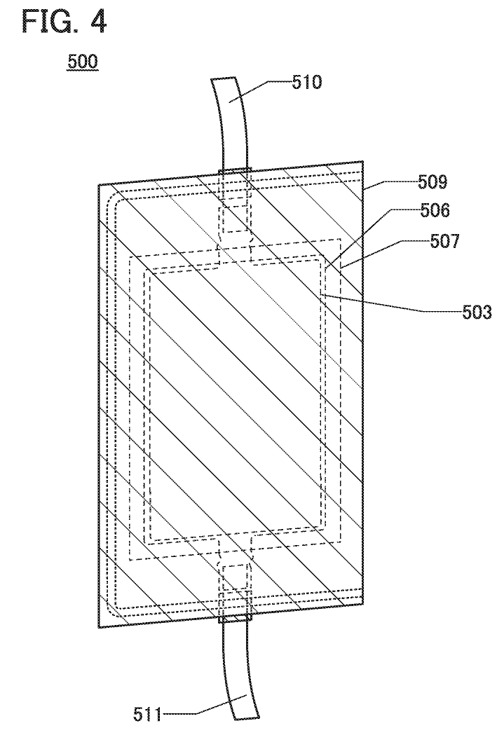

Although the positive electrode lead 510 and the negative electrode lead 511 are provided on the same side of the battery cell 500 in FIG. 1A, the positive electrode lead 510 and the negative electrode lead 511 may be provided on different sides of the battery cell 500 as illustrated in FIG. 4. The lead electrodes of the battery cell of one embodiment of the present invention can be freely positioned as described above; therefore, the degree of freedom in design is high. Accordingly, a product including the battery cell of one embodiment of the present invention can have a high degree of freedom in design. Furthermore, a yield of products each including the battery cell of one embodiment of the present invention can be increased.

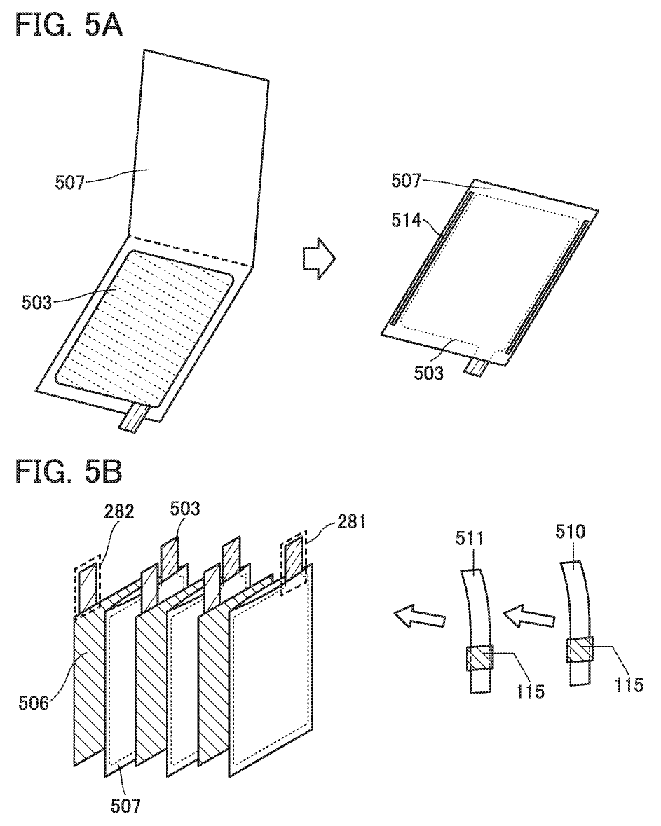

Next, an example of a fabricating method for the battery cell 500 will be described with reference to FIGS. 5A and 5B to FIG. 7.

First, the positive electrode 503, the negative electrode 506, and the separator 507 are stacked. Specifically, the separator 507 is positioned over the positive electrode 503. Then, the negative electrode 506 is positioned over the separator 507. In the case of using two or more positive electrode-negative electrode pairs, another separator 507 is positioned over the negative electrode 506, and then, the positive electrode 503 is positioned. In this manner, the positive electrodes 503 and the negative electrodes 506 are alternately stacked and separated by the separator 507.

Alternatively, the separator 507 may have a bag-like shape. The electrode is preferably surrounded by the separator 507, in which case the electrode is less likely to be damaged during a fabricating process.

First, the positive electrode 503 is positioned over the separator 507. Then, the separator 507 is folded along a broken line in FIG. 5A so that the positive electrode 503 is sandwiched by the separator 507. Although the example where the positive electrode 503 is sandwiched by the separator 507 is described here, the negative electrode 506 may be sandwiched by the separator 507.

Here, the outer edges of the separator 507 outside the positive electrode 503 are bonded so that the separator 507 has a bag-like shape (or an envelope-like shape). The bonding of the outer edges of the separator 507 can be performed with the use of an adhesive or the like, by ultrasonic welding, or by thermal fusion bonding.

In this embodiment, a separator containing polyphenylene sulfide is used as the separator 507 and the outer edges of the separator 507 are bonded by heating. Bonding portions 514 are illustrated in FIG. 5A. In such a manner, the positive electrode 503 can be covered with the separator 507.

Then, the positive electrodes 503 each covered with the separator 507 and the negative electrodes 506 are alternately stacked as illustrated in FIG. 5B. Furthermore, the positive electrode lead 510 and the negative electrode lead 511 each having a sealing layer 115 are prepared.

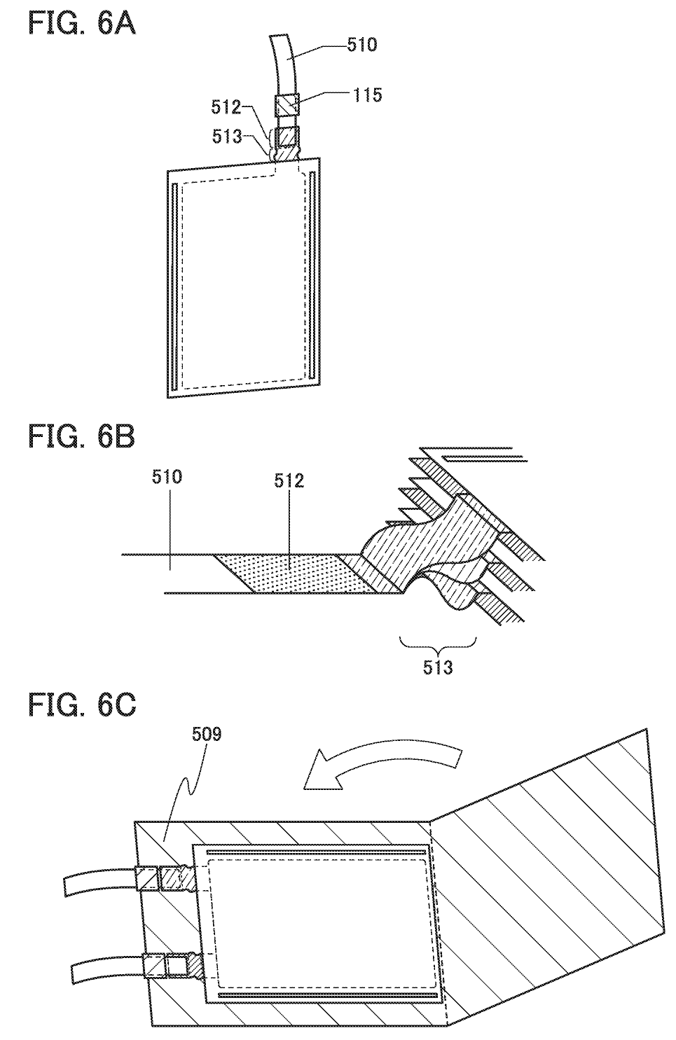

After that, the positive electrode lead 510 having the sealing layer 115 is connected to the tab region 281 of the positive electrode 503 as illustrated in FIG. 6A. FIG. 6B is an enlarged view of a connection portion. The tab region 281 of the positive electrode 503 and the positive electrode lead 510 are electrically connected to each other by irradiating the bonding portion 512 with ultrasonic waves while applying pressure thereto (ultrasonic welding). In that case, a curved portion 513 is preferably provided in the tab region 281.

This curved portion 513 can relieve stress due to external force applied after fabrication of the battery cell 500. Thus, the battery cell 500 can have high reliability.

The negative electrode lead 511 can be electrically connected to the tab region 282 of the negative electrode 506 by a similar method.

Subsequently, the positive electrode 503, the negative electrode 506, and the separator 507 are positioned over an exterior body 509.

Then, the exterior body 509 is folded along a portion shown by a dotted line in the vicinity of a center portion of the exterior body 509 in FIG. 6C.

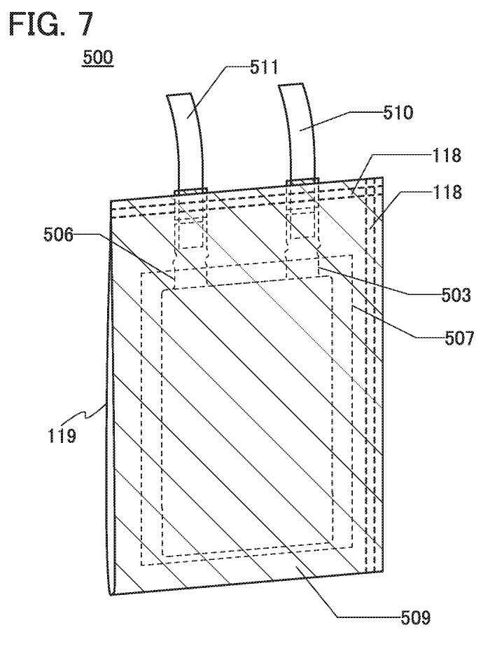

In FIG. 7, the thermocompression bonding portion in the outer edges of the exterior body 509 is illustrated as a bonding portion 118. The outer edges of the exterior body 509 except an inlet 119 for introducing the electrolytic solution 508 are bonded by thermocompression bonding. In thermocompression bonding, sealing layers provided over the lead electrodes are also melted, thereby fixing the lead electrodes and the exterior body 509 to each other. Moreover, adhesion between the exterior body 509 and the lead electrodes can be increased.

After that, in a reduced-pressure atmosphere or an inert gas atmosphere, a desired amount of electrolytic solution 508 is introduced to the inside of the exterior body 509 from the inlet 119. Lastly, the inlet 119 is sealed by thermocompression bonding. Through the above steps, the battery cell 500, which is a thin storage battery, can be fabricated.

Aging is preferably performed after fabrication of the battery cell 500. The aging can be performed under the following conditions, for example. Charge is performed at a rate of 0.001 C or more and 0.2 C or less at temperatures higher than or equal to room temperature and lower than or equal to 50° C. In the case where an electrolytic solution is decomposed and a gas is generated and accumulated in the cell, the electrolytic solution cannot be in contact with a surface of the electrode in some regions. That is to say, an effectual reaction area of the electrode is reduced and effectual resistance is increased.

When the resistance is extremely increased, a charging voltage is increased in accordance with the resistance of the electrode, and the negative electrode potential is lowered. Consequently, lithium is intercalated into graphite and lithium is deposited on the surface of graphite. The lithium deposition might reduce capacity. For example, if a coating film or the like is grown on the surface after lithium deposition, lithium deposited on the surface cannot be dissolved again. This lithium cannot contribute to capacity. In addition, when deposited lithium is physically collapsed and conduction with the electrode is lost, the lithium also cannot contribute to capacity. Therefore, the gas is preferably released to prevent the potential of the electrode from reaching the potential of lithium because of a voltage drop.

In the case of performing degasification, for example, part of the exterior body of the thin storage battery is cut to open the storage battery. When the exterior body is expanded because of a gas, the form of the exterior body is preferably adjusted. Furthermore, the electrolytic solution may be added as needed before resealing.

After the release of the gas, the charging state may be maintained at temperatures higher than room temperature, preferably higher than or equal to 30° C. and lower than or equal to 60° C., more preferably higher than or equal to 35° C. and lower than or equal to 50° C. for, for example, 1 hour or more and 100 hours or less. In the initial charge, an electrolytic solution decomposed on the surface forms a coating film. The formed coating film may thus be densified when the charging state is held at temperatures higher than room temperature after the release of the gas, for example.

Components of the power storage device of one embodiment of the present invention will be described in detail below. Description of the separator and the electrolytic solution described above is omitted. When a flexible material is selected from materials of the members described in this embodiment and used, a flexible power storage device can be fabricated.

### <<Current Collector>>

There is no particular limitation on the current collector as long as it has high conductivity without causing a significant chemical change in a power storage device. For example, the positive electrode current collector and the negative electrode current collector can each be formed using a metal such as stainless steel, gold, platinum, zinc, iron, nickel, copper, aluminum, titanium, tantalum, or manganese, an alloy thereof, sintered carbon, or the like. Alternatively, copper or stainless steel that is coated with carbon, nickel, titanium, or the like may be used. Alternatively, the current collectors can each be formed using an aluminum alloy to which an element that improves heat resistance, such as silicon, titanium, neodymium, scandium, or molybdenum, is added. Still alternatively, a metal element that forms silicide by reacting with silicon can be used to form the current collectors. Examples of the metal element that forms silicide by reacting with silicon include zirconium, titanium, hafnium, vanadium, niobium, tantalum, chromium, molybdenum, tungsten, cobalt, and nickel.

An irreversible reaction with an electrolytic solution is sometimes caused on surfaces of the positive electrode current collector and the negative electrode current collector. Thus, the positive electrode current collector and the negative electrode current collector preferably have low reactivity with an electrolytic solution. Stainless steel or the like is preferably used for the positive electrode current collector and the negative electrode current collector, in which case reactivity with an electrolytic solution can be lowered in some cases, for example.

The positive electrode current collector and the negative electrode current collector can each have any of various shapes including a foil-like shape, a plate-like shape (sheet-like shape), a net-like shape, a cylindrical shape, a coil shape, a punching-metal shape, an expanded-metal shape, a porous shape, and a shape of non-woven fabric as appropriate. The positive electrode current collector and the negative electrode current collector may each be formed to have micro irregularities on the surface thereof in order to enhance adhesion to the active material layer. The positive electrode current collector and the negative electrode current collector each preferably have a thickness of 5 μm to 30 μm inclusive.

An undercoat layer may be provided over part of a surface of the current collector. The undercoat layer is a coating layer provided to reduce contact resistance between the current collector and the active material layer or to improve adhesion between the current collector and the active material layer. Note that the undercoat layer is not necessarily formed over the entire surface of the current collector and may be partly formed to have an island-like shape. In addition, the undercoat layer may serve as an active material to have capacity. For the undercoat layer, a carbon material can be used, for example. Examples of the carbon material include graphite, carbon black such as acetylene black, and a carbon nanotube. Examples of the undercoat layer include a metal layer, a layer containing carbon and high molecular compounds, and a layer containing metal and high molecular compounds.

### <<Active Material Layer>>

The active material layer includes the active material. An active material refers only to a material that is involved in insertion and extraction of ions that are carriers. In this specification and the like, a material that is actually an “active material” and the material including a conductive additive, a binder, and the like are collectively referred to as an active material layer.

The positive electrode active material layer includes one or more kinds of positive electrode active materials. The negative electrode active material layer includes one or more kinds of negative electrode active materials.

The positive electrode active material and the negative electrode active material have a central role in battery reactions of a power storage device, and receive and release carrier ions. To increase the lifetime of the power storage device, the active materials preferably have a little capacity involved in irreversible battery reactions, and have high charge and discharge efficiency.

For the positive electrode active material, a material into and from which carrier ions such as lithium ions can be inserted and extracted can be used. Examples of a positive electrode active material include materials having an olivine crystal structure, a layered rock-salt crystal structure, a spinel crystal structure, and a NASICON crystal structure.

As the positive electrode active material, a compound such as LiFeO₂, LiCoO₂, LiNiO₂, or LiMn₂O₄, V₂O₅, Cr₂O₅, or MnO₂ can be used.

As an example of a material having an olivine crystal structure, lithium-containing complex phosphate (LiMPO₄ (general formula) (M is one or more of Fe(II), Mn(II), Co(II), and Ni(II))) can be given. Typical examples of LiMPO₄ are compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

For example, lithium iron phosphate (LiFePO₄) is preferable because it properly has properties necessary for the positive electrode active material, such as safety, stability, high capacity density, high potential, and the existence of lithium ions which can be extracted in initial oxidation (charging).

The use of LiFePO₄ for the positive electrode active material allows fabrication of a highly safe power storage device that is stable against an external load such as overcharging. Such a power storage device is particularly suitable for, for example, a mobile device, a wearable device, and the like.

Examples of a material with a layered rock-salt crystal structure include lithium cobalt oxide (LiCoO₂), LiNiO₂, LiMnO₂, Li₂MnO₃, a NiCo-containing material (general formula: LiNiₓCo₁₋ₓO₂ (0<x<1)) such as LiNi_{0.8}Co_{0.2}O₂, a NiMn-containing material (general formula: LiNiₓMn₁₋ₓO₂ (0<x<1)) such as LiNi_{0.5}Mn_{0.5}O₂, a NiMnCo-containing material (also referred to as NMC) (general formula: LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M=Co, Ni, or Mn), and the like can be given as the examples.

In particular, LiCoO₂ is preferable because it has advantages such as high capacity, higher stability in the air than that of LiNiO₂, and higher thermal stability than that of LiNiO₂.

Examples of a material with a spinel crystal structure include LiMn₂O₄, Li₁₊ₓMn₂₋ₓO₄ (0<x<2), LiMn₂₋ₓAlₓO₄ (0<x<2), and LiMn_{1.5}Ni_{0.5}O₄.

It is preferred that a small amount of lithium nickel oxide (LiNiO₂ or LiNi₁₋ₓMₓO₂ (0<x<1, M=Co, Al, or the like)) be added to a material with a spinel crystal structure that contains manganese, such as LiMn₂O₄, in which case advantages such as inhibition of the dissolution of manganese and the decomposition of an electrolytic solution can be obtained.

Alternatively, a lithium-containing complex silicate expressed by Li₍₂₋ⱼ₎MSiO₄ (general formula) (M is one or more of Fe(II), Mn(II), Co(II), or Ni(II); 0≦j≦2) may be used as the positive electrode active material. Typical examples of the general formula Li₍₂₋ⱼ₎MSiO₄ are compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<1<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a NASICON compound expressed by AₓM₂(XO₄)₃ (general formula) (A=Li, Na, or Mg, M=Fe, Mn, Ti, V, Nb, or Al, X=S, P, Mo, W, As, or Si) can be used for the positive electrode active material. Examples of the NASICON compound are Fe₂(MnO₄)₃, Fe₂(SO₄)₃, and Li₃Fe₂(PO₄)₃.

Further alternatively, for example, a compound expressed by Li₂MPO₄F, Li₂MP₂O₇, or Li₅MO₄ (general formula) (M=Fe or Mn), a perovskite fluoride such as FeF₃, a metal chalcogenide (a sulfide, a selenide, or a telluride) such as TiS₂ and MoS₂, a lithium-containing material with an inverse spinel structure such as LiMVO₄, a vanadium oxide (V₂O₅, V₆O₁₃, LiV₃O₈, or the like), a manganese oxide, or an organic sulfur compound can be used as the positive electrode active material.

Further alternatively, any of the aforementioned materials may be combined to be used as the positive electrode active material. For example, a solid solution obtained by combining two or more of the above materials can be used as the positive electrode active material. For example, a solid solution of LiCo_{1/3}Mn_{1/3}Ni_{1/3}O₂ and Li₂MnO₃ can be used as the positive electrode active material.

In the case where carrier ions are alkali metal ions other than lithium ions, or alkaline-earth metal ions, a compound containing carriers such as an alkali metal (e.g., sodium and potassium) or an alkaline-earth metal (e.g., calcium, strontium, barium, beryllium, and magnesium) instead of lithium of the lithium compound, the lithium-containing complex phosphate, or the lithium-containing complex silicate may be used as the positive electrode active material.

The average diameter of primary particles of the positive electrode active material is preferably, for example, greater than or equal to 5 nm and less than or equal to 100 μm.

For example, lithium-containing complex phosphate having an olivine crystal structure used for the positive electrode active material has a one-dimensional lithium diffusion path, so that lithium diffusion is slow. Thus, in the case of using lithium-containing complex phosphate having an olivine crystal structure, the average diameter of particles of the positive electrode active material is, for example, preferably greater than or equal to 5 nm and less than or equal to 1 μm so that the charge and discharge rate is increased. The specific surface area of the positive electrode active material is, for example, preferably greater than or equal to 10 m²/g and less than or equal to 50 m²/g.

An active material having an olivine crystal structure is much less likely to be changed in the crystal structure by charging and discharging and has a more stable crystal structure than, for example, an active material having a layered rock-salt crystal structure. Thus, a positive electrode active material having an olivine crystal structure is stable against operation such as overcharging. The use of such a positive electrode active material allows fabrication of a highly safe power storage device.

As the negative electrode active material, for example, a carbon-based material, an alloy-based material, or the like can be used.

Examples of the carbon-based material include graphite, graphitizing carbon (soft carbon), non-graphitizing carbon (hard carbon), a carbon nanotube, graphene, carbon black, and the like. Examples of the graphite include artificial graphite such as meso-carbon microbeads (MCMB), coke-based artificial graphite, or pitch-based artificial graphite and natural graphite such as spherical natural graphite. In addition, examples of the shape of the graphite include a flaky shape and a spherical shape.

Graphite has a low potential substantially equal to that of a lithium metal (higher than or equal to 0.1 V and lower than or equal to 0.3 V vs. Li/Li⁺) when lithium ions are intercalated into the graphite (while a lithium-graphite intercalation compound is formed). For this reason, a lithium-ion secondary battery can have a high operating voltage. Graphite is preferred because of its advantages described above, such as relatively high capacity per unit volume, small volume expansion, low cost, and safety greater than that of a lithium metal.

For example, in the case where carrier ions are lithium ions, a material including at least one of Mg, Ca, Ga, Si, Al, Ge, Sn, Pb, As, Sb, Bi, Ag, Au, Zn, Cd, Hg, In, and the like can be used as the alloy-based material. Such elements have a higher capacity than carbon. In particular, silicon has a high theoretical capacity of 4200 mAh/g, and therefore, the capacity of the power storage device can be increased. Examples of an alloy-based material (compound-based material) using such elements include Mg₂Si, Mg₂Ge, Mg₂Sn, SnS₂, V₂Sn₃, FeSn_{z}, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as SiO, SnO, SnO₂, titanium dioxide (e.g., TiO₂), lithium titanium oxide (e.g., Li₄Ti₅O₁₂), lithium-graphite intercalation compound (e.g., LiₓC₆), niobium pentoxide (e.g., Nb₂O₅), tungsten oxide (e.g., WO₂), or molybdenum oxide (e.g., MoO₂) can be used. Here, SiO is a compound containing silicon and oxygen. When the atomic ratio of silicon to oxygen is represented by α:β, α preferably has an approximate value of β. Here, when α has an approximate value of β, an absolute value of the difference between α and β is preferably less than or equal to 20% of a value of β, more preferably less than or equal to 10% of a value of β.

Still alternatively, for the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

When a nitride containing lithium and a transition metal is used, lithium ions are contained in the negative electrode active material and thus the negative electrode active material can be used in combination with a material for a positive electrode active material that does not contain lithium ions, such as V₂O₅ or Cr₃O₈. In the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material; for example, a transition metal oxide that does not cause an alloy reaction with lithium, such as cobalt oxide (CoO), nickel oxide (NiO), and iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The average diameter of primary particles of the negative electrode active material is preferably, for example, greater than or equal to 5 nm and less than or equal to 100 μm.

The positive electrode active material layer and the negative electrode active material layer may each include a conductive additive.

Examples of the conductive additive include a carbon material, a metal material, and a conductive ceramic material. Alternatively, a fiber material may be used as the conductive additive. The content of the conductive additive in the active material layer is preferably greater than or equal to 1 wt % and less than or equal to 10 wt %, more preferably greater than or equal to 1 wt % and less than or equal to 5 wt %.

A network for electric conduction can be formed in the electrode by the conductive additive. The conductive additive also allows maintaining of a path for electric conduction between the negative electrode active material particles. The addition of the conductive additive to the active material layer increases the electric conductivity of the active material layer.

Examples of the conductive additive include natural graphite, artificial graphite such as mesocarbon microbeads, and carbon fiber. Examples of carbon fiber include mesophase pitch-based carbon fiber, isotropic pitch-based carbon fiber, carbon nanofiber, and carbon nanotube. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used.

Flaky graphene has an excellent electrical characteristic of high conductivity and excellent physical properties of high flexibility and high mechanical strength. Thus, the use of graphene as the conductive additive can increase electrical conductivity between the active materials or between the active material and the current collector.

Note that graphene in this specification includes single-layer graphene and multilayer graphene including two to hundred layers. Single-layer graphene refers to a one-atom-thick sheet of carbon molecules having π bonds. Graphene oxide refers to a compound formed by oxidation of such graphene. Alternatively, a compound containing graphene as a basic skeleton (also referred to as a graphene compound) may be used as a material (e.g., a conductive additive or an active material) of the power storage device of one embodiment of the present invention. Note that a graphene compound in this specification includes graphene such as single-layer graphene and multilayer graphene including two to a hundred layers and graphene oxide.

Graphene is capable of making low-resistance surface contact and has extremely high conductivity even with a small thickness. Therefore, even a small amount of graphene can efficiently form a conductive path in an active material layer.

In the case where an active material with a small average particle diameter (e.g., 1 μm or less) is used, the specific surface area of the active material is large and thus more conductive paths for the active material particles are needed. In such a case, it is particularly preferred that graphene with extremely high conductivity that can efficiently form a conductive path even in a small amount is used.

The positive electrode active material layer and the negative electrode active material layer may each include a binder.

In this specification, the binder has a function of binding or bonding the active materials and/or a function of binding or bonding the active material layer and the current collector. The binder is sometimes changed in state during fabrication of an electrode or a battery. For example, the binder can be at least one of a liquid, a solid, and a gel. The binder is sometimes changed from a monomer to a polymer during fabrication of an electrode or a battery.

As the binder, for example, a water-soluble high molecular compound can be used. As the water-soluble high molecular compound, a polysaccharide or the like can be used. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used.

As the binder, a rubber material such as styrene-butadiene rubber (SBR), styrene-isoprene-styrene rubber, acrylonitrile-butadiene rubber, butadiene rubber, fluororubber, or ethylene-propylene-diene copolymer can be used. Any of these rubber materials may be used in combination with the aforementioned water-soluble high molecular compound. Since these rubber materials have rubber elasticity and easily expand and contract, it is possible to obtain a highly reliable electrode that is resistant to stress due to expansion and contraction of an active material by charging and discharging, bending of the electrode, or the like. On the other hand, the rubber materials have a hydrophobic group and thus are unlikely to be soluble in water in some cases. In such a case, particles are dispersed in an aqueous solution without being dissolved in water, so that increasing the viscosity of a composition containing a solvent used for the formation of the active material layer 102 (also referred to as an electrode binder composition) up to the viscosity suitable for application might be difficult. A water-soluble high molecular compound having excellent viscosity modifying properties, such as a polysaccharide, can moderately increase the viscosity of the solution and can be uniformly dispersed together with a rubber material. Thus, a favorable electrode with high uniformity (e.g., an electrode with uniform electrode thickness or electrode resistance) can be obtained.

Alternatively, as the binder, a material such as PVdF, polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, isobutylene, polyethylene terephthalate (PET), nylon, polyacrylonitrile (PAN), polyvinyl chloride, ethylene-propylene-diene polymer, polyvinyl acetate, or nitrocellulose can be used.

Two or more of the above materials may be used in combination for the binder.

The content of the binder in the active material layer is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %.

### <<Exterior Body>>

It is preferred that the surface of the exterior body 509 that is in contact with the electrolytic solution 508, i.e., the inner surface of the exterior body 509, does not react with the electrolytic solution 508 significantly. When moisture enters the battery cell 500 from the outside, a reaction between a component of the electrolytic solution 508 or the like and water might occur. Thus, the exterior body 509 preferably has low moisture permeability.

As the exterior body 509, a film having a three-layer structure can be used, for example. In the three-layer structure, a highly flexible metal thin film of aluminum, stainless steel, copper, nickel, or the like is provided over a film formed using polyethylene, polypropylene, polycarbonate, ionomer, polyamide, or the like, and an insulating synthetic resin film of a polyamide-based resin, a polyester-based resin, or the like is provided as the outer surface of the exterior body over the metal thin film can be used. With such a three-layer structure, the passage of an electrolytic solution and a gas can be blocked and an insulating property and resistance to the electrolytic solution can be provided. The exterior body is folded inside in two, or two exterior bodies are stacked with the inner surfaces facing each other, in which case application of heat melts the materials on the overlapping inner surfaces to cause fusion bonding between the two exterior bodies. In this manner, a sealing structure can be formed.

A portion where the sealing structure is formed by fusion bonding or the like of the exterior body is referred to as a sealing portion. In the case where the exterior body is folded inside in two, the sealing portion is formed in the place other than the fold, and a first region of the exterior body and a second region of the exterior body that overlaps with the first region are fusion-bonded, for example. In the case where two exterior bodies are stacked, the sealing portion is formed along the entire outer region by heat fusion bonding or the like.

The battery cell 500 can be flexible by using the exterior body 509 with flexibility. When the battery cell has flexibility, it can be used in an electronic device at least part of which is flexible, and the battery cell 500 can be bent as the electronic device is bent.

As described above, in one embodiment of the present invention, the separator containing polyphenylene sulfide and the electrolytic solution containing an ionic liquid are used; thus, even at high temperature, the separator and the electrolytic solution are less likely to react with each other and the decomposition of the electrolytic solution can be inhibited. Consequently, an increase in irreversible capacity in operation at high temperature can be inhibited, leading to favorable charge and discharge cycle performance.

Furthermore, the power storage device of one embodiment of the present invention exhibits favorable charge and discharge characteristics at a wide range of temperature, not only at high temperature. Furthermore, in the power storage device of one embodiment of the present invention, an ionic liquid is used, and this enables a high level of safety at a wide range of temperature compared with the case where an organic solvent is used.

One embodiment of the present invention can provide a power storage device that is capable of operating at temperatures higher than or equal to 100° C., for example, a power storage device that can be used in an autoclave or the like.

This embodiment can be combined with any of the other embodiments as appropriate.

### Embodiment 2

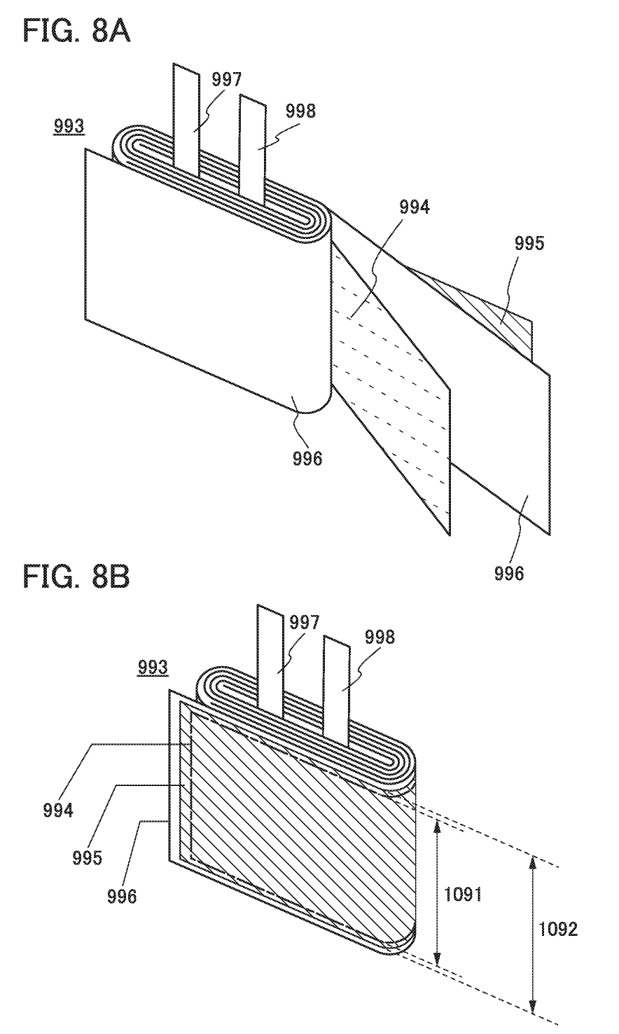

In this embodiment, power storage devices of embodiments of the present invention will be described with reference to FIGS. 8A and 8B to FIGS. 15A and 15B.

In one embodiment of the present invention, a separator containing polyphenylene sulfide and an electrolytic solution containing an ionic liquid are used, and this enables fabrication of a highly safe power storage device that exhibits excellent charge and discharge characteristics and high long-term reliability at a wide range of temperature including high temperatures.

### [Storage Battery Using Wound Body]

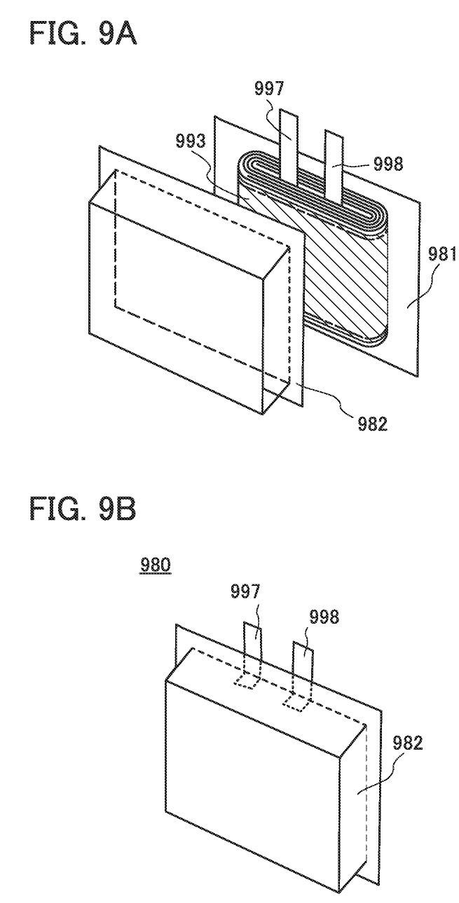

Next, FIGS. 8A and 8B and FIGS. 9A and 9B illustrate structural examples of a storage battery using a wound body that is the power storage device of one embodiment of the present invention.

A wound body 993 illustrated in FIGS. 8A and 8B includes a negative electrode 994, a positive electrode 995, and a separator 996.

The wound body 993 is obtained by winding a sheet of a stack in which the negative electrode 994 overlaps with the positive electrode 995 with the separator 996 therebetween. The wound body 993 is covered with a rectangular sealed container or the like; thus, a rectangular storage battery is fabricated.

Note that the number of stacks each including the negative electrode 994, the positive electrode 995, and the separator 996 can be determined as appropriate depending on capacity and element volume which are required. The negative electrode 994 is connected to a negative electrode current collector (not illustrated) via one of a terminal 997 and a terminal 998. The positive electrode 995 is connected to a positive electrode current collector (not illustrated) via the other.

The area of a region where the negative electrode 994 does not overlap with the positive electrode 995 is preferably as small as possible. FIG. 8B illustrates the example where a width 1091 of the negative electrode 994 is smaller than a width 1092 of the positive electrode 995. In addition, an end portion of the negative electrode 994 is located inside a region between end portions of the positive electrode 995. With such a structure, the negative electrode 994 can entirely overlap with the positive electrode 995 or the area of a region where the negative electrode 994 and the positive electrode 995 do not overlap with each other can be reduced.

In the case where the area of the positive electrode 995 is too larger than that of the negative electrode 994, an excess portion of the positive electrode 995 is large, which reduces the capacity of a storage battery per unit volume, for example. Thus, for example, the end portion of the negative electrode 994 is preferably located inward from the end portion of the positive electrode 995. Furthermore, the distance between the end portion of the positive electrode 995 and the end portion of the negative electrode 994 is preferably 3 mm or less, more preferably 0.5 mm or less, still more preferably 0.1 mm or less. Alternatively, the difference between the widths of the positive electrode 995 and the negative electrode 994 is preferably 6 mm or less, more preferably 1 mm or less, still more preferably 0.2 mm or less. Alternatively, it is preferred that the widths 1091 and 1092 be approximately equal values and the end portion of the negative electrode 994 be substantially aligned with the end portion of the positive electrode 995.

A storage battery 980 illustrated in FIG. 9B includes, as illustrated in FIG. 9A, a film 981, a film 982 having a depressed portion, and the wound body 993. In the storage battery 980, the wound body 993 is packed in a space formed by bonding a film 981 and the film 982 having a depressed portion that serve as exterior bodies by thermocompression bonding or the like. The wound body 993 includes the terminal 997 and the terminal 998, and is soaked in an electrolytic solution inside a space surrounded by the film 981 and the film 982.

For the film 981 and the film 982, a metal material such as aluminum or a resin material can be used, for example. With the use of a resin material for the film 981 and the film 982, the film 981 and the film 982 can be changed in their forms when external force is applied; thus, a flexible storage battery can be fabricated.

Although FIGS. 9A and 9B illustrate an example where a space is formed by two films, the wound body 993 may be placed in a space formed by bending one film.

Furthermore, the use of a resin material or the like for an exterior body and a sealed container allows the whole power storage device to have flexibility. Note that in the case where a resin material is used for the exterior body and the sealed container, a conductive material is used for a portion connected to the outside.

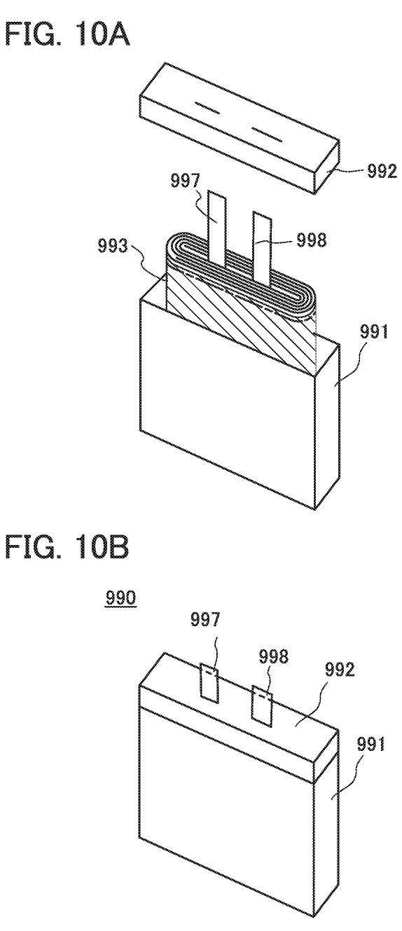

The storage battery 990 illustrated in FIG. 10B includes, as illustrated in FIG. 10A, an exterior body 991, an exterior body 992, and the wound body 993.

In the storage battery 990 illustrated in FIG. 10B, the wound body 993 is packed in an exterior body 991. The wound body 993 includes the terminal 997 and the terminal 998, and is soaked in an electrolytic solution inside a space surrounded by the exterior body 991 and an exterior body 992. For example, a metal material such as aluminum or a resin material can be used for each of the exterior bodies 991 and 992. With the use of a resin material for the exterior bodies 991 and 992, the exterior bodies 991 and 992 can be changed in their forms when external force is applied; thus, a flexible storage battery can be fabricated.

### [Cylindrical Storage Battery]

Next, a cylindrical storage battery will be described as an example of a power storage device using a wound body.

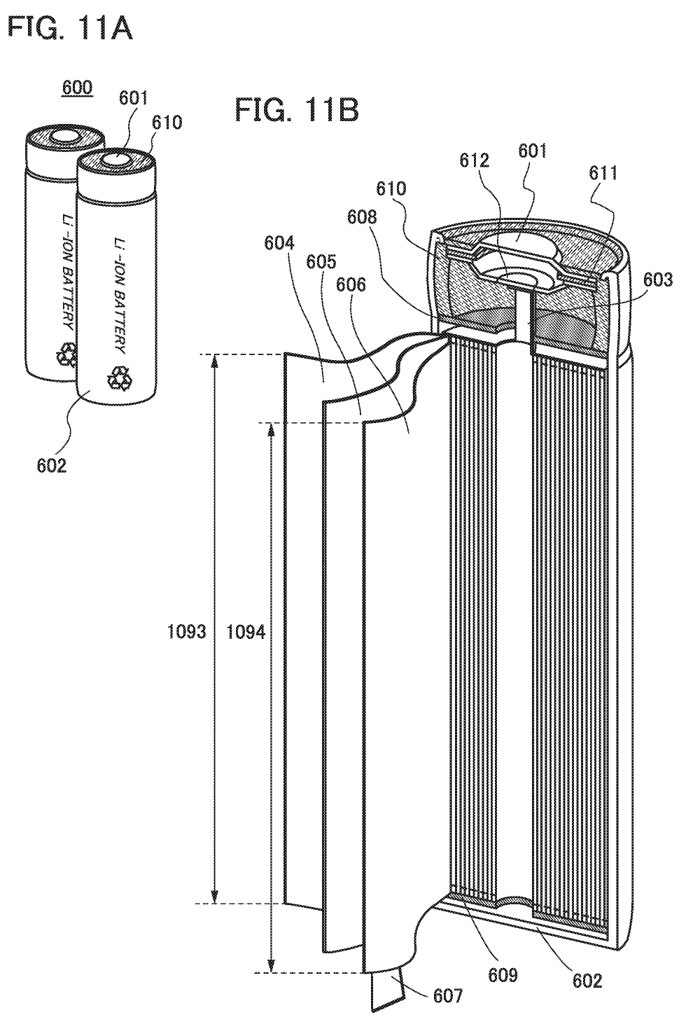

A cylindrical storage battery 600 illustrated in FIG. 11A includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 11B is a schematic cross-sectional view of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is close and the other end thereof is open. For the battery can 602, a metal having a corrosion-resistant property to an electrolytic solution, such as aluminum, or titanium, an alloy of such a metal, or an alloy of such a metal and another metal (e.g., stainless steel or the like) can be used. Alternatively, the battery can 602 is preferably covered with aluminum, or the like in order to prevent corrosion due to the electrolytic solution. Inside the battery can 602, the battery element in which the positive electrode, the negative electrode, and the separator are wound is provided between a pair of insulating plates 608 and 609 which face each other. Furthermore, a nonaqueous electrolytic solution (not illustrated) is injected inside the battery can 602 provided with the battery element.

Since the positive electrode and the negative electrode of the cylindrical storage battery are wound, active materials are preferably formed on opposite surfaces of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

The area of a region where the negative electrode 606 does not overlap with the positive electrode 604 is preferably as small as possible. For example, an end portion of the negative electrode 606 is located inside a region between end portions of the positive electrode 604. Furthermore, the distance between the end portion of the positive electrode 604 and the end portion of the negative electrode 606 is preferably 3 mm or less, more preferably 0.5 mm or less, still more preferably 0.1 mm or less. Alternatively, the difference between a width 1093 of the positive electrode 604 and a width 1094 of the negative electrode 606 is preferably 6 mm or less, more preferably 1 mm or less, still more preferably 0.2 mm or less. Alternatively, it is preferred that the widths 1093 and 1094 be approximately equal values and the end portion of the negative electrode 606 be substantially aligned with the end portion of the positive electrode 604.

### [Coin-Type Storage Battery]

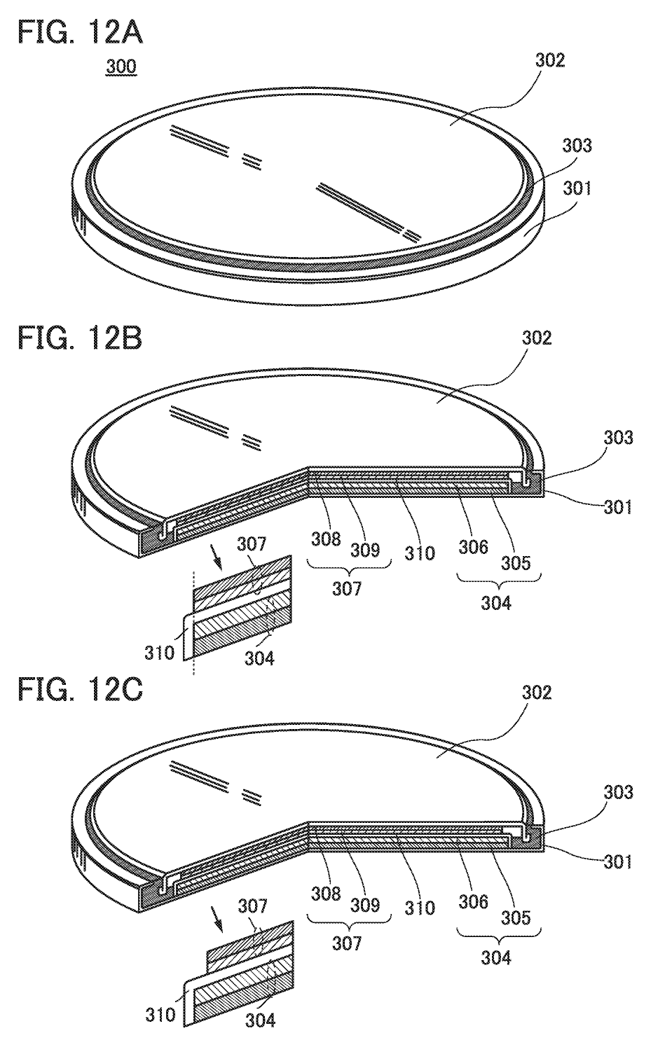

FIGS. 12A to 12C illustrate an example of a coin-type storage battery, which is a power storage device of one embodiment of the present invention. FIG. 12A is an external view of a coin-type (single-layer flat type) storage battery, and FIGS. 12B and 12C are cross-sectional views thereof.

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like.

A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 that are in contact with each other. Note that only one surface of each of the positive electrode and the negative electrode used for the coin-type storage battery is provided with an active material layer.

The positive electrode active material layer 306 may further include a binder for increasing adhesion of positive electrode active materials, a conductive additive for increasing the conductivity of the positive electrode active material layer, and the like in addition to the active materials. The negative electrode active material layer 309 may further include a binder for increasing adhesion of negative electrode active materials, a conductive additive for increasing the conductivity of the negative electrode active material layer, and the like in addition to the negative electrode active materials.

A separator 310 and an electrolyte (not illustrated) are provided between the positive electrode active material layer 306 and the negative electrode active material layer 309.

It is preferred that the shape and area of the positive electrode 304 be preferably substantially the same as those of the negative electrode 307 and an end portion of the positive electrode 304 be substantially aligned with an end portion of the negative electrode 307. FIG. 12B illustrates an example where the end portion of the positive electrode 304 is aligned with the end portion of the negative electrode 307.

Alternatively, it is preferred that the area of the positive electrode 304 be larger than that of the negative electrode 307 and the end portion of the negative electrode 307 be located inward from the end portion of the positive electrode 304. FIG. 12C illustrates an example where the end portion of the negative electrode 307 is located inward from the end portion of the positive electrode 304.

For the positive electrode can 301 and the negative electrode can 302, a metal having a corrosion-resistant property to an electrolytic solution, such as aluminum or titanium, an alloy of such a metal, or an alloy of such a metal and another metal (e.g., stainless steel or the like) can be used. Alternatively, the positive electrode can 301 and the negative electrode can 302 are preferably covered with aluminum or the like in order to prevent corrosion due to the electrolytic solution. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIGS. 12B and 12C, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be fabricated.

### [Power Storage System]

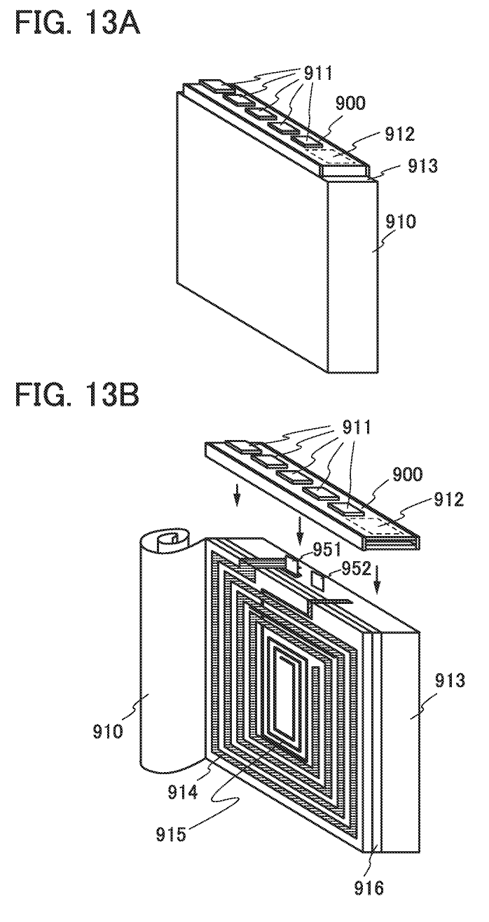

Next, structural examples of power storage systems will be described with reference to FIGS. 13A and 13B to FIGS. 15A and 15B. Here, a power storage system refers to, for example, a device including a power storage device. The power storage system described in this embodiment includes a power storage device of one embodiment of the present invention.

FIGS. 13A and 13B are external views of a power storage system. The power storage system includes a circuit board 900 and a storage battery 913. A label 910 is attached to the storage battery 913. As shown in FIG. 13B, the power storage system further includes a terminal 951, a terminal 952, an antenna 914, and an antenna 915.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the storage battery 913 and the antennas 914 and 915. The layer 916 may have a function of preventing an adverse effect on an electromagnetic field by the storage battery 913. As the layer 916, for example, a magnetic body can be used.

Note that the structure of the power storage system is not limited to that shown in FIGS. 13A and 13B. A modification example will be described below. Note that the above description can be appropriately referred to for a portion that is the same as a portion of the power storage system in FIGS. 13A and 13B.

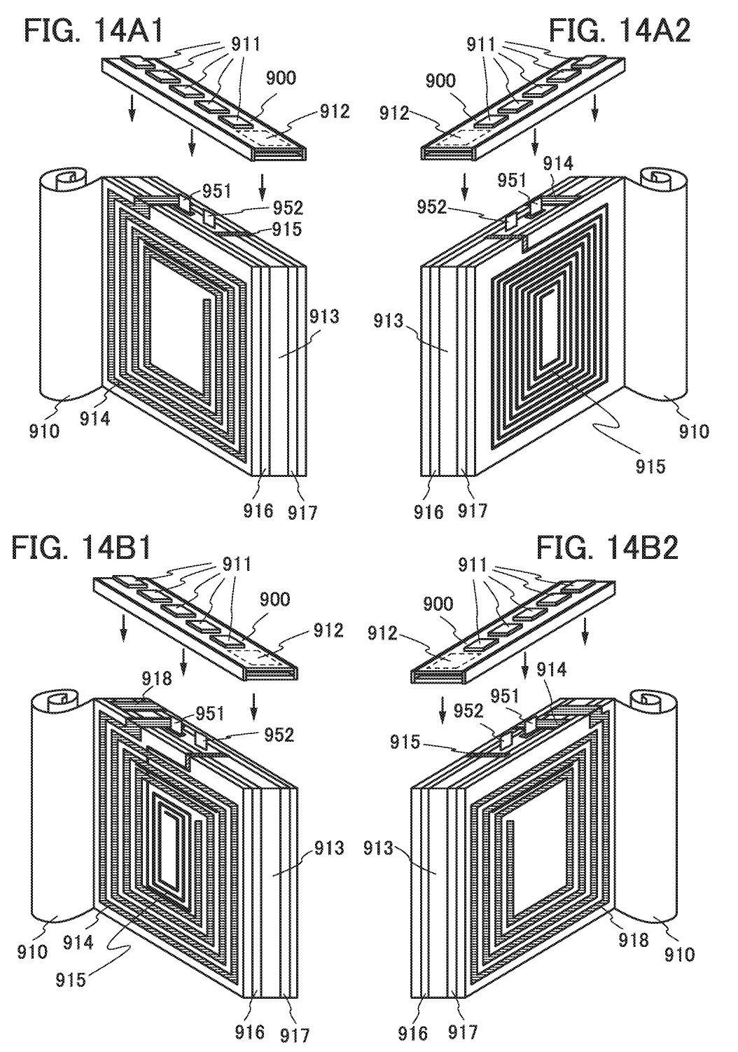

For example, as shown in FIGS. 14A1 and 14A2, two opposite surfaces of the storage battery 913 in FIGS. 13A and 13B may be provided with respective antennas. FIG. 14A1 is an external view showing one side of the opposite surfaces, and FIG. 14A2 is an external view showing the other side of the opposite surfaces.

As illustrated in FIG. 14A1, the antenna 914 is provided on one of the opposite surfaces of the storage battery 913 with the layer 916 interposed therebetween, and as illustrated in FIG. 14A2, the antenna 915 is provided on the other of the opposite surfaces of the storage battery 913 with a layer 917 interposed therebetween. The layer 917 has a function of blocking an electromagnetic field from the storage battery 913, for example. As the layer 917, for example, a magnetic body can be used.

With the above structure, both of the antennas 914 and 915 can be increased in size.

Alternatively, as illustrated in FIGS. 14B1 and 14B2, two opposite surfaces of the storage battery 913 in FIGS. 13A and 13B may be provided with different types of antennas. FIG. 14B1 is an external view showing one side of the opposite surfaces, and FIG. 14B2 is an external view showing the other side of the opposite surfaces.

As illustrated in FIG. 14B1, the antenna 914 is provided on one of the opposite surfaces of the storage battery 913 with the layer 916 interposed therebetween, and as illustrated in FIG. 14B2, an antenna 918 is provided on the other of the opposite surfaces of the storage battery 913 with the layer 917 interposed therebetween. The antenna 918 has a function of communicating data with an external device, for example. An antenna with a shape that can be applied to the antennas 914 and 915, for example, can be used as the antenna 918. As a system for communication using the antenna 918 between the power storage system and another device, a response method that can be used between the power storage system and another device, such as NFC, can be employed.

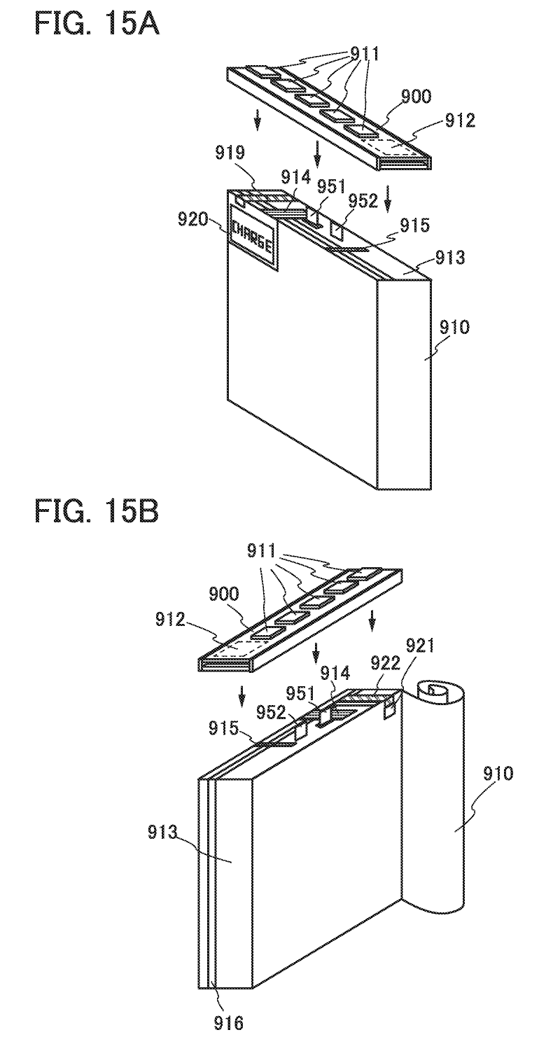

Alternatively, as illustrated in FIG. 15A, the storage battery 913 in FIGS. 13A and 13B may be provided with a display device 920. The display device 920 is electrically connected to the terminal 911 via a terminal 919. It is possible that the label 910 is not provided in a portion where the display device 920 is provided.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 15B, the storage battery 913 illustrated in FIGS. 13A and 13B may be provided with a sensor 921. The sensor 921 is electrically connected to the terminal 911 via a terminal 922.

As the sensor 921, the one having a function of measuring, for example, force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays can be used. With the sensor 921, for example, data on an environment (e.g., temperature) where the power storage system is placed can be determined and stored in a memory inside the circuit 912.

This embodiment can be combined with any of the other embodiments as appropriate.

### Embodiment 3

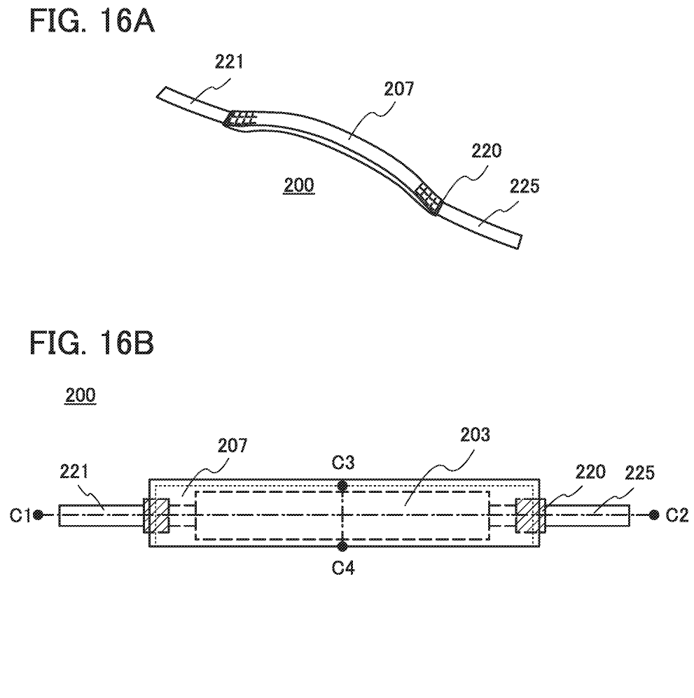

In this embodiment, flexible power storage devices that are embodiments of the present invention will be described with reference to FIGS. 16A and 16B to FIG. 23. The power storage device of one embodiment of the present invention may have a curved shape. The power storage device of one embodiment of the present invention may be flexible and capable of being used while being curved and while being not curved.

### <Structural Example 2>

FIG. 16A is a perspective view of a secondary battery 200 and FIG. 16B is a top view of the secondary battery 200.

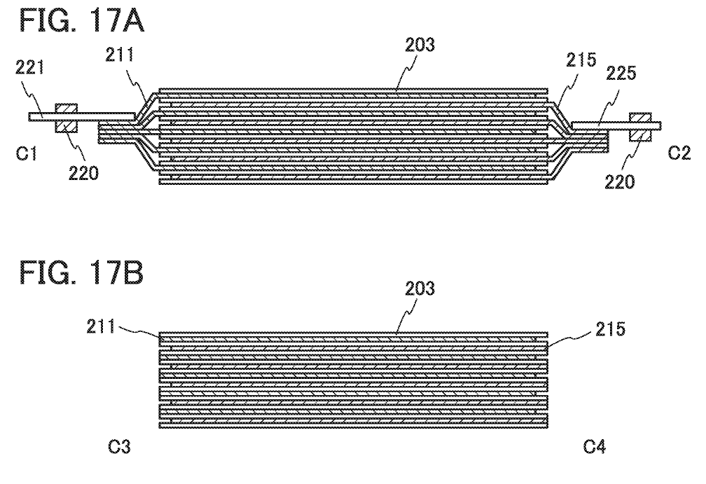

FIG. 17A is a cross-sectional view along dashed-dotted line C1-C2 in FIG. 16B, and FIG. 17B is a cross-sectional view along dashed-dotted line C3-C4 in FIG. 16B. Note that FIGS. 17A and 17B do not illustrate all components for clarity of the drawings.

The secondary battery 200 includes a positive electrode 211, a negative electrode 215, and a separator 203. The secondary battery 200 further includes a positive electrode lead 221, a negative electrode lead 225, and an exterior body 207.

The positive electrode 211 and the negative electrode 215 each include a current collector and an active material layer. The positive electrode 211 and the negative electrode 215 are provided such that the active material layers face each other with the separator 203 provided therebetween.

One of the electrodes (the positive electrode 211 and the negative electrode 215) of the secondary battery 200 that is positioned on the outer diameter side of a curved portion is preferably longer than the other electrode that is positioned on the inner diameter side of the curved portion, in the direction in which the electrode is curved. With such a structure, ends of the positive electrode 211 and those of the negative electrode 215 are aligned when the secondary battery 200 is curved with a certain curvature. That is, the entire region of the positive electrode active material layer included in the positive electrode 211 can face the negative electrode active material layer included in the negative electrode 215. Thus, positive electrode active materials included in the positive electrode 211 can efficiently contribute to a battery reaction. Therefore, the capacity of the secondary battery 200 per volume can be increased. Such a structure is particularly effective in a case where the curvature of the secondary battery 200 is fixed in using the secondary battery 200.

The positive electrode lead 221 is electrically connected to a plurality of positive electrodes 211. The negative electrode lead 225 is electrically connected to a plurality of negative electrodes 215. The positive electrode lead 221 and the negative electrode lead 225 each include a sealing layer 220.

The exterior body 207 covers a plurality of positive electrodes 211, a plurality of negative electrodes 215, and a plurality of separators 203. The secondary battery 200 includes an electrolytic solution (not shown) in a region covered with the exterior body 207. Three sides of the exterior body 207 are bonded, whereby the secondary battery 200 is sealed.

In FIGS. 17A and 17B, the separators 203 each having a strip-like shape are used and each pair of the positive electrode 211 and the negative electrode 215 sandwich the separator 203; however, one embodiment of the present invention is not limited to this structure. One separator sheet may be folded in zigzag (or into a bellows shape) or wound so that the separator is positioned between the positive electrode and the negative electrode.

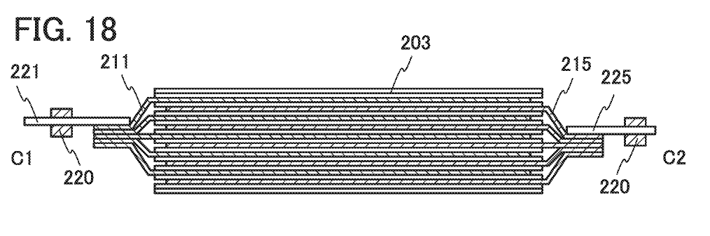

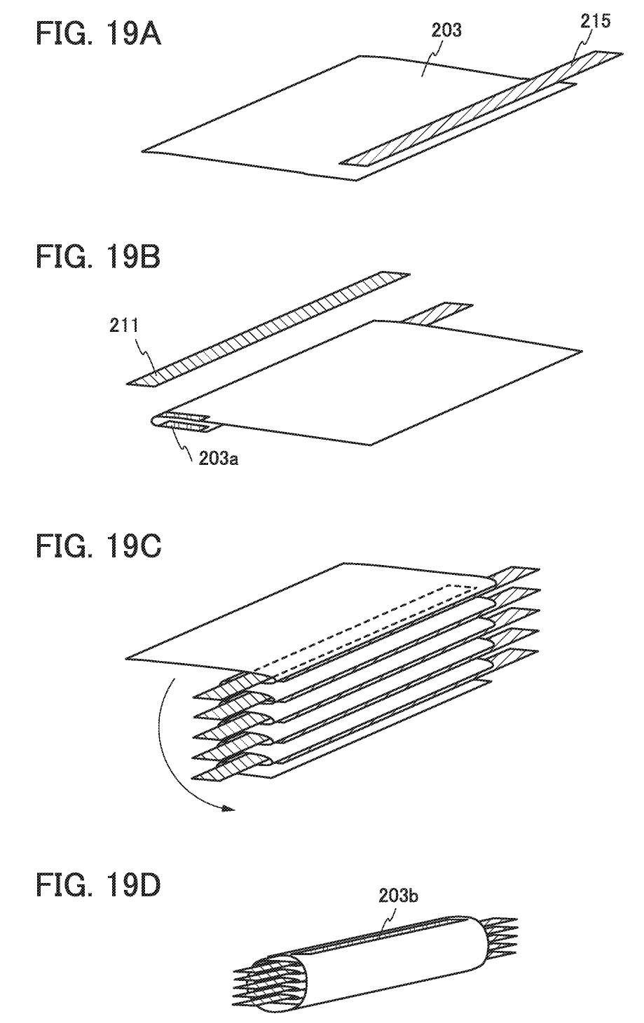

An example of a method for fabricating the secondary battery 200 is illustrated in FIGS. 19A to 19D. FIG. 18 is a cross-sectional view along dashed-dotted line C1-C2 in FIG. 16B of the case of employing this manufacturing method.

First, the negative electrode 215 is positioned over the separator 203 (FIG. 19A) such that the negative electrode active material layer of the negative electrode 215 overlaps with the separator 203.

Then, the separator 203 is folded to overlap with the negative electrode 215. Next, the positive electrode 211 overlaps with the separator 203 (FIG. 19B) such that the positive electrode active material layer of the positive electrode 211 overlaps with the separator 203 and the negative electrode active material layer. Note that in the case of using an electrode in which one surface of a current collector is provided with an active material layer, the positive electrode active material layer of the positive electrode 211 and the negative electrode active material layer of the negative electrode 215 are positioned to face each other with the separator 203 provided therebetween.

In the case where the separator 203 is formed using a material that can be thermally welded, such as polypropylene, a region where the separator 203 overlaps with itself is thermally welded and then another electrode overlaps with the separator 203, whereby the slippage of the electrode in the fabrication process can be suppressed. Specifically, a region which does not overlap with the negative electrode 215 or the positive electrode 211 and in which the separator 203 overlaps with itself, e.g., a region denoted as 203a in FIG. 19B, is preferably thermally welded.

By repeating the above steps, the positive electrode 211 and the negative electrode 215 can overlap with each other with the separator 203 provided therebetween as illustrated in FIG. 19C.

Note that a plurality of positive electrodes 211 and a plurality of negative electrodes 215 may be placed to be alternately sandwiched by the separator 203 that is repeatedly folded in advance.

Then, as illustrated in FIG. 19C, a plurality of positive electrodes 211 and a plurality of negative electrodes 215 are covered with the separator 203.

Furthermore, the region where the separator 203 overlaps with itself, e.g., a region 203b in FIG. 19D, is thermally welded as illustrated in FIG. 19D, whereby a plurality of positive electrodes 211 and a plurality of negative electrodes 215 are covered with and tied with the separator 203.

Note that a plurality of positive electrodes 211, a plurality of negative electrodes 215, and the separator 203 may be tied with a binding material.

Since the positive electrodes 211 and the negative electrodes 215 are stacked in the above process, one separator 203 has a region sandwiched between the positive electrode 211 and the negative electrode 215 and a region covering a plurality of positive electrodes 211 and a plurality of negative electrodes 215.

In other words, the separator 203 included in the secondary battery 200 in FIG. 18 and FIG. 19D is a single separator which is partly folded. In the folded regions of the separator 203, a plurality of positive electrodes 211 and a plurality of negative electrodes 215 are provided.

### <Structural Example 2>

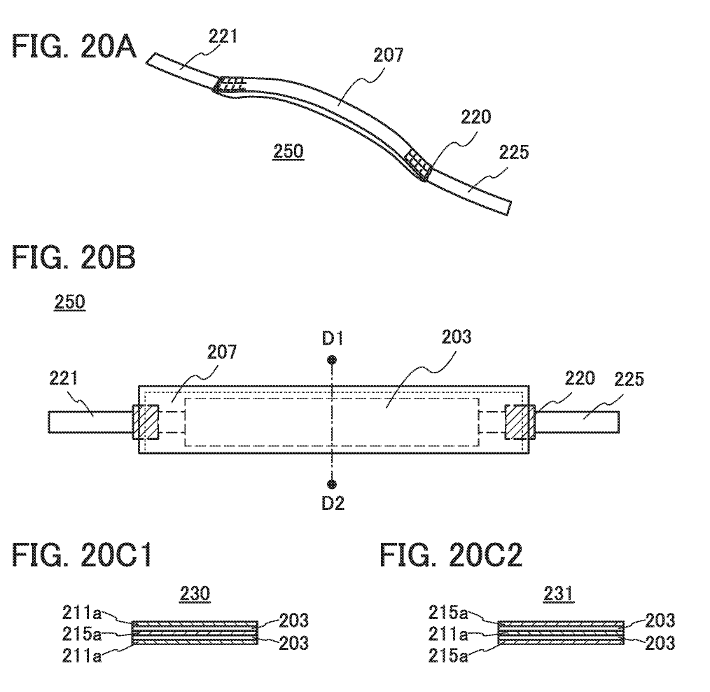

FIG. 20A is a perspective view of a secondary battery 250 and FIG. 20B is a top view of the secondary battery 250. Furthermore, FIG. 20C1 is a cross-sectional view of a first electrode assembly 230 and FIG. 20C2 is a cross-sectional view of a second electrode assembly 231.

The secondary battery 250 includes the first electrode assembly 230, the second electrode assembly 231, and the separator 203. The secondary battery 250 further includes the positive electrode lead 221, the negative electrode lead 225, and the exterior body 207.

As illustrated in FIG. 20C1, in the first electrode assembly 230, a positive electrode 211a, the separator 203, a negative electrode 215a, the separator 203, and the positive electrode 211a are stacked in this order. The positive electrode 211a and the negative electrode 215a each include active material layers on opposite surfaces of a current collector.

As illustrated in FIG. 20C2, in the second electrode assembly 231, a negative electrode 215a, the separator 203, the positive electrode 211a, the separator 203, and the negative electrode 215a are stacked in this order. The positive electrode 211a and the negative electrode 215a each include active material layers on opposite surfaces of a current collector.

In other words, in each of the first electrode assembly 230 and the second electrode assembly 231, the positive electrode and the negative electrode are provided such that the active material layers face each other with the separator 203 provided therebetween.

The positive electrode lead 221 is electrically connected to a plurality of positive electrodes 211. The negative electrode lead 225 is electrically connected to a plurality of negative electrodes 215. The positive electrode lead 221 and the negative electrode lead 225 each include the sealing layer 220.

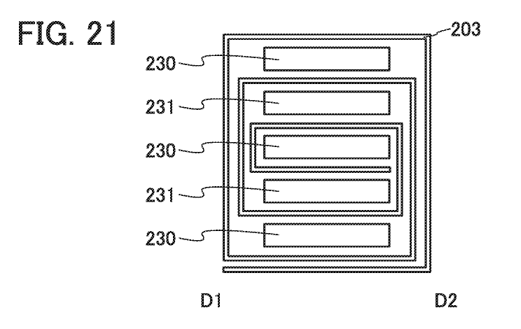

FIG. 21 is an example of a cross-sectional view along dashed-dotted line D1-D2 in FIG. 20B. Note that FIG. 21 does not illustrate all components for clarity of the drawings.

As illustrated in FIG. 21, the secondary battery 250 has a structure in which a plurality of first electrode assemblies 230 and a plurality of second electrode assemblies 231 are covered with the wound separator 203.

The exterior body 207 covers a plurality of first electrode assemblies 230, a plurality of second electrode assemblies 231, and the separator 203. The secondary battery 200 includes an electrolytic solution (not shown) in a region covered with the exterior body 207. Three sides of the exterior body 207 are bonded, whereby the secondary battery 200 is sealed.

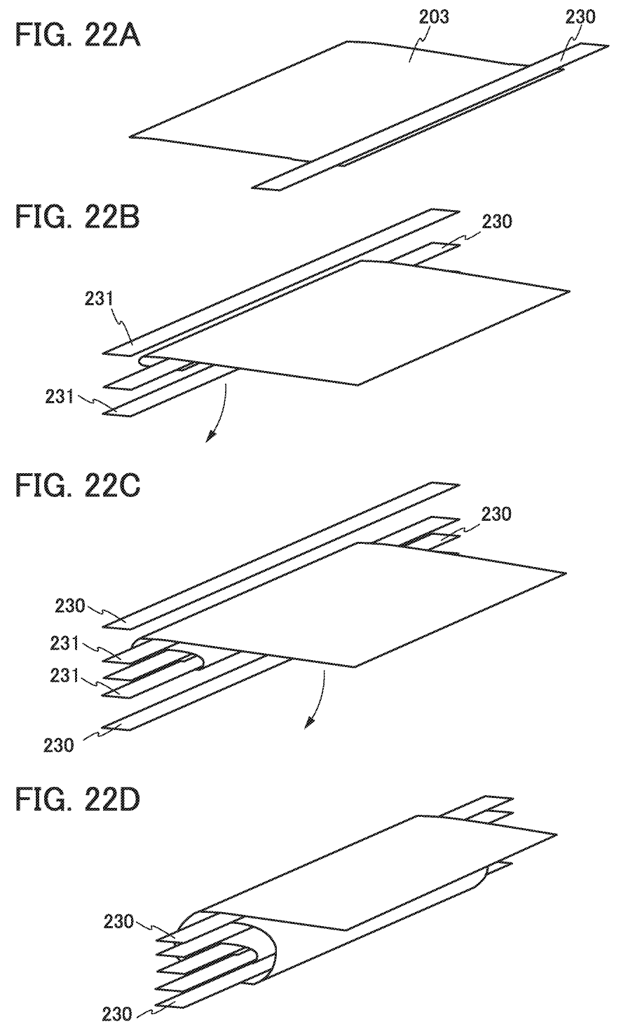

An example of a method for fabricating the secondary battery 250 is illustrated in FIGS. 22A to 22D.

First, the first electrode assembly 230 is positioned over the separator 203 (FIG. 22A).

Then, the separator 203 is folded to overlap with the first electrode assembly 230. After that, two second electrode assemblies 231 are positioned over and under the first electrode assembly 230 with the separator 203 positioned between each of the second electrode assemblies 231 and the first electrode assembly 230 (FIG. 22B).

Then, the separator 203 is wound to cover the two second electrode assemblies 231. Moreover, two first electrode assemblies 230 are positioned over and under the two second electrode assemblies 231 with the separator 203 positioned between each of the first electrode assemblies 230 and each of the second electrode assemblies 231 (FIG. 22C).

Then, the separator 203 is wound to cover the two first electrode assemblies 230 (FIG. 22D).

Since a plurality of first electrode assemblies 230 and a plurality of second electrode assemblies 231 are stacked in the above process, these electrode assemblies are each positioned surrounded with the spirally wound separator 203.

Note that the outermost electrode preferably does not include an active material layer on the outer side.

Although FIGS. 20C1 and 20C2 each illustrate a structure in which the electrode assembly includes three electrodes and two separators, one embodiment of the present invention is not limited to this structure. The electrode assembly may include four or more electrodes and three or more separators. A larger number of electrodes lead to higher capacity of the secondary battery 250. Alternatively, the electrode assembly may include two electrodes and one separator. A smaller number of electrodes enable higher resistance of the secondary battery against bending. Although FIG. 21 illustrates the structure in which the secondary battery 250 includes three first electrode assemblies 230 and two second electrode assemblies 231, one embodiment of the present invention is not limited to this structure. The number of the electrode assemblies may be increased. A larger number of electrode assemblies lead to higher capacity of the secondary battery 250. The number of the electrode assemblies may be decreased. A smaller number of electrode assemblies enable higher resistance of the secondary battery against bending.

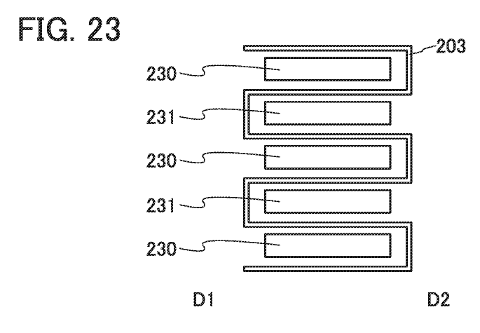

FIG. 23 illustrates another example of a cross-sectional view along dashed-dotted line D1-D2 in FIG. 20B. As illustrated in FIG. 23, the separator 203 may be folded into a bellows shape so that the separator 203 is positioned between the first electrode assembly 230 and the second electrode assembly 231.

This embodiment can be combined with any of the other embodiments as appropriate.

### Embodiment 4

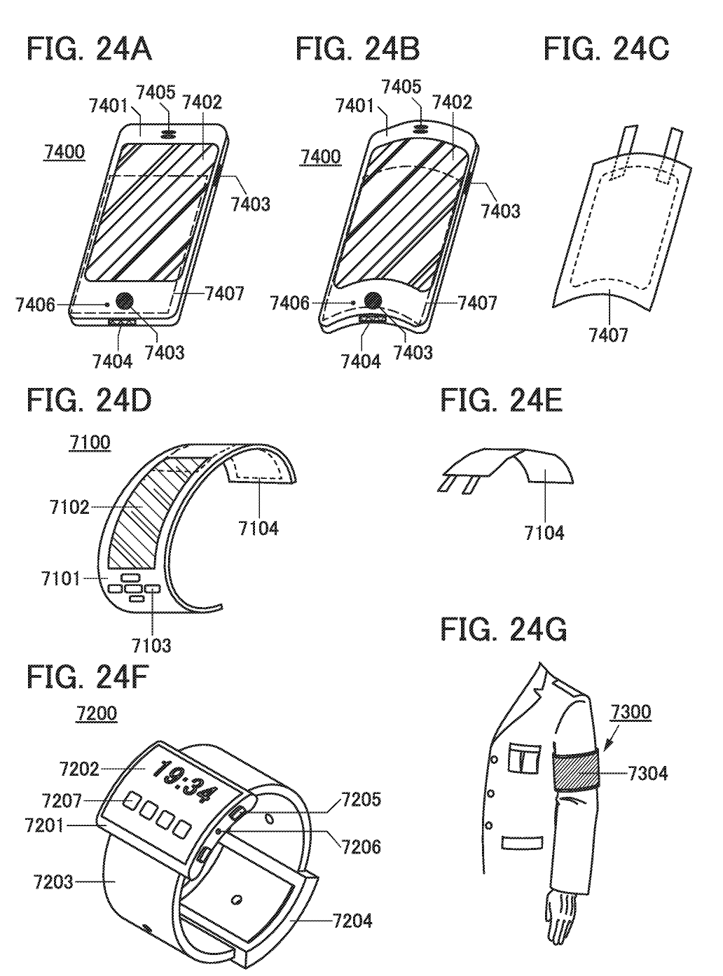

In this embodiment, application examples of the power storage device of one embodiment of the present invention will be described with reference to FIGS. 24A to 24G to FIGS. 27A to 27G.

The power storage device of one embodiment of the present invention can be used for an electronic device or a lighting device, for example. The power storage device of one embodiment of the present invention has excellent charge and discharge characteristics. Therefore, the electronic device or the lighting device can be used for a long time by a single charge. Moreover, since a decrease in capacity with an increasing number of charge and discharge cycles is inhibited, the time between charges is less likely to be reduced by repetitive charge. Furthermore, the power storage device of one embodiment of the present invention exhibits excellent charge and discharge characteristics and high long-term reliability and is highly safe at a wide range of temperature including high temperatures, so that the safety and reliability of an electronic device or a lighting device can be improved.

Examples of electronic devices include a television set (also referred to as a television or a television receiver), a monitor of a computer or the like, a digital camera, a digital video camera, a digital photo frame, a mobile phone (also referred to as a mobile phone device), a portable game machine, a portable information terminal, an audio reproducing device, a large game machine such as a pinball machine, and the like.

Since the power storage device of one embodiment of the present invention is flexible, the power storage device or an electronic device or a lighting device using the power storage device can be incorporated along a curved inside/outside wall surface of a house or a building or a curved interior/exterior surface of a motor vehicle.

FIG. 24A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

FIG. 24B illustrates the mobile phone 7400 in the state of being bent. When the whole mobile phone 7400 is bent by the external force, the power storage device 7407 included in the mobile phone 7400 is also bent. The power storage device 7407 is a thin storage battery. The power storage device 7407 is fixed in a state of being bent. FIG. 24C illustrates the power storage device 7407 in the state of being bent

FIG. 24D illustrates an example of a bangle display device. A portable display device 7100 includes a housing 7101, a display portion 7102, an operation button 7103, and a power storage device 7104. FIG. 24E illustrates the bent power storage device 7104.

FIG. 24F illustrates an example of a watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing text, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as power ON/OFF, ON/OFF of wireless communication, setting and cancellation of silent mode, and setting and cancellation of power saving mode can be performed. For example, the functions of the operation button 7205 can be set freely by the operating system incorporated in the portable information terminal 7200.

Furthermore, the portable information terminal 7200 can employ near field communication, which is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. In addition, charging via the input output terminal 7206 is possible. Note that the charging operation may be performed by wireless power feeding without using the input output terminal 7206.

The display portion 7202 of the portable information terminal 7200 is provided with the power storage device of one embodiment of the present invention. For example, the power storage device 7104 illustrated in FIG. 24E that is in the state of being curved can be provided in the housing 7201. Alternatively, the power storage device 7104 illustrated in FIG. 24E can be provided in the band 7203 such that it can be curved.

FIG. 24G illustrates an example of an armband display device. A display device 7300 includes a display portion 7304 and the power storage device of one embodiment of the present invention. The display device 7300 can include a touch sensor in the display portion 7304 and can serve as a portable information terminal.

The display surface of the display portion 7304 is bent, and images can be displayed on the bent display surface. A display state of the display device 7300 can be changed by, for example, near field communication, which is a communication method based on an existing communication standard.

The display device 7300 includes an input output terminal, and data can be directly transmitted to and received from another information terminal via a connector. In addition, charging via the input output terminal is possible. Note that the charging operation may be performed by wireless power feeding without using the input output terminal.

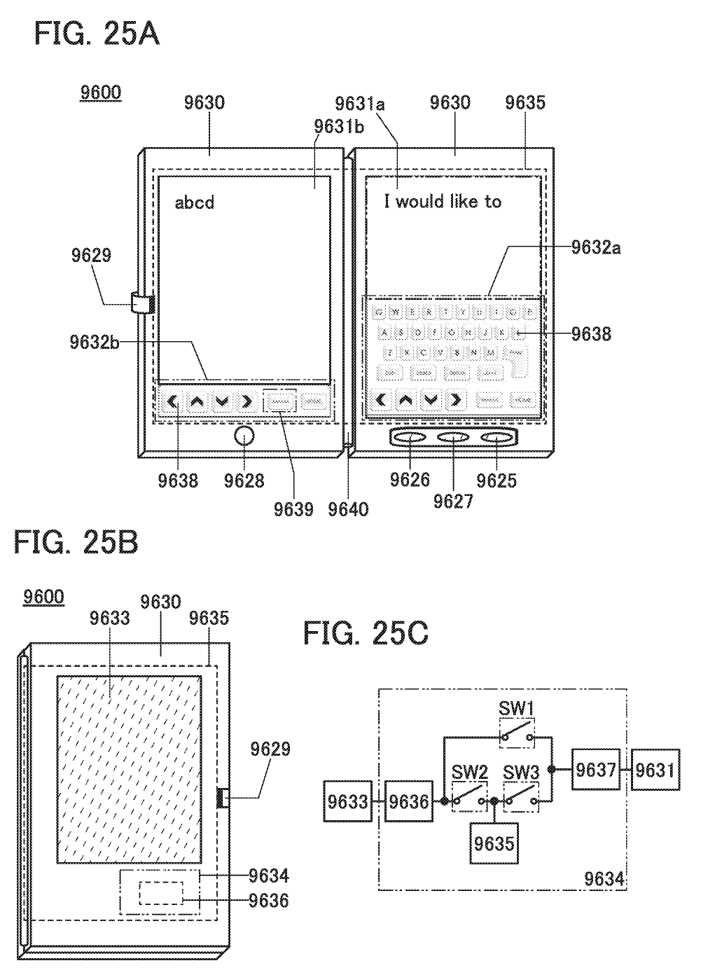

FIGS. 25A and 25B illustrate an example of a tablet terminal that can be folded in half. A tablet terminal 9600 illustrated in FIGS. 25A and 25B includes a pair of housings 9630, a movable portion 9640 connecting the pair of housings 9630, a display portion 9631a, a display portion 9631b, a display mode changing switch 9626, a power switch 9627, a power saving mode changing switch 9625, a fastener 9629, and an operation switch 9628. FIG. 25A illustrates the tablet terminal 9600 that is opened, and FIG. 25B illustrates the tablet terminal 9600 that is closed.

The tablet terminal 9600 includes a power storage unit 9635 inside the housings 9630. The power storage unit 9635 is provided across the housings 9630, passing through the movable portion 9640.

Part of the display portion 9631a can be a touch panel region 9632a, and data can be input by touching operation keys 9638 that are displayed. Note that FIG. 25A shows, as an example, that half of the area of the display portion 9631a has only a display function and the other half of the area has a touch panel function. However, the structure of the display portion 9631a is not limited to this, and all the area of the display portion 9631a may have a touch panel function. For example, all the area of the display portion 9631a can display a keyboard and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode changing switch 9626 allows switching between a landscape mode and a portrait mode, color display and black-and-white display, and the like. The power saving mode changing switch 9625 can control display luminance in accordance with the amount of external light in use of the tablet terminal 9600, which is measured with an optical sensor incorporated in the tablet terminal 9600. In addition to the optical sensor, other detecting devices such as sensors for determining inclination, such as a gyroscope or an acceleration sensor, may be incorporated in the tablet terminal.

Although the display portion 9631a and the display portion 9631b have the same area in FIG. 25A, one embodiment of the present invention is not limited to this example. The display portion 9631a and the display portion 9631b may have different areas or different display quality. For example, one of the display portions 9631a and 9631b may display higher definition images than the other.

The tablet terminal is closed in FIG. 25B. The tablet terminal includes the housing 9630, a solar cell 9633, and a charge and discharge control circuit 9634 including a DC-DC converter 9636. The power storage device of one embodiment of the present invention is used as the power storage unit 9635.

The tablet terminal 9600 can be folded such that the pair of housings 9630 overlap with each other when not in use. Thus, the display portions 9631a and 9631b can be protected, which increases the durability of the tablet terminal 9600. In addition, the power storage unit 9635 of one embodiment of the present invention has flexibility and can be repeatedly bent without a significant decrease in charge and discharge capacity. Thus, a highly reliable tablet terminal can be provided.

The tablet terminal illustrated in FIGS. 25A and 25B can also have a function of displaying various kinds of data (e.g., a still image, a moving image, and a text image) on the display portion, a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processing portion, and the like. Note that the solar cell 9633 can be provided on one surface or opposite surfaces of the housing 9630 and the power storage unit 9635 can be charged efficiently. The use of a lithium-ion battery as the power storage unit 9635 brings an advantage such as reduction in size.

The structure and operation of the charge and discharge control circuit 9634 illustrated in FIG. 25B will be described with reference to a block diagram in FIG. 25C. The solar cell 9633, the power storage unit 9635, the DC-DC converter 9636, a converter 9637, switches SW1 to SW3, and the display portion 9631 are illustrated in FIG. 25C, and the power storage unit 9635, the DC-DC converter 9636, the converter 9637, and the switches SW1 to SW3 correspond to the charge and discharge control circuit 9634 in FIG. 25B.

First, an example of operation when electric power is generated by the solar cell 9633 using external light will be described. The voltage of electric power generated by the solar cell is raised or lowered by the DC-DC converter 9636 to a voltage for charging the power storage unit 9635. When the display portion 9631 is operated with the electric power from the solar cell 9633, the switch SW1 is turned on and the voltage of the electric power is raised or lowered by the converter 9637 to a voltage needed for operating the display portion 9631. When display on the display portion 9631 is not performed, the switch SW1 is turned off and the switch SW2 is turned on, so that the power storage unit 9635 can be charged.

Note that the solar cell 9633 is described as an example of a power generation means; however, one embodiment of the present invention is not limited to this example. The power storage unit 9635 may be charged using another power generation means such as a piezoelectric element or a thermoelectric conversion element (Peltier element). For example, the power storage unit 9635 may be charged with a non-contact power transmission module capable of performing charging by transmitting and receiving electric power wirelessly (without contact), or any of the other charge means used in combination.

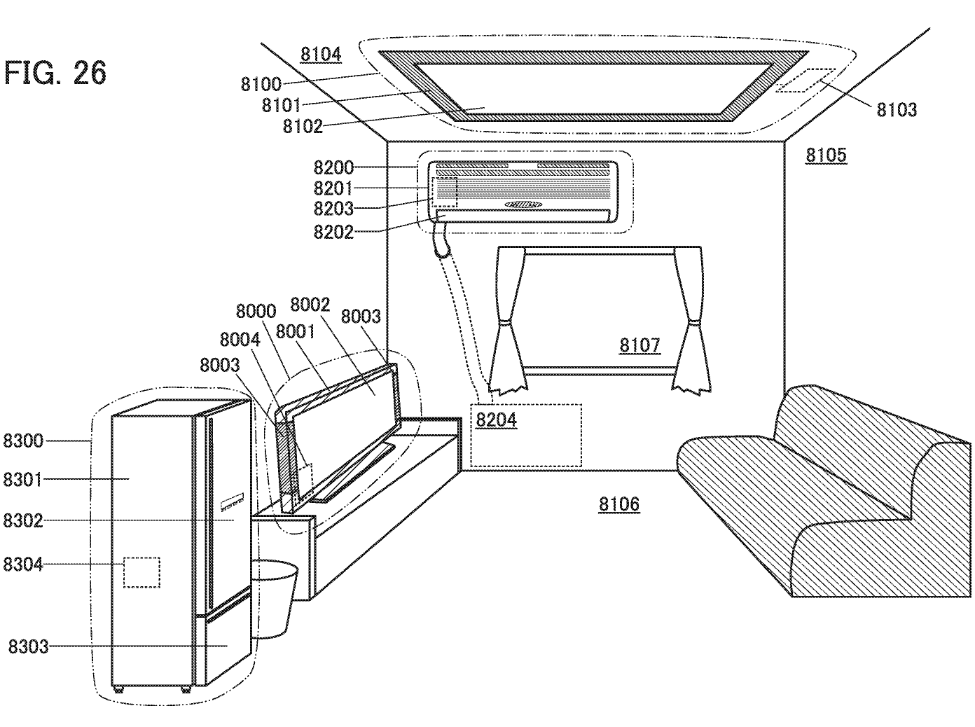

FIG. 26 illustrates other examples of electronic devices. In FIG. 26, a display device 8000 is an example of an electronic device including a power storage device 8004 of one embodiment of the present invention. Specifically, the display device 8000 corresponds to a display device for TV broadcast reception and includes a housing 8001, a display portion 8002, speaker portions 8003, and the power storage device 8004. The power storage device 8004 of one embodiment of the present invention is provided in the housing 8001. The display device 8000 can receive electric power from a commercial power supply. Alternatively, the display device 8000 can use electric power stored in the power storage device 8004. Thus, the display device 8000 can be operated with the use of the power storage device 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 26, an installation lighting device 8100 is an example of an electronic device including a power storage device 8103 of one embodiment of the present invention. Specifically, the lighting device 8100 includes a housing 8101, a light source 8102, and the power storage device 8103. Although FIG. 26 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power supply. Alternatively, the lighting device 8100 can use electric power stored in the power storage device 8103. Thus, the lighting device 8100 can be operated with the use of power storage device 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 26 as an example, the power storage device of one embodiment of the present invention can be used in an installation lighting device provided in, for example, a wall 8105, a floor 8106, a window 8107, or the like other than the ceiling 8104. Alternatively, the power storage device of one embodiment of the present invention can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 26, an air conditioner including an indoor unit 8200 and an outdoor unit 8204 is an example of an electronic device including a power storage device 8203 of one embodiment of the present invention. Specifically, the indoor unit 8200 includes a housing 8201, an air outlet 8202, and the power storage device 8203. Although FIG. 26 illustrates the case where the power storage device 8203 is provided in the indoor unit 8200, the power storage device 8203 may be provided in the outdoor unit 8204. Alternatively, the power storage devices 8203 may be provided in both the indoor unit 8200 and the outdoor unit 8204. The air conditioner can receive electric power from a commercial power supply. Alternatively, the air conditioner can use electric power stored in the power storage device 8203. Particularly in the case where the power storage devices 8203 are provided in both the indoor unit 8200 and the outdoor unit 8204, the air conditioner can be operated with the use of the power storage device 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 26 as an example, the power storage device of one embodiment of the present invention can be used in an air conditioner in which the functions of an indoor unit and an outdoor unit are integrated in one housing.

In FIG. 26, an electric refrigerator-freezer 8300 is an example of an electronic device including a power storage device 8304 of one embodiment of the present invention. Specifically, the electric refrigerator-freezer 8300 includes a housing 8301, a door for a refrigerator 8302, a door for a freezer 8303, and the power storage device 8304. The power storage device 8304 is provided in the housing 8301 in FIG. 26. The electric refrigerator-freezer 8300 can receive electric power from a commercial power supply. Alternatively, the electric refrigerator-freezer 8300 can use electric power stored in the power storage device 8304. Thus, the electric refrigerator-freezer 8300 can be operated with the use of the power storage device 8304 of one embodiment of the present invention as an uninterruptible power supply even when electric power cannot be supplied from a commercial power supply due to power failure or the like.

Note that a high-frequency heating apparatus such as a microwave oven and an electronic device such as an electric rice cooker require high power in a short time. The tripping of a breaker of a commercial power supply in use of an electronic device can be prevented by using the power storage device of one embodiment of the present invention as an auxiliary power supply for supplying electric power which cannot be supplied enough by a commercial power supply.

In addition, in a time period when electronic devices are not used, particularly when the proportion of the amount of electric power which is actually used to the total amount of electric power which can be supplied from a commercial power supply source (such a proportion referred to as a usage rate of electric power) is low, electric power can be stored in the power storage device, whereby the usage rate of electric power can be reduced in a time period when the electronic devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power supply; thus, the usage rate of electric power in daytime can be reduced.

Furthermore, the power storage device of one embodiment of the present invention can be provided in a vehicle.

The use of power storage devices in vehicles enables production of next-generation clean energy vehicles such as hybrid electric vehicles (HEVs), electric vehicles (EVs), and plug-in hybrid electric vehicles (PHEVs).

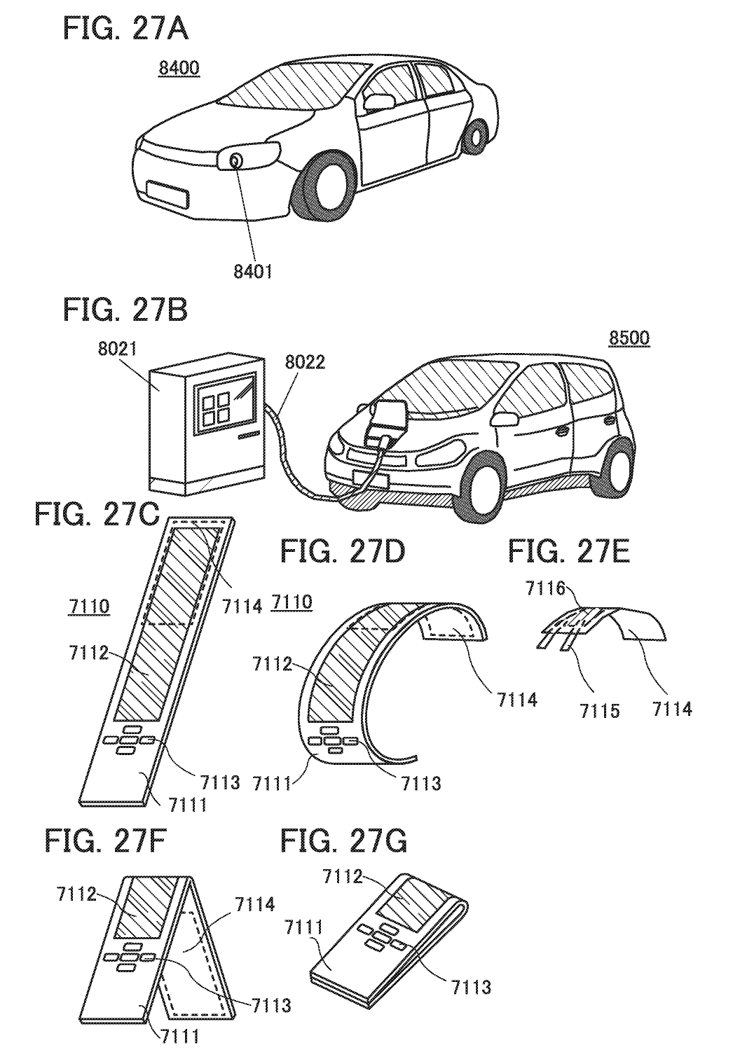

FIGS. 27A and 27B each illustrate an example of a vehicle using one embodiment of the present invention. An automobile 8400 illustrated in FIG. 27A is an electric vehicle that runs on the power of an electric motor. Alternatively, the automobile 8400 is a hybrid electric vehicle capable of driving appropriately using either the electric motor or the engine. One embodiment of the present invention can provide a high-mileage vehicle. The automobile 8400 includes the power storage device. The power storage device is used not only for driving the electric motor, but also for supplying electric power to a light-emitting device such as a headlight 8401 or a room light (not illustrated).

The power storage device can also supply electric power to a display device of a speedometer, a tachometer, or the like included in the automobile 8400. Furthermore, the power storage device can supply electric power to a semiconductor device included in the automobile 8400, such as a navigation system.

FIG. 27B illustrates an automobile 8500 including the power storage device. The automobile 8500 can be charged when the power storage device is supplied with electric power through external charging equipment by a plug-in system, a contactless power feeding system, or the like. In FIG. 27B, a power storage device included in the automobile 8500 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The ground-based charging apparatus 8021 may be a charging station provided in a commerce facility or a power source in a house. For example, with the use of a plug-in technique, the power storage device included in the automobile 8500 can be charged by being supplied with electric power from outside. The charging can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Furthermore, the power storage device included in the vehicle can be used as a power source for supplying electric power to products other than the vehicle. In such a case, the use of a commercial power source can be avoided at peak time of electric power demand.

FIG. 27C illustrates an example of a portable information terminal that can be bent. When bent to be put around a forearm, a portable information terminal 7110 can be used as a bangle-type portable information terminal as illustrated in FIG. 27D. A portable information terminal 7110 includes a housing 7111, a display portion 7112, an operation button 7113, and a power storage device 7114. FIG. 27E illustrates the power storage device 7114 in FIG. 27D that can be bent. When the portable information terminal is worn on a user's arm while the power storage device 7114 is bent, the housing 7111 changes its form and the curvature of a part or the whole of the power storage device 7114 is changed. Specifically, the curvature of a part or the whole of the housing 7111 or the main surface of the power storage device 7114 is changed in the range of radius of curvature from 10 mm to 150 mm. Note that the power storage device 7114 includes a lead electrode 7115 that is electrically connected to a current collector 7116. For example, a surface of a film of an exterior body of the power storage device 7114 is preferably provided with a plurality of projections and depressions by pressing, in which case the power storage device 7114 can retain high reliability even when the power storage device 7114 is bent many times with different curvatures. The portable information terminal 7110 may further be provided with a slot for insertion of a SIM card, a connector portion for connecting a USB device such as a USB memory. When the portable information terminal 7110 in FIG. 27C is bent in the middle, it can have a shape illustrated in FIG. 27F. When the portable information terminal is folded in the middle so that end portions of the portable information terminal overlap with each other as illustrated in FIG. 27G, the portable information terminal can be reduced in size so as to be put in, for example, a pocket of clothes a user wears. As described above, the portable information terminal illustrated in FIG. 27C can be changed in form in more than one way, and it is desirable that at least the housing 7111, the display portion 7112, and the power storage device 7114 have flexibility in order to change the form of the portable information terminal.

This embodiment can be combined with any of the other embodiments as appropriate.

### Example 1

In this example, evaluation results of the characteristics of the power storage device of one embodiment of the present invention that was fabricated will be described.

In this example, the battery cell 500 illustrated in FIG. 1A was fabricated.

In this example, four samples, Samples 1A and 1B fabricated using one embodiment of the present invention and Comparative samples 1C and 1D, were used.

The samples fabricated in this example each included two positive electrodes in each of which a positive electrode active material layer was provided on one surface of a positive electrode current collector and one negative electrode in which negative electrode active material layers were provided on opposite surfaces of a negative electrode current collector. In other words, the samples in this example each included two positive electrode active material layers and two negative electrode active material layers.

First, methods for fabricating the electrodes will be described.

### [Fabricating Method for Negative Electrode]

The same fabricating method was used to form the negative electrodes of all the samples in this example.

Spherical natural graphite having a specific surface area of 6.3 m²/g and an average particle size of 15 μm was used as a negative electrode active material. For a binder, sodium carboxymethyl cellulose (CMC-Na) and SBR were used. The polymerization degree of CMC-Na that was used was 600 to 800, and the viscosity of a 1 wt % CMC-Na aqueous solution was in the range from 300 mPa·s to 500 mPa·s. The compounding ratio of graphite:CMC-Na:SBR was set to 97:1:1.5 (wt %).

First, CMC-Na powder and an active material were mixed and then kneaded with a mixer, so that a first mixture was obtained.

Subsequently, a small amount of water was added to the first mixture and kneading was performed, so that a second mixture was obtained. Here, “kneading” means “mixing something with a high viscosity”.

Then, water was further added and the mixture was kneaded with a mixer, so that a third mixture was obtained.

Then, a 50 wt % SBR aqueous dispersion liquid was added to the third mixture, and mixing was performed with a mixer. After that, the obtained mixture was degassed under a reduced pressure, so that a slurry was obtained.

Subsequently, the slurry was applied to a negative electrode current collector with the use of a continuous coater. An 18-μm-thick rolled copper foil was used as the negative electrode current collector. The coating speed was set to 0.75 m/min.

Then, the solvent in the slurry applied to the negative electrode current collector was vaporized in a drying furnace. Vaporization treatment was performed at 50° C. in an air atmosphere for 120 seconds and then further performed at 80° C. in the air atmosphere for 120 seconds. After that, further vaporization treatment was performed at 100° C. under a reduced pressure (−100 KPa) for 10 hours.

Through the above steps, the negative electrode active material layer was formed on opposite surfaces of the negative electrode current collector, so that the negative electrode was fabricated.

### [Fabricating Method for Positive Electrodes of Sample 1A, Comparative Sample 1C, and Comparative Sample 1D]

The same fabricating method was used to form the positive electrodes of Sample 1A, Comparative sample 1C, and Comparative sample 1D. Note that a fabricating method for the positive electrodes of Sample 1B was different from the above method, and thus will be described below.

LiFePO₄ with a specific surface area of 15.6 m²/g was used as a positive electrode active material, PVdF was used as a binder, and acetylene black was used as a conductive additive. The compounding ratio of LiFePO₄:PVdF:acetylene black was set to 85:8:7 (wt %).

First, acetylene black and PVdF were mixed in a mixer, so that a first mixture was obtained.

Next, the active material was added to the first mixture, so that a second mixture was obtained.

After that, a solvent N-methyl-2-pyrrolidone (NMP) was added to the second mixture and mixing was performed with a mixer. Through the above steps, a slurry was formed.

Then, mixing was performed with a large-sized mixer.

Subsequently, the slurry was applied to a positive electrode current collector with the use of a continuous coater. A 20-μm-thick aluminum current collector which had been covered with an undercoat in advance was used as the positive electrode current collector. The coating speed was set to 0.2 m/min.

Then, the solvent in the slurry applied to the positive electrode current collector was vaporized in a drying furnace. Solvent vaporization treatment was performed at 70° C. in an air atmosphere for 7.5 minutes and then further performed at 90° C. in the air atmosphere for 7.5 minutes.

Subsequently, the positive electrode active material layer was pressed by a roll press method so as to be consolidated. After that, heat treatment was performed in a reduced-pressure atmosphere (−100 KPa) at 170° C. for 10 hours.

Through the above steps, the positive electrode active material layer was formed on one surface of the positive electrode current collector, so that the positive electrode was fabricated.

### [Fabricating Method for Positive Electrode of Sample 1B]

LiFePO₄ with a specific surface area of 15.6 m²/g was used as a positive electrode active material, PVdF was used as a binder, and graphene was used as a conductive additive. Note that graphene was obtained by reducing graphene oxide, which was used to form the slurry, after application of the electrode. The compounding ratio of LiFePO₄:graphene oxide:PVdF was set to 94.2:0.8:5.0 (wt %).

First, NMP serving as a solvent and PVdF were mixed with a mixer, so that a first mixture was obtained.

Subsequently, the active material was added to the first mixture to obtain a second mixture.

Subsequently, graphene oxide was added to the second mixture and mixing was performed with a mixer, so that a third mixture was obtained.

Subsequently, the solvent NMP was added to the third mixture and mixing was performed with a mixer. Through the above steps, the slurry was formed.

Subsequently, the slurry was applied to a positive electrode current collector with the use of a continuous coater. A 20-μm-thick aluminum current collector which had been covered with an undercoat in advance was used as the positive electrode current collector. The coating speed was set to 0.1 m/min.

Then, the solvent in the slurry applied to the positive electrode current collector was vaporized in a drying furnace. Solvent vaporization treatment was performed at 65° C. in an air atmosphere for 15 minutes and then further performed at 75° C. in the air atmosphere for 15 minutes.

Next, the graphene oxide was reduced. As the reduction, chemical reduction was first performed, followed by thermal reduction. A solution used for the chemical reduction was prepared as follows: a solvent in which NMP and water were mixed at 9:1 was used, and ascorbic acid and LiOH were added to the solvent to have a concentration of 77 mmol/L and 73 mmol/L, respectively. The chemical reduction was performed at 60° C. for 1 hour. After that, washing with ethanol was performed, and the solvent was vaporized in a reduced pressure atmosphere of −100 KPa at room temperature. Then, the thermal reduction was performed at 170° C. in a reduced pressure atmosphere of −100 KPa for 10 hours.

Subsequently, the positive electrode active material layer was pressed by a roll press method so as to be consolidated.

Through the above steps, the positive electrode active material layer was formed on one surface of the positive electrode current collector, so that the positive electrode was fabricated. Through the above steps, the positive electrode active material layer was formed on one surface of the positive electrode current collector, so that the positive electrode was fabricated.

Table 1 lists the averages of the active material loadings, the thicknesses, and the densities of each of the positive electrode active material layers and the negative electrode active material layers that were formed. The values shown in this specification are the averages of measurement values of each of the electrodes used in fabricating the samples. Note that when the active material layers were formed on opposite surfaces of the current collector, the values are the averages of the active material loadings, the thicknesses, and the densities of the active material layer on one surface of the current collector.

TABLE 1

| | | Sample | Sample | Comparative | Comparative |
|---|---|---|---|---|---|
| | | 1A | 1B | Sample 1C | Sample 1D |
| Positive | Loading | 7.7 | 8.5 | 7.7 | 8.0 |
| electrode | (mg/cm²) | | | | |
| | Thickness | 57 | 53 | 62 | 63 |
| | (μm) | | | | |
| | Density | 1.61 | 1.62 | 1.46 | 1.50 |
| | (g/cc) | | | | |
| Negative | Loading | 5.5 | 5.5 | 5.4 | 5.6 |
| electrode | (mg/cm²) | | | | |
| | Thickness | 60 | 62 | 61 | 57 |
| | (μm) | | | | |
| | Density | 0.95 | 0.89 | 0.92 | 1.02 |
| | (g/cc) | | | | |

In the electrolytic solution, 1-butyl-3-methylimidazolium bis(fluorosulfonyl)amide (abbreviation: BMI-FSA) represented by the following structural formula was used as a solvent and lithium bis(fluorosulfonyl)amide (LiN(FSO₂)₂, abbreviation: LiFSA) was used as a salt. LiFSA was dissolved in BMI-FSA, so that an electrolytic solution with a LiFSA concentration of 1.8 mol/kg was prepared.

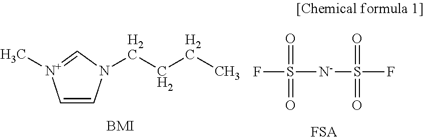

In Samples 1A and 1B fabricated using one embodiment of the present invention, a 46-μm-thick separator containing polyphenylene sulfide (hereinafter also referred to as a PPS separator) was used. In Comparative sample 1C, a 50-μm-thick separator containing cellulose (hereinafter also referred to as a cellulose separator) was used. In Comparative sample 1D, a 25-μm-thick separator containing polyolefin (hereinafter also referred to as a polyolefin separator) was used.

As an exterior body, an aluminum film with opposite surfaces covered with a resin layer was used.

Next, fabrication methods for the samples will be described.

First, a positive electrode, a negative electrode, and a separator were cut. The area of each of the positive electrode and the negative electrode was 8.19 cm².

Then, the positive electrode active material and the negative electrode active material in tab regions were removed to expose the current collectors.

Subsequently, the separator was folded in half, and the positive electrode or the negative electrode was provided so as to be located between facing surfaces of the folded separator.

After that, the electrode (the positive electrode or the negative electrode) that is sandwiched by the separator and the electrode (the negative electrode or the positive electrode) that is not sandwiched by the separator were stacked. At that time, the positive electrode and the negative electrode were stacked such that the positive electrode active material layer and the negative electrode active material layer faced each other.

Then, lead electrodes were attached to the positive electrode and the negative electrode.

Then, facing parts of two of four sides of the exterior body were bonded to each other by heating.

After that, sealing layers provided for the lead electrodes were positioned so as to overlap with a sealing layer of the exterior body, and bonding was performed by heating. At this time, facing parts of a side of the exterior body except a side used for introduction of an electrolytic solution were bonded to each other.

Then, the exterior body and the positive electrode, the separator, and the negative electrode wrapped by the exterior body were heated at 80° C. under a reduced pressure atmosphere (−100 KPa) for 10 hours.

Subsequently, an electrolytic solution was introduced into a space surrounded by the exterior body in an argon gas atmosphere from one side that was not sealed. After that, the one side of the exterior body was sealed by heating in a reduced pressure atmosphere (−100 KPa). Through the above steps, each thin storage battery was fabricated.

Next, aging was performed on the samples. Note that in aging, a 2-hour break was taken after each of the charging and the discharging.

First, constant current charging was performed at a rate of 0.01 C at 25° C. The charging was performed until the voltage reached an upper voltage limit of 3.2 V. Constant current charging is a charging method in which a constant current is made to flow to a sample during the whole charging period and charging is terminated when the voltage reaches a predetermined voltage.

Here, a charge rate and a discharge rate will be described. A charge rate of 1 C means a current value with which charging is terminated in exactly 1 hour in the case of charging a cell with a capacity of X (Ah) at a constant current. When 1 C=I (A), a charge rate of 0.2 C means I/5 (A), i.e., a current value at which charging is terminated in exactly 5 hours. Similarly, a discharge rate of 1 C means a current value at which discharging is terminated in exactly 1 hour in the case of discharging a cell with a capacity of X (Ah) at a constant current. A discharge rate of 0.2 C means I/5 (A), i.e., a current value at which discharging is terminated in exactly 5 hours.

Here, the rate was calculated using the theoretical capacity (170 mAh/g) of LiFePO₄ which is a positive electrode active material as a reference.

In an argon atmosphere, the exterior body was cut at one side to be opened, and degasification was performed. Then, the one side of the exterior body that was opened was sealed again in a reduced-pressure atmosphere (−100 KPa).

Next, constant current charging was performed at a rate of 0.05 C at 25° C. The charging was performed until the voltage reached an upper voltage limit of 4.0 V. Then, constant current discharging was performed at a rate of 0.2 C at 25° C. The discharging was performed until the voltage reached a lower voltage limit of 2.0 V. Moreover, charging and discharging were performed twice at a rate of 0.2 C at 25° C. The charging was performed until the voltage reached an upper limit of 4.0 V, and the discharging was performed until the voltage reached a lower limit of 2.0 V. Constant current discharging is a discharging method in which a constant current is made to flow from a sample during the whole discharging period and discharging is ended when the voltage reaches a predetermined voltage.

Through the above steps, the samples were fabricated.

Next, the charge and discharge cycle performances at 100° C. of the samples in this example were measured. The measurement was performed with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charging and the discharging were performed at a rate of 0.3 C. Note that for calculation of the rate, 1 C was set to 170 mA/g, which was the current value per weight of the positive electrode active material. In addition, a 10-minute break was taken after each of the charging and the discharging.

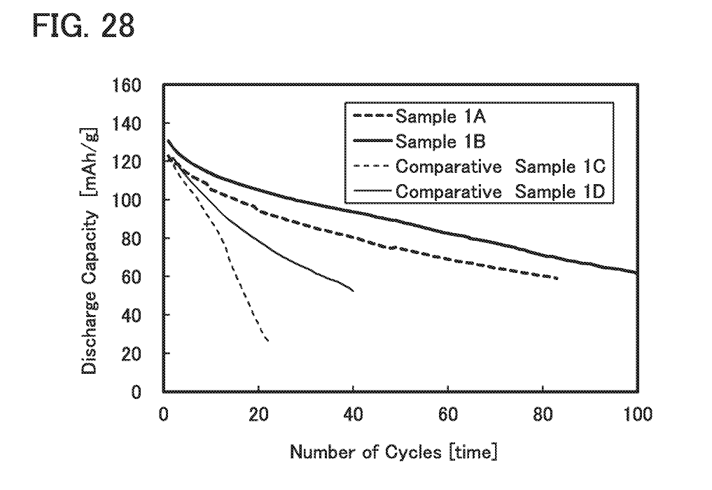

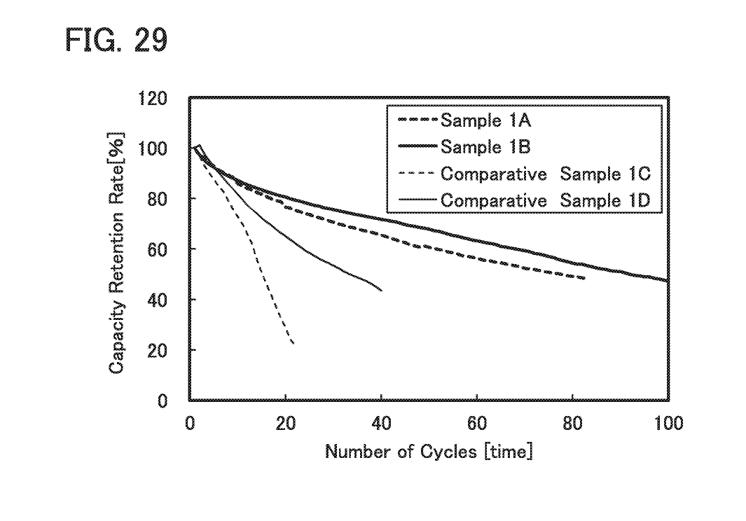

FIGS. 28 and 29 each show the charge and discharge cycle performance of the samples in this example. In FIG. 28, the horizontal axis represents the number of cycles (times), and the vertical axis represents discharge capacity (mAh/g). In FIG. 29, the horizontal axis represents the number of cycles (times) and the vertical axis represents the capacity retention rate (%).

Here, the capacity retention rate refers to the proportion of discharge capacity in each cycle to the initial discharge capacity. Table 2 also lists the capacity retention rates of Samples 1A and 1B.

TABLE 2

| | Capacity retention rate | |
|---|---|---|
| | [%] | |
| Number of cycles | Sample 1A | Sample 1B |
| 50 | 60.62 | 67.77 |
| 60 | 56.25 | 63.25 |
| 70 | 52.34 | 59.32 |
| 80 | 49.07 | 54.41 |
| 90 | — | 50.99 |
| 100 | — | 47.13 |

According to FIG. 29, the capacity retention rate of Comparative sample 1C was approximately 22% in the 22nd cycle, and the capacity retention rate of Comparative sample 1D was approximately 43% in the 40th cycle. In contrast, according to FIG. 29 and Table 2, the capacity retention rates of Sample 1A and Sample 1B, which are embodiments of the present invention, were approximately 49% in the 80th cycle and approximately 47% in the 100th cycle, respectively.

The results of this example indicate that the power storage devices using a PPS separator of one embodiment of the present invention had charge and discharge cycle performance at high temperature that was superior to those of the power storage device using a cellulose separator and the power storage device using a polyolefin separator.

### Example 2

In this example, results obtained by examining a reaction between a separator and an electrolytic solution by thermal analysis will be described.

In Example 1, the charge and discharge cycle performance at high temperature depended on the separator. For example, whether the separator and the electrolytic solution react with each other presumably caused the difference in charge and discharge cycle performance at high temperature.

The power storage device including the cellulose separator and the electrolytic solution containing an ionic liquid was disassembled after a charge and discharge test at 100° C., and it was observed that the separator was discolored in the vicinity of a negative electrode tab region and in the vicinity of the outer region of the negative electrode. In addition, it was also found by surface observation with a scanning electron microscope (SEM) that there was a large amount of deposit in the separator after the charge and discharge test compared with the separator not used yet. This is presumably due to a change in quality of the separator or the reaction with the electrolytic solution.

Meanwhile, the power storage device including the PPS separator and the electrolytic solution containing an ionic liquid of one embodiment of the present invention that was disassembled after a charge and discharge test at 100° C., and the separator was scarcely discolored.

In this example, thermogravimetry-differential thermal analysis (TG-DTA) was performed to examine whether a separator and an electrolytic solution reacted with each other. The analysis was performed with Thermo Mass Photo (manufactured by Rigaku Corporation) at a temperature increase rate of 10° C./min under helium stream (the flow rate: 300 ml/min) until the temperature reached 600° C.

The electrolytic solution used in this example was the same as that used in Example 1. Specifically, BMI-FSA was used as a solvent, and LiFSA was used as a salt. LiFSA was dissolved in BMI-FSA, so that an electrolytic solution with a LiFSA concentration of 1.8 mol/kg was prepared.

In this example, a 46-μm-thick separator containing polyphenylene sulfide was used for embodiments of the present invention, and a 50-μm-thick separator containing cellulose was used for comparative examples.

In this example, five kinds of samples were used: Sample 2A with a structure in which a PPS separator was put in an electrolytic solution; Sample 2B only with a PPS separator; Sample 2C with a structure in which a cellulose separator was put in an electrolytic solution; Sample 2D only with a cellulose separator; and Sample 2E only with an electrolytic solution.

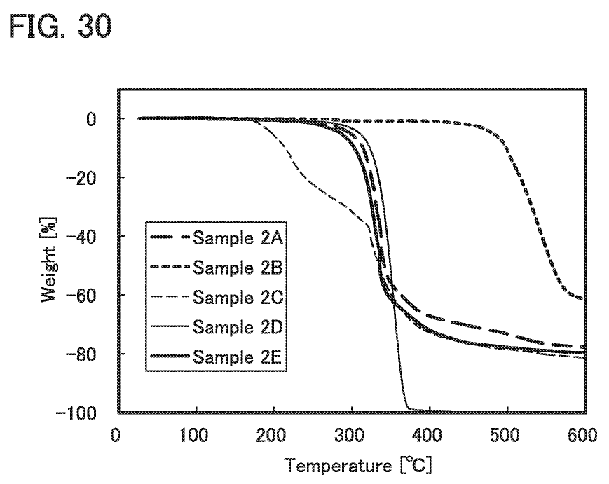

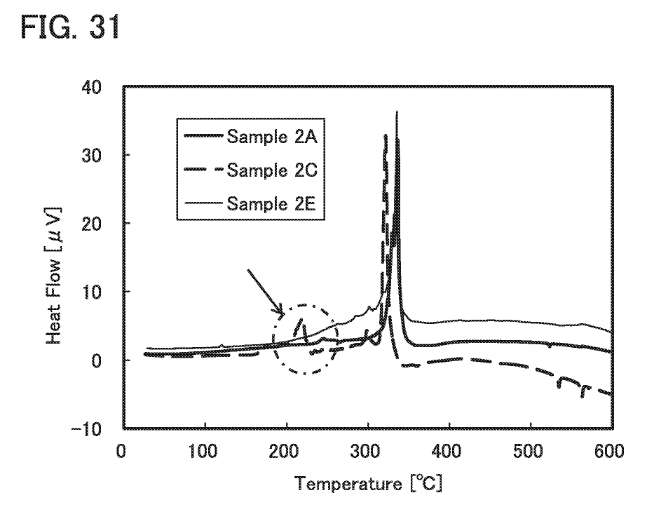

FIG. 30 shows results of weight loss measurement. FIG. 31 shows results of differential thermal analysis.

The results of Samples 2B and 2D in FIG. 30 show that the weight of each separator started to decrease at a temperature higher than the decomposition temperature of the electrolytic solution. For this reason, as for the reaction between the separator and the electrolytic solution, focus is given to changes at temperatures lower than or equal to 300° C.

The weight of Sample 2C with a structure in which a cellulose separator was put in an electrolytic solution significantly decreased at temperatures lower than or equal to 300° C. compared with the weight of Sample 2E.

As shown by an arrow in FIG. 31, Sample 2C has a heat generation peak, which is not observed from Sample 2E. This suggests that the electrolytic solution using an ionic liquid and the cellulose separator reacted with each other by heat.

There is almost no difference between Sample 2A with a structure in which a PPS separator was put in an electrolytic solution and Sample 2E only with an electrolytic solution at temperatures lower than or equal to 300° C. in FIG. 30. Also in FIG. 31, a peak different from that of Sample 2E is not observed.

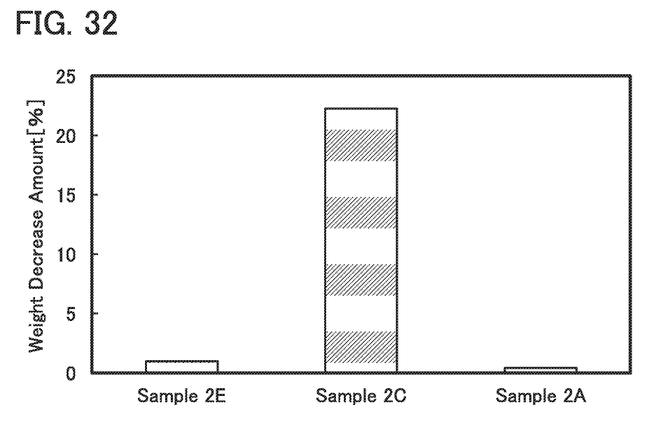

FIG. 32 shows the weight decrease amount of each of Sample 2A and Sample 2C at a temperature at which the weight decrease amount of the electrolytic solution was approximately 1% (that is, the weight decrease amount of Sample 2E was approximately 1%). It is found from FIG. 32 that the weight of the cellulose separator decreased approximately 20 times as much as that of the PPS separator.

The above results imply that the PPS separator was noticeably stable toward the electrolytic solution using an ionic liquid.

Furthermore, thermogravimetry-differential thermal analysis-mass spectrometry (TG-DTA-MS) was performed on Sample 2A (with the structure in which a PPS separator was put in an electrolytic solution), Sample 2C (with the structure in which a cellulose separator was put in an electrolytic solution), and Sample 2E (only with an electrolytic solution). The analysis was performed with Thermo Mass Photo (manufactured by Rigaku Corporation) at a temperature increase rate of 10° C./min under helium stream (the flow rate: 300 ml/min) until the temperature reached 600° C. The conditions for MS were as follows: an electron ionization (EI) method (approximately 70 eV) was used as an ionization method; and the mass measurement range was from 10 to 200 (m/z).

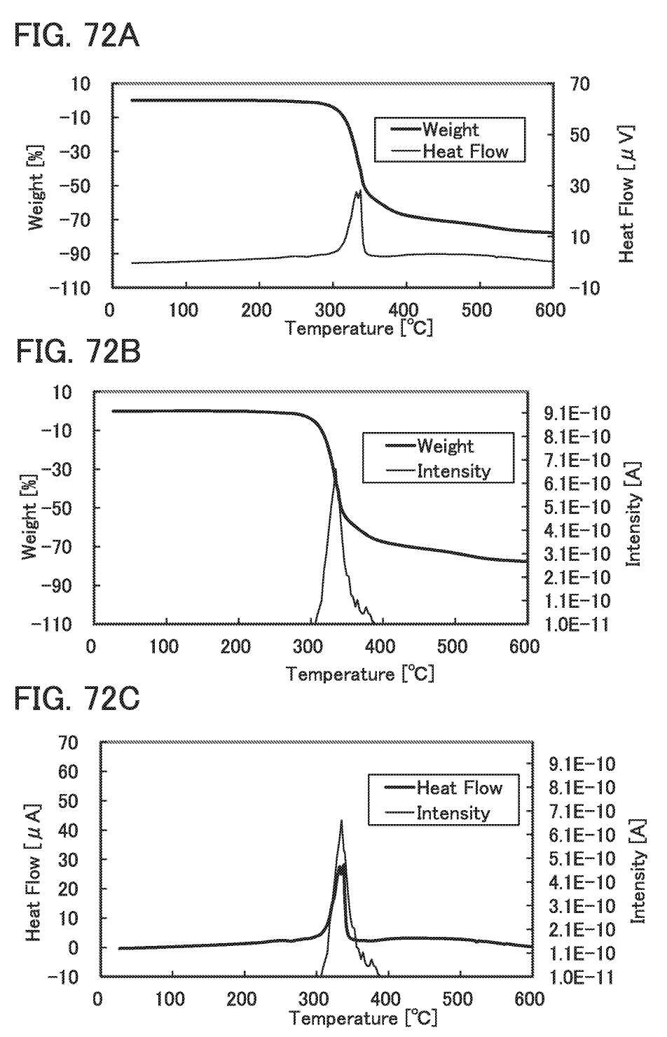

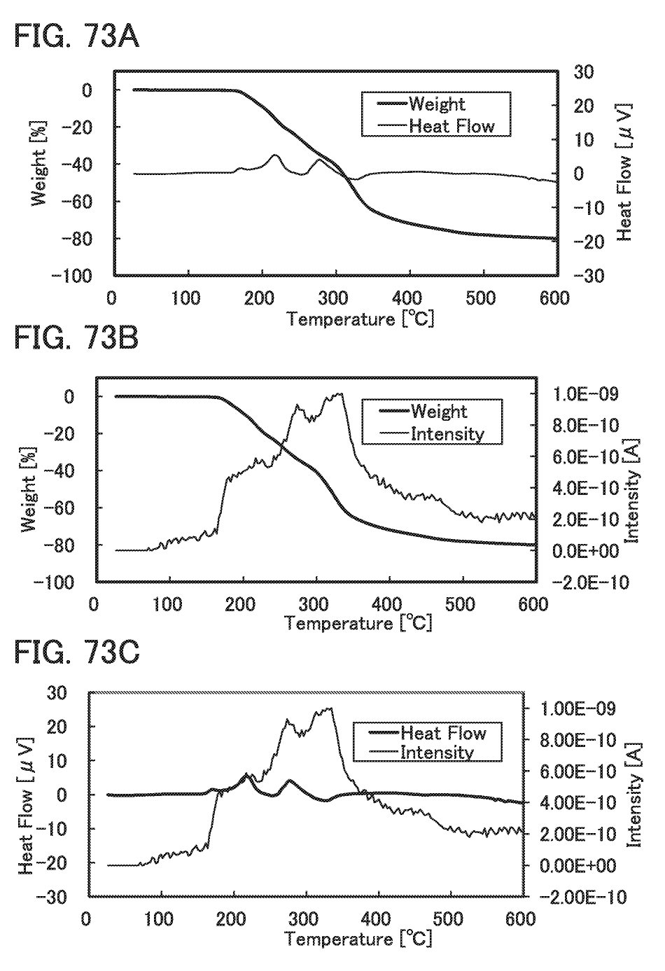

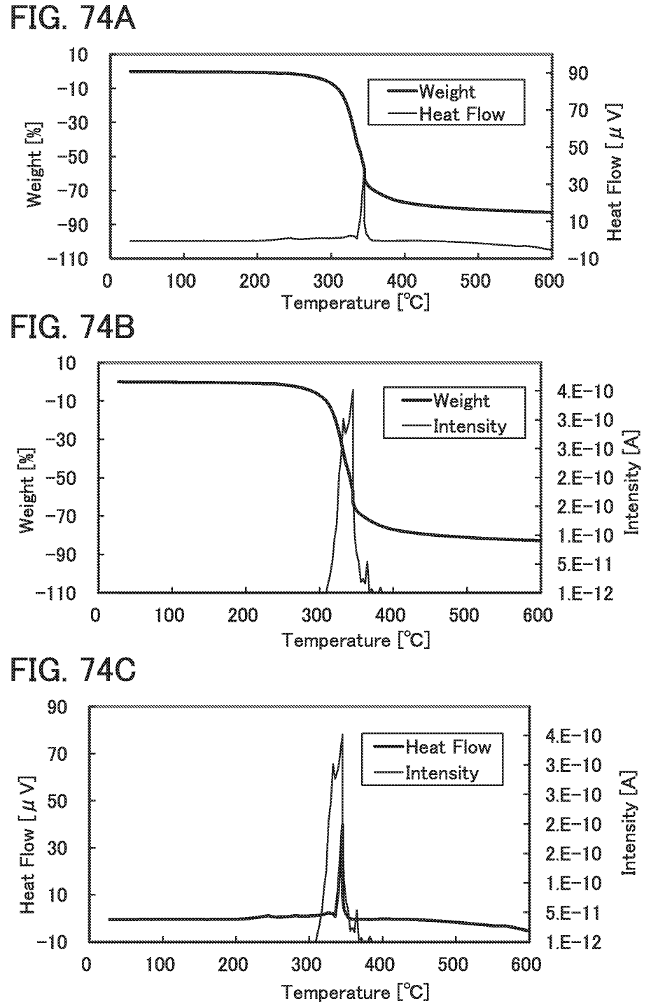

FIGS. 72A to 72C show results of TG-DTA-MS performed on Sample 2A. FIGS. 73A to 73C show results of TG-DTA-MS performed on Sample 2C. FIGS. 74A to 74C show results of TG-DTA-MS performed on Sample 2E. In this example, attention is given particularly to a peak attributed to water (a peak at m/z of 18) in mass analysis results.

In FIG. 72A, FIG. 73A, and FIG. 74A, the first vertical axis represents weight (%), the second vertical axis represents heat flow (μV), the horizontal axis represents temperature (° C.), the thick line represents thermogravimetry (TG) analysis results, and the thin line represents differential thermal analysis (DTA) results.

In FIG. 72B, FIG. 73B, and FIG. 74B, the first vertical axis represents weight (%), the second vertical axis represents intensity (A), the horizontal axis represents temperature (° C.), the thick line represents thermogravimetry (TG) analysis results, and the thin line represents mass spectrometry (MS) results.

In FIG. 72C, FIG. 73C, and FIG. 74C, the first vertical axis represents heat flow (μV), the second vertical axis represents intensity (A), the horizontal axis represents temperature (° C.), the thick line represents differential thermal analysis (DTA) results, and the thin line represents mass spectrometry (MS) results.

As shown in FIGS. 72A to 72C, Sample 2A did not have a peak at m/z of 18 at temperatures lower than or equal to 200° C., and the weight scarcely decreased. This indicates that the PPS separator and the electrolytic solution were not decomposed.

As shown in FIGS. 73A to 73C, Sample 2C had peaks at m/z of 18 at temperatures around 80° C. or higher, and the peak intensity at m/z of 18 further increased when the temperature exceeded 150° C. Meanwhile, the weight noticeably decreased when the temperature exceeded 150° C. This means that Sample 2C became easily decomposed and its weight decreased when the temperature exceeded 150° C.

As shown in FIGS. 74A to 74C, Sample 2E did not have a peak at m/z of 18 at temperatures lower than or equal to 200° C., and the weight scarcely decreased. This indicates that the electrolytic solution was not decomposed.

As described above, when the cellulose separator was put in the electrolytic solution, peaks attributed to water were observed at temperatures higher than or equal to 80° C. In contrast, when the PPS separator was put in the electrolytic solution, a peak attributed to water was not observed at temperatures lower than or equal to 200° C.

In Example 1, the sample using the PPS separator had charge and discharge cycle performance at 100° C. superior to that of the sample using the cellulose separator. The results of this example show that the cellulose separator thermally reacted with the electrolytic solution using an ionic liquid, whereas the PPS separator was extremely stable toward the electrolytic solution, and this feature of the PPS separator presumably helped improve the charge and discharge cycle performance of the sample at high temperature.

### Example 3

In this example, evaluation results of the characteristics of the power storage device of one embodiment of the present invention that was fabricated will be described.

In this example, the battery cell 500 illustrated in FIG. 1A was fabricated.

In this example, eight samples, Samples 3A, 3B, 3C, 3D, 3E, 3F, and 3G fabricated using one embodiment of the present invention and Comparative sample 3X, were used.

Samples 3A to 3F each included two positive electrodes in each of which a positive electrode active material layer was provided on one surface of a positive electrode current collector; six positive electrodes in each of which positive electrode active material layers were provided on opposite surfaces of a positive electrode current collector; and seven negative electrodes in each of which negative electrode active material layers were provided on opposite surfaces of a negative electrode current collector. In other words, Samples 3A to 3F each included 14 positive electrode active material layers and 14 negative electrode active material layers.

Sample 3G included two positive electrodes in each of which a positive electrode active material layer was provided on one surface of a positive electrode current collector; three positive electrodes in each of which positive electrode active material layers were provided on opposite surfaces of a positive electrode current collector; and four negative electrodes in each of which negative electrode active material layers were provided on opposite surfaces of a negative electrode current collector. In other words, Sample 3G included 8 positive electrode active material layers and 8 negative electrode active material layers.

Comparative sample 3X included two positive electrodes in each of which a positive electrode active material layer was provided on one surface of a positive electrode current collector; five positive electrodes in each of which positive electrode active material layers were provided on opposite surfaces of a positive electrode current collector; and six negative electrodes in each of which negative electrode active material layers were provided on opposite surfaces of a negative electrode current collector. In other words, Comparative sample 3X included 12 positive electrode active material layers and 12 negative electrode active material layers.

Materials for the positive electrode and the negative electrode in each sample of this example were the same as those of Sample 1A in Example 1.

Specifically, in the negative electrode of each sample of this example, spherical natural graphite was used as a negative electrode active material, and CMC-Na and SBR were used for a binder. In the positive electrode of each sample of this example, LiFePO₄ was used as a positive electrode active material, PVdF was used as a binder, and acetylene black was used as a conductive additive.

Forming methods for the positive electrode and the negative electrode of each sample of this example were the same as those for Sample 1A of Example 1 except for the following points. Each sample of this example included two kinds of positive electrodes: a positive electrode in which positive electrode active material layers were provided on opposite surfaces of a positive electrode current collector; and a positive electrode in which a positive electrode active material layer was provided on one surface of a positive electrode current collector.

Tables 3 and 4 list the averages of the active material loadings, the thicknesses, and the densities of each of the positive electrode active material layers and the negative electrode active material layers that were formed.

TABLE 3

| | | Sam- | Sam- | Sam- | Sam- | Sam- | |
|---|---|---|---|---|---|---|---|
| | | ple | ple | ple | ple | ple | Comparative |
| | | 3A | 3B | 3C | 3D | 3E | sample 3X |
| Positive | Loading | 9.0 | 9.1 | 9.1 | 9.0 | 9.2 | 9.1 |
| electrode | (mg/cm²) | | | | | | |
| | Thickness | 71 | 72 | 72 | 72 | 72 | 66 |
| | (μm) | | | | | | |
| | Density | 1.49 | 1.49 | 1.49 | 1.48 | 1.49 | 1.65 |
| | (g/cc) | | | | | | |
| Negative | Loading | 5.5 | 5.5 | 5.6 | 5.5 | 5.6 | 5.5 |
| electrode | (mg/cm²) | | | | | | |
| | Thickness | 57 | 57 | 58 | 57 | 57 | 58 |
| | (μm) | | | | | | |
| | Density | 0.99 | 1.00 | 0.99 | 1.01 | 1.00 | 0.97 |
| | (g/cc) | | | | | | |

TABLE 4

| | | Sample | Sample |
|---|---|---|---|
| | | 3F | 3G |
| Positive | Loading | 8.9 | 9.8 |
| electrode | (mg/cm²) | | |
| | Thickness | 70 | 75 |
| | (μm) | | |
| | Density | 1.50 | 1.54 |
| | (g/cc) | | |
| Negative | Loading | 4.9 | 5.3 |
| electrode | (mg/cm²) | | |
| | Thickness | 58 | 73 |
| | (μm) | | |
| | Density | 0.86 | 0.75 |
| | (g/cc) | | |

The electrolytic solution used in this example was the same as that used in Example 1. Specifically, BMI-FSA was used as a solvent, and LiFSA was used as a salt. LiFSA was dissolved in BMI-FSA, so that an electrolytic solution with a LiFSA concentration of 1.8 mol/kg was prepared.

In each of Samples 3A to 3F fabricated using one embodiment of the present invention, one 46-μm-thick separator containing polyphenylene sulfide was used. In Sample 3G fabricated using one embodiment of the present invention, two 46 μm-thick separators containing polyphenylene sulfide were used. In Comparative sample 3X, one 50-μm-thick separator containing cellulose was used.

As an exterior body, an aluminum film with opposite surfaces covered with a resin layer was used.

Fabricating methods for the samples in this example were the same as those in Example 1; thus, description thereof is omitted. The area of each of the positive electrode and the negative electrode was 20.49 cm².

Then, aging was performed on the samples. Aging of Samples 3A to 3G will be described below. Aging of Comparative sample 3X was performed in a manner similar to that of the samples in Example 1, and thus description thereof is omitted. Note that in aging, a 2-hour break was taken after each of the charging and the discharging.

First, constant current charging was performed at a rate of 0.01 C. The charging was performed until the voltage reached an upper voltage limit of 3.2 V. Here, the rate was calculated using the theoretical capacity (170 mAh/g) of LiFePO₄ which is a positive electrode active material as a reference.

In an argon atmosphere, the exterior body was cut at one side to be opened, and degasification was performed. Then, the one side of the exterior body that was opened was sealed again in a reduced-pressure atmosphere (−100 KPa).

Next, constant current charging was performed at a rate of 0.05 C. The charging was performed until the voltage reached an upper voltage limit of 4.0 V. Then, constant current discharging was performed at a rate of 0.2 C. The discharging was performed until the voltage reached a lower voltage limit of 2.0 V. Moreover, charging and discharging were performed twice at a rate of 0.2 C at 40° C. The charging was performed until the voltage reached an upper limit of 4.0 V, and the discharging was performed until the voltage reached a lower limit of 2.0 V.

Note that charging and discharging in aging were performed at 40° C. in Samples 3A to 3E, and were performed at 25° C. in Samples 3F and 3G.

Through the above steps, the samples were fabricated.

Next, measurement results of the characteristics of the samples will be described.

The discharge rate characteristics of Sample 3A were measured.

The measurement of the rate characteristics was performed with a charge-discharge measuring instrument (produced by TOYO SYSTEM Co., LTD.) at 25° C. Constant current charging was performed until the voltage reached an upper voltage limit of 4.0 V, and constant current discharging was performed until the voltage reached a lower voltage limit of 2.0 V. The charge rate was fixed at 0.1 C. The discharge rates were varied as follows: 0.1 C, 0.2 C, 0.3 C, 0.4 C, 0.5 C, 1 C, and 2 C. Note that for calculation of the rate, 1 C was set to 135 mA/g, which was the current value per weight of the positive electrode active material. In addition, a 30-minute break was taken after each of the charging and the discharging.

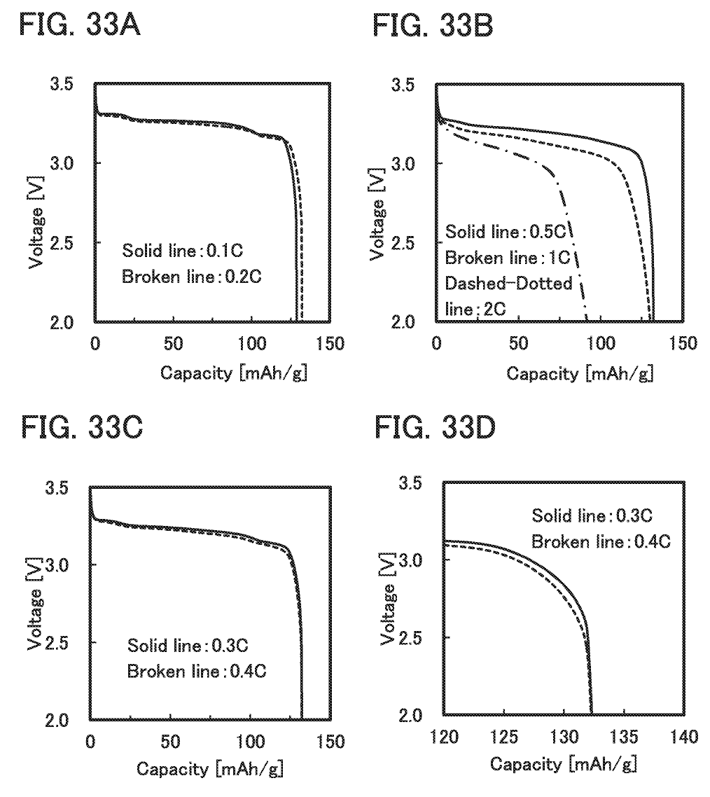

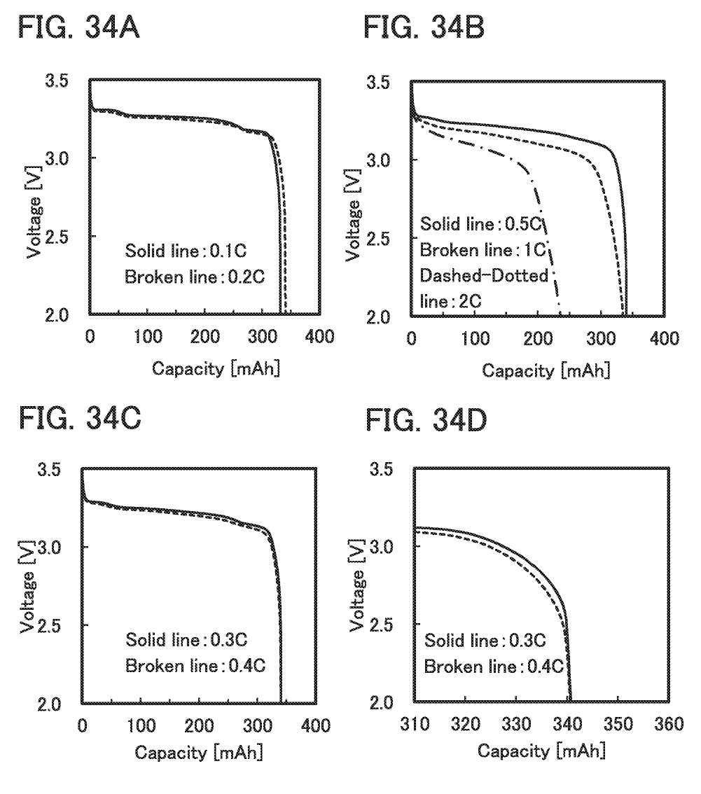

FIGS. 33A to 33D and FIGS. 34A to 34D show discharge curves of Sample 3A. In FIGS. 33A to 33D, the horizontal axis represents capacity (mAh/g), and the vertical axis represents voltage (V). In FIGS. 34A to 34D, the horizontal axis represents capacity (mAh/g), and the vertical axis represents voltage (V).

FIG. 33A and FIG. 34A show the results obtained when the discharge rates were 0.1 C and 0.2 C. FIG. 33B and FIG. 34B show the results obtained when the discharge rates were 0.5 C, 1 C, and 2 C. FIG. 33C and FIG. 34C show the results obtained when the discharge rates were 0.3 C and 0.4 C. FIG. 33D and FIG. 34D are enlarged graphs of FIG. 33C and FIG. 34C, respectively.

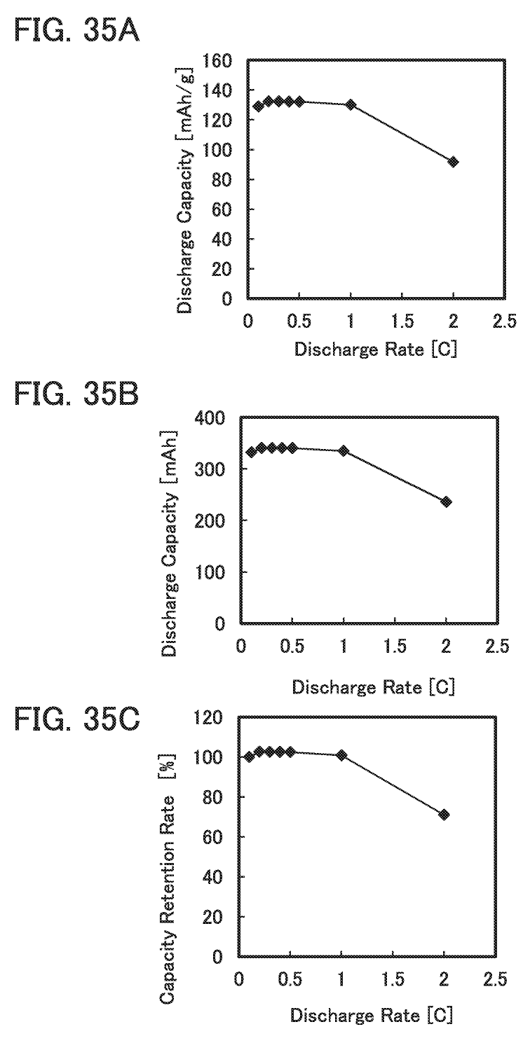

FIGS. 35A and 35B show discharge capacities at respective rates. In FIG. 35A, the horizontal axis represents discharge rate (C), and the vertical axis represents discharge capacity (mAh/g). In FIG. 35B, the horizontal axis represents discharge rate (C), and the vertical axis represents discharge capacity (mAh). FIG. 35C shows capacity retention rate, which indicates the proportion of the discharge capacity at each rate to the discharge capacity at 0.1 C. In FIG. 35C, the horizontal axis represents discharge rate (C), and the vertical axis represents capacity retention rate (%).

Table 5 lists discharge capacities and capacity retention rates at respective rates.

TABLE 5

| | | | Capacity |
|---|---|---|---|
| | Capacity | Capacity | retention rate |
| Rate [C] | [mAh/g] | [mAh] | [%] |
| 0.1 | 128.9 | 332.0 | 100.0 |
| 0.2 | 132.4 | 340.8 | 102.6 |
| 0.3 | 132.3 | 340.7 | 102.6 |
| 0.4 | 132.3 | 340.6 | 102.6 |
| 0.5 | 132.1 | 340.3 | 102.5 |
| 1 | 130.1 | 334.9 | 100.9 |
| 2 | 91.65 | 236.0 | 71.08 |

In discharging at a rate of 0.1 C to 1 C inclusive (approximately 340 mA), approximately 100% of battery capacity was able to be discharged. Even in discharging at a rate of 2 C (approximately 680 mA), approximately 71% of battery capacity was able to be discharged.

The above results show that the power storage device fabricated using one embodiment of the present invention exhibited favorable rate characteristics.

Next, the temperature characteristics of Sample 3B in discharging were measured.

The temperature characteristics were measured with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charge rate was 0.1 C, and the discharge rate was 0.2 C. The temperature in charging was 25° C., and the temperatures in discharging were varied as follows: 25° C., 10° C., 0° C., −10° C., −25° C., 40° C., 60° C., 80° C., and 100° C. Note that for calculation of the rate, 1 C was set to 135 mA/g, which was the current value per weight of the positive electrode active material. In addition, a 30-minute break was taken after each of the charging and the discharging.

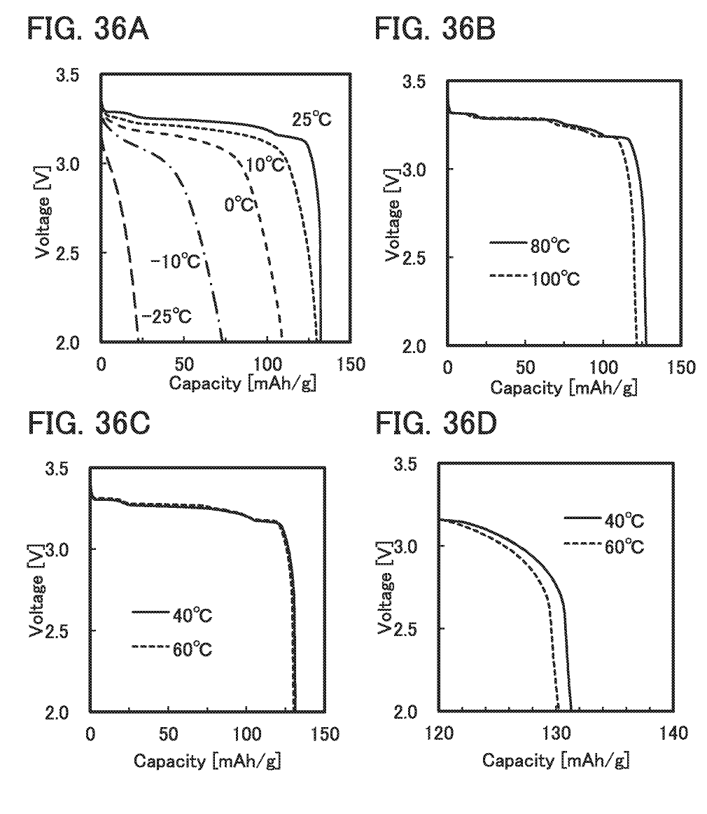

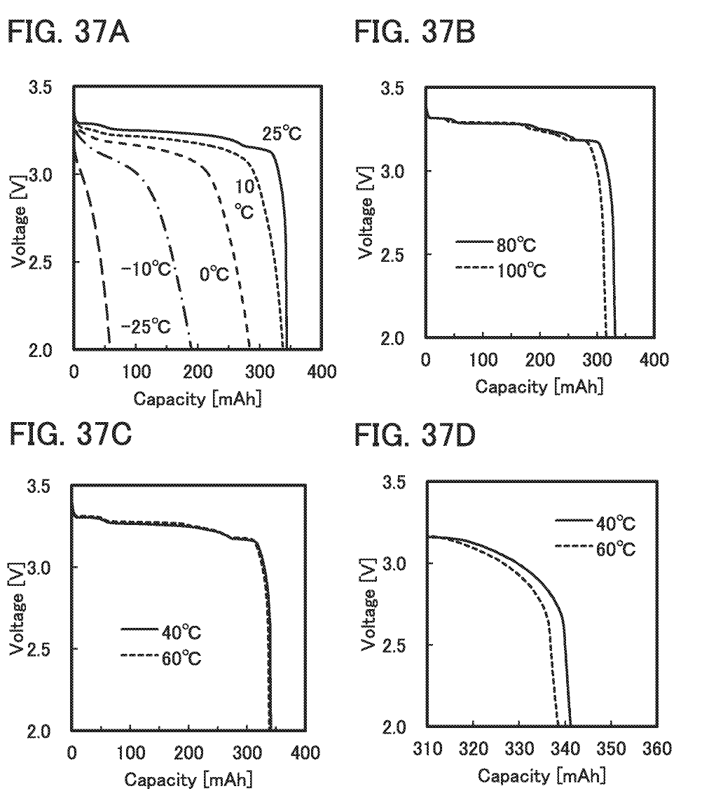

FIGS. 36A to 36D and FIGS. 37A to 37D show discharge curves of Sample 3B. In FIGS. 36A to 36D, the horizontal axis represents capacity (mAh/g), and the vertical axis represents voltage (V). In FIGS. 37A to 37D, the horizontal axis represents capacity (mAh/g), and the vertical axis represents voltage (V).

FIG. 36A and FIG. 37A show, from the left side, the results obtained when the temperatures in discharging were −25° C., −10° C., 0° C., 10° C., and 25° C. FIG. 36B and FIG. 37B show the results obtained when the temperatures in discharging were 80° C. and 100° C. FIG. 36C and FIG. 37C show the results obtained when the temperatures in discharging were 40° C. and 60° C. FIG. 36D and FIG. 37D are enlarged graphs of FIG. 36C and FIG. 37C, respectively.

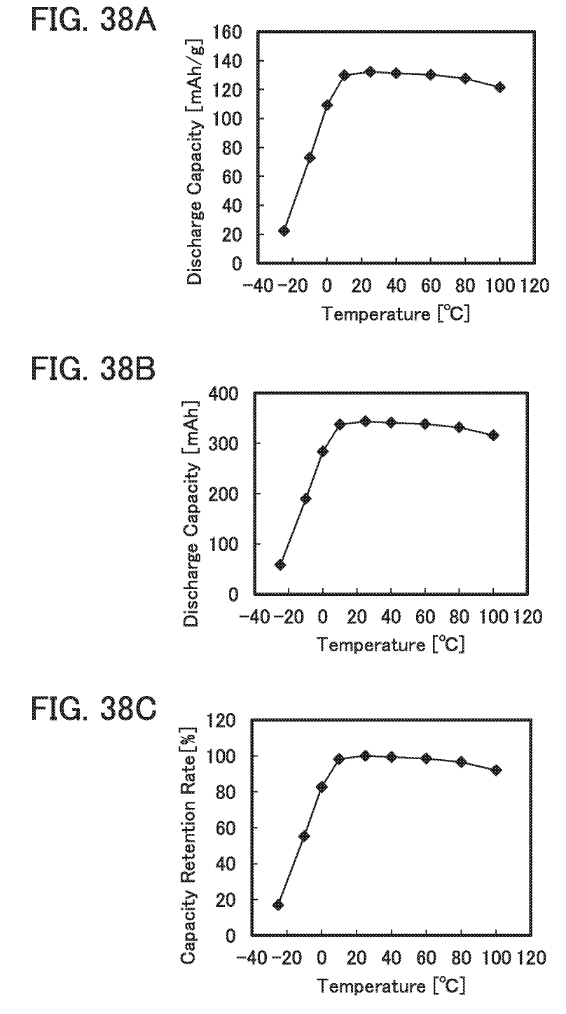

FIGS. 38A and 38B show discharge capacities at respective rates. In FIG. 38A, the horizontal axis represents temperature (° C.), and the vertical axis represents discharge capacity (mAh/g). In FIG. 38B, the horizontal axis represents temperature (° C.), and the vertical axis represents discharge capacity (mAh). FIG. 38C shows capacity retention rate, which indicates the proportion of the discharge capacity at each temperature to the discharge capacity at 25° C. In FIG. 38C, the horizontal axis represents temperature (° C.), and the vertical axis represents capacity retention rate (%).

Table 6 lists discharge capacities and capacity retention rates at respective temperatures.

TABLE 6

| | | | Capacity |
|---|---|---|---|
| | | | retention |
| Temperature | Capacity | Capacity | rate |
| [° C.] | [mAh/g] | [mAh] | [%] |
| −25 | 22.42 | 58.27 | 16.96 |
| −10 | 73.01 | 189.7 | 55.21 |
| 0 | 109.3 | 284.0 | 82.64 |
| 10 | 129.9 | 337.6 | 98.22 |
| 25 | 132.2 | 343.7 | 100.0 |
| 40 | 131.3 | 341.3 | 99.29 |
| 60 | 130.3 | 338.5 | 98.50 |
| 80 | 127.7 | 331.9 | 96.56 |
| 100 | 121.6 | 316.0 | 91.96 |

The discharge capacity at 100° C. was approximately 92% of the discharge capacity at 25° C. The discharge capacity at 0° C. was approximately 83% of the discharge capacity at 25° C. Thus, the power storage device fabricated using one embodiment of the present invention exhibited favorable charge and discharge characteristics at a wide range of temperature (e.g., at temperatures in the range of 0° C. to 100° C. inclusive) as well as at high temperature.

In general, higher heat resistance of an electrolytic solution tends to make operation at low temperature more difficult; however, the power storage device of one embodiment of the present invention exhibited favorable discharge characteristics even at 0° C.

Next, the charge and discharge cycle performances at 25° C. of Sample 3C and Comparative sample 3X were measured.

The measurement of the charge and discharge cycle performances was performed with a charge-discharge measuring instrument (produced by TOYO SYSTEM Co., LTD.) at 25° C. Constant current charging was performed until the voltage reached an upper voltage limit of 4.0 V, and constant current discharging was performed until the voltage reached a lower voltage limit of 2.0 V. The initial charge and discharge cycle was performed at 0.1 C, and a 2-hour break was taken after each of the charging and the discharging. The second and subsequent charge and discharge cycles were performed at 0.3 C, and a 10-minute break was taken after each of the charging and the discharging in each cycle. Note that as for Comparative sample 3X, one cycle of charging and discharging was performed at 0.1 C every time 200 cycles of charging and discharging were performed at 0.3 C. Note that for calculation of the rate, 1 C was set to 135 mA/g, which was the current value per weight of the positive electrode active material.

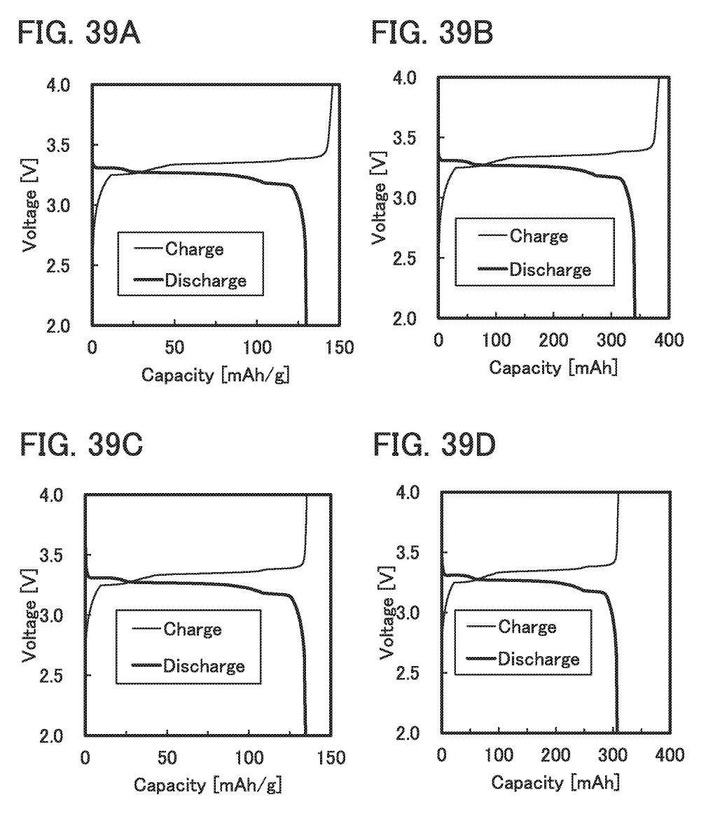

FIGS. 39A and 39B show charge and discharge curves of Sample 3C when the charge and discharge rate was 0.1 C. FIGS. 39C and 39D show charge and discharge curves of Comparative sample 3X when the charge and discharge rate was 0.1 C. In FIGS. 39A and 39C, the horizontal axis represents capacity (mAh/g), and the vertical axis represents voltage (V). In FIGS. 39B and 39D, the horizontal axis represents capacity (mAh), and the vertical axis represents voltage (V).

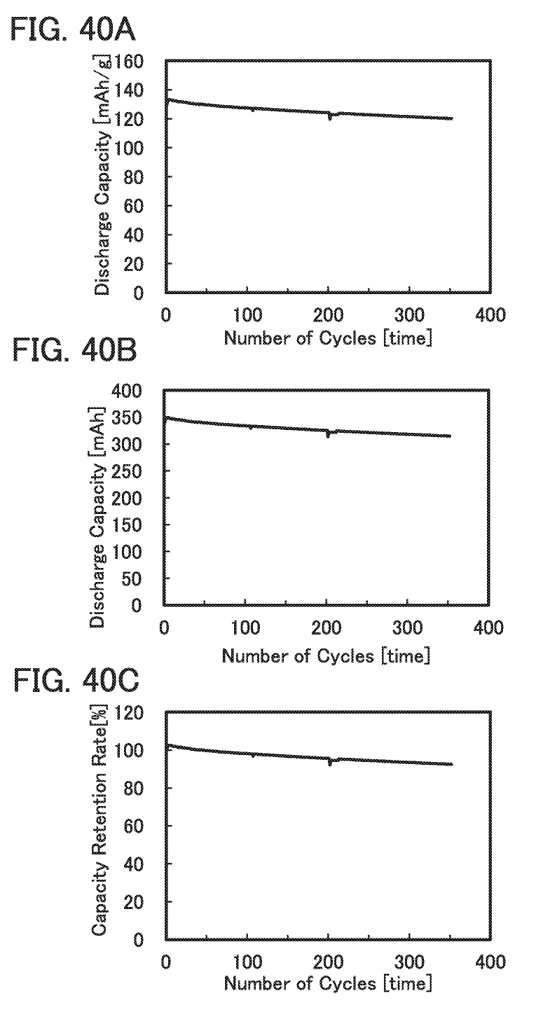

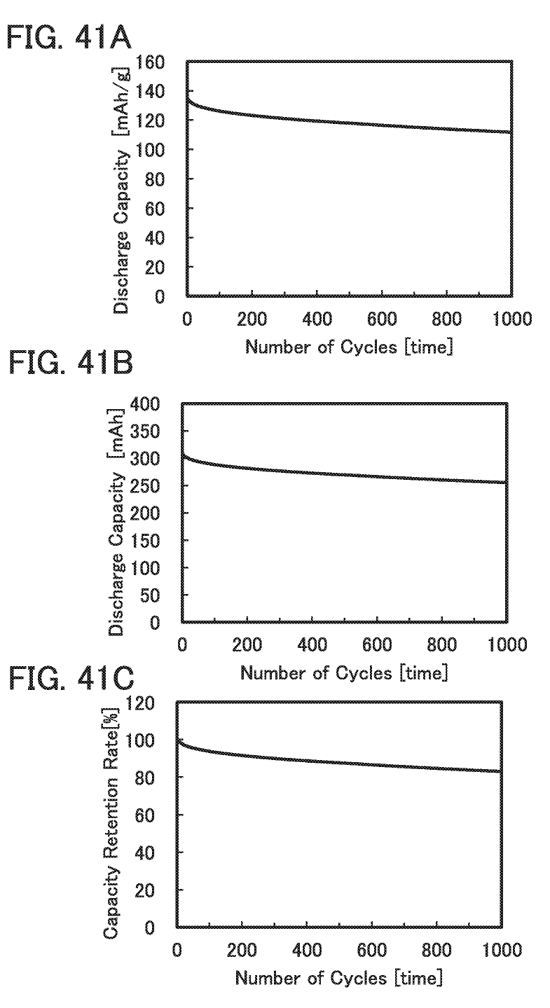

FIGS. 40A to 40C each show the charge and discharge cycle performance of Sample 3C. FIGS. 41A to 41C each show the charge and discharge cycle performance of Comparative sample 3X. In FIG. 40A and FIG. 41A, the horizontal axis represents the number of cycles (times), and the vertical axis represents discharge capacity (mAh/g). In FIG. 40B and FIG. 41B, the horizontal axis represents the number of cycles (times), and the vertical axis represents discharge capacity (mAh). In FIG. 40C and FIG. 41C, the horizontal axis represents the number of cycles (times) and the vertical axis represents the capacity retention rate (%).

Next, the charge and discharge cycle performance at 60° C. of Sample 3D was measured.

The charge and discharge cycle performance was measured with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The initial charge and discharge cycle was performed at 0.1 C at 25° C., and a 2-hour break was taken after each of the charging and the discharging. The second and subsequent charge and discharge cycles were performed at 0.3 C at 60° C., and a 10-minute break was taken after each of the charging and the discharging.

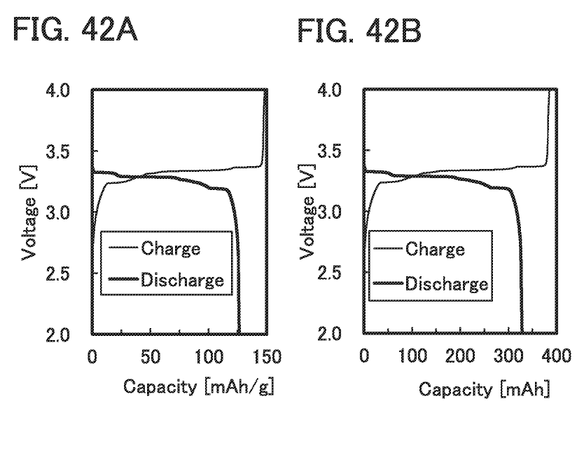

FIGS. 42A and 42B show charge and discharge curves of Sample 3D when the charge and discharge rate was 0.1 C. In FIG. 42A, the horizontal axis represents capacity (mAh/g), and the vertical axis represents voltage (V). In FIG. 42B, the horizontal axis represents capacity (mAh), and the vertical axis represents voltage (V).

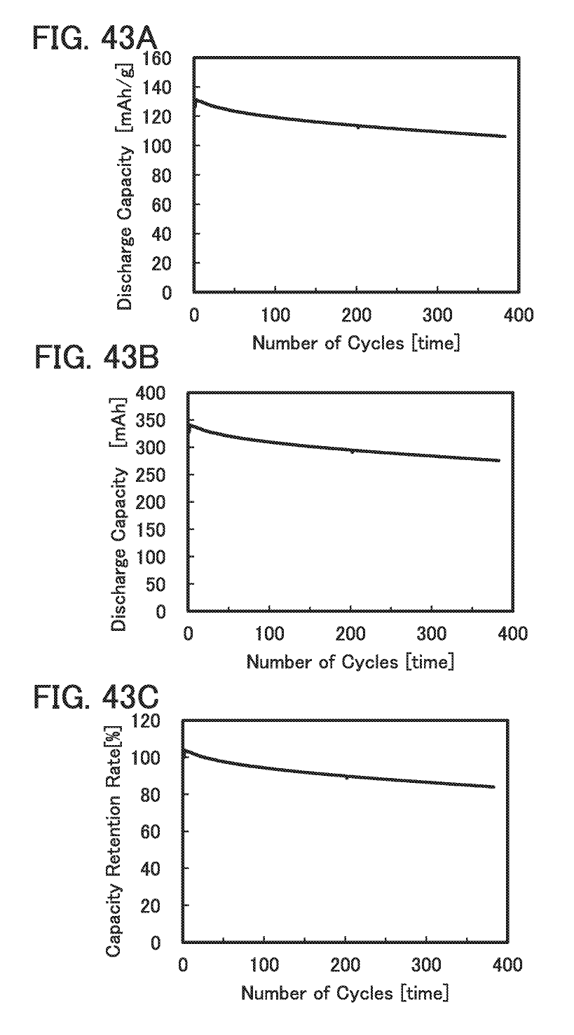

FIGS. 43A to 43C show the charge and discharge performance of Sample 3D. In FIG. 43A, the horizontal axis represents the number of cycles (times), and the vertical axis represents discharge capacity (mAh/g). In FIG. 43B, the horizontal axis represents the number of cycles (times), and the vertical axis represents discharge capacity (mAh). In FIG. 43C, the horizontal axis represents the number of cycles (times) and the vertical axis represents the capacity retention rate (%).

Next, the charge and discharge cycle performances at 100° C. of Sample 3E, Sample 3F, and Sample 3G were measured.

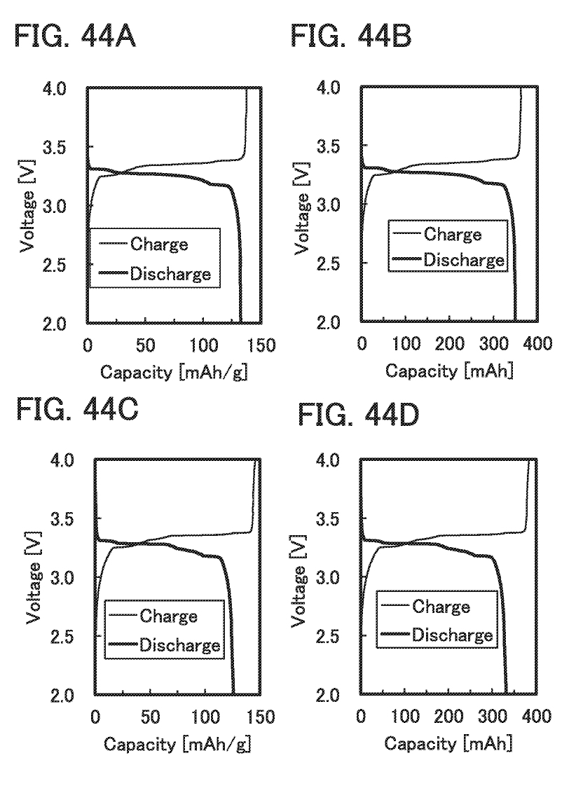

FIGS. 44A and 44B show charge and discharge curves of Sample 3E before measurement when the temperature was 25° C. In FIG. 44A, the horizontal axis represents capacity (mAh/g), and the vertical axis represents voltage (V). In FIG. 44B, the horizontal axis represents capacity (mAh), and the vertical axis represents voltage (V).

It is found from FIG. 44B that the battery capacity of Sample 3E before measurement was approximately 340 mAh and that the average discharge voltage of Sample 3E before measurement was 3.2 V.

As shown in FIGS. 44A and 44B, Sample 3E had high charge and discharge efficiency. This implies that stable charging and discharging were achieved when graphite was used for the negative electrode.

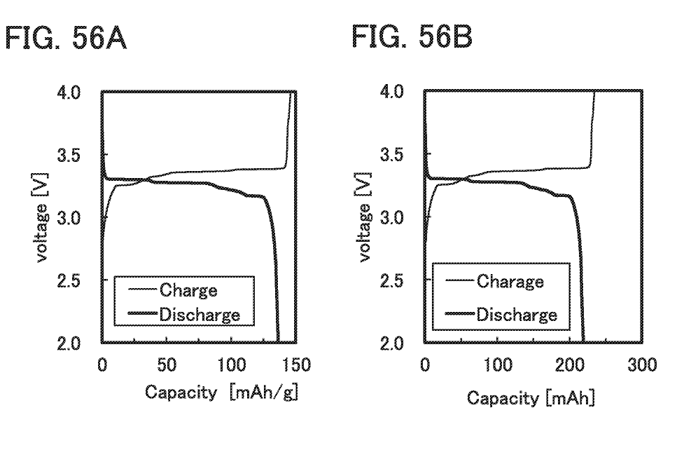

FIGS. 56A and 56B show charge and discharge curves of Sample 3G before measurement when the temperature was 25° C. In FIG. 56A, the horizontal axis represents capacity (mAh/g), and the vertical axis represents voltage (V). In FIG. 56B, the horizontal axis represents capacity (mAh), and the vertical axis represents voltage (V).

The charge and discharge cycle performance was measured with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. Charge and discharge cycles were performed at 0.3 C at 100° C., and a 10-minute break was taken after each of the charging and the discharging. Note that for calculation of the rate, 1 C was set to 135 mA/g, which was the current value per weight of the positive electrode active material.

FIGS. 44C and 44D show the initial charge and discharge curves of Sample 3E. In FIG. 44C, the horizontal axis represents capacity (mAh/g), and the vertical axis represents voltage (V). In FIG. 44D, the horizontal axis represents capacity (mAh), and the vertical axis represents voltage (V).

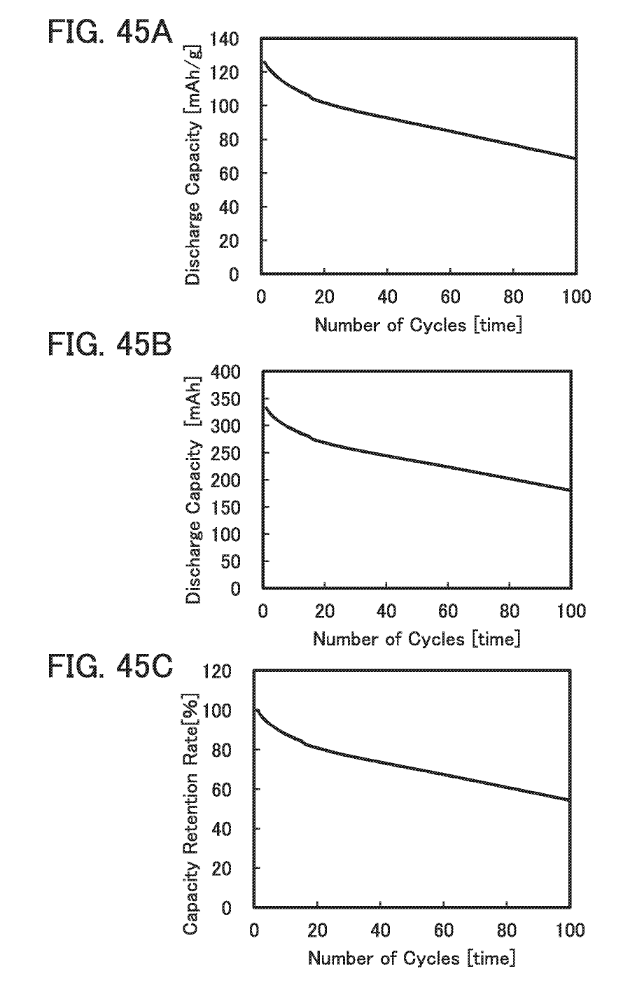

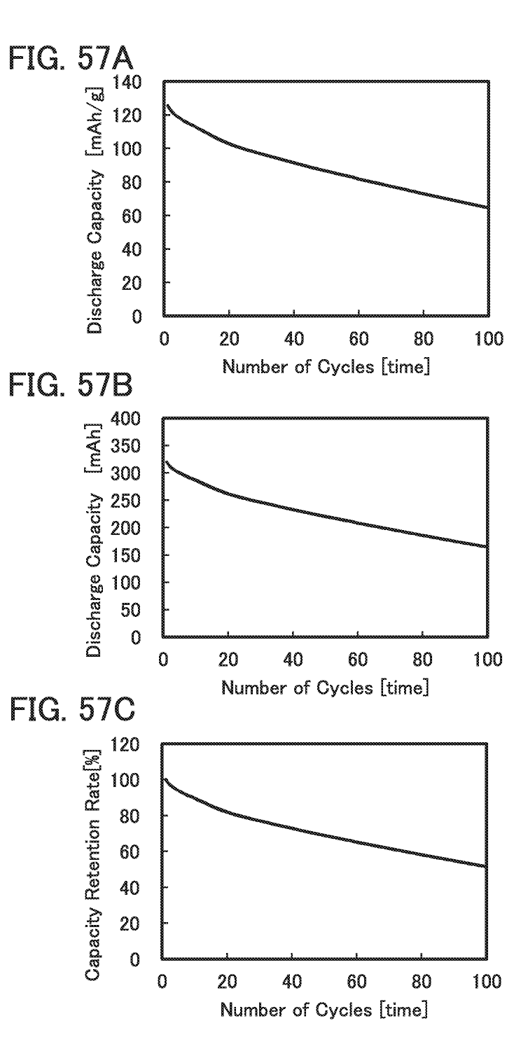

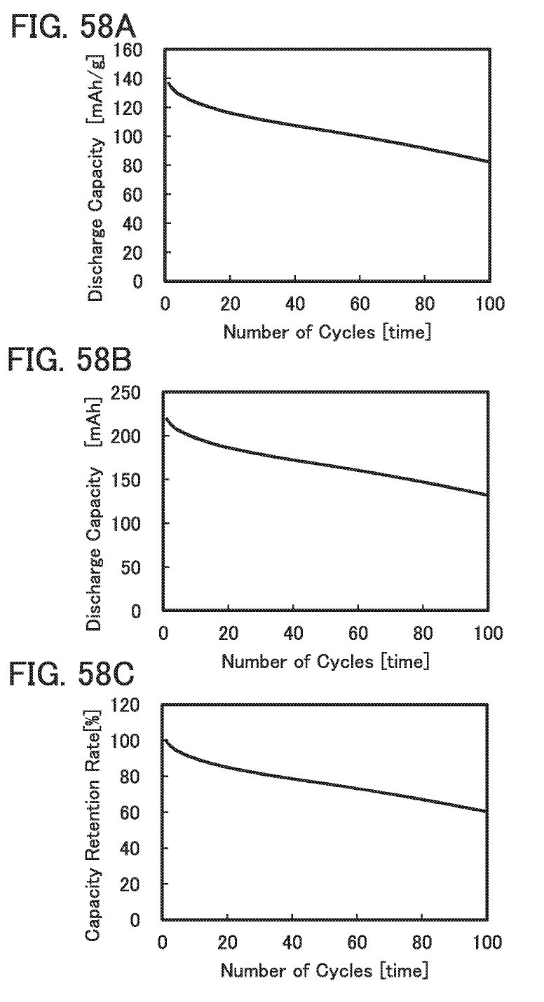

FIGS. 45A to 45C show the charge and discharge performance of Sample 3E. FIGS. 57A to 57C show the charge and discharge performance of Sample 3F. FIGS. 58A to 58C show the charge and discharge performance of Sample 3G. In FIG. 45A, FIG. 57A, and FIG. 58A, the horizontal axis represents the number of cycles (times), and the vertical axis represents discharge capacity (mAh/g). In FIG. 45B, FIG. 57B, and FIG. 58B, the horizontal axis represents the number of cycles (times), and the vertical axis represents discharge capacity (mAh). In FIG. 45C, FIG. 57C, and FIG. 58C, the horizontal axis represents the number of cycles (times) and the vertical axis represents the capacity retention rate (%).

As shown in FIG. 45C, the capacity retention rate of Sample 3E after 100 cycles was 54%. As shown in FIG. 57C, the capacity retention rate of Sample 3F after 100 cycles was 51%. Sample 3E and Sample 3F are separate samples fabricated by the same fabricating method. As described above, the capacity retention rates of Samples 3E and 3F after 100 cycles at 100° C. were each 50% or higher; thus, the reproducibility of the results were ensured.

As shown in FIG. 58C, the capacity retention rate of Sample 3G after 100 cycles was 60%. Sample 3G was different from Samples 3E and 3F in that two 46-μm-thick separators containing polyphenylene sulfide were used (in other words, the total thickness of the separators containing polyphenylene sulfide was 92 μm). When the plurality of separators containing polyphenylene sulfide were used in this manner, it was also possible to fabricate the power storage device exhibiting favorable charge and discharge cycle performance at 100° C.

The results of Samples 3C, 3D, 3E, 3F, and 3G show that the use of one embodiment of the present invention allowed fabrication of the power storage devices exhibiting favorable charge and discharge cycle performance at temperatures of 25° C., 60° C., and 100° C. Furthermore, high charge and discharge efficiency was achieved and long-time driving was possible when the temperatures were 25° C. and 60° C., and long-time driving for longer than or equal to 300 hours was possible when the temperature was 100° C.

As described above, the use of one embodiment of the present invention allowed fabrication of the power storage devices that exhibited favorable rate characteristics, that was capable of stably operating at a wide range of temperature, and that was capable of being repeatedly charged and discharged.

### Example 4

In this example, measurement results of the characteristics of the power storage device of one embodiment of the present invention that was fabricated will be described.

In this example, the battery cell 500 illustrated in FIG. 1A was fabricated.

In this example, four samples, Sample 4A fabricated using one embodiment of the present invention and Comparative samples 4B, 4C, and 4D were used.

The samples fabricated in this example each included two positive electrodes in each of which a positive electrode active material layer was provided on one surface of a positive electrode current collector and one negative electrode in which negative electrode active material layers were provided on opposite surfaces of a negative electrode current collector. In other words, the samples in this example each included two positive electrode active material layers and two negative electrode active material layers.

Materials and forming methods for the positive electrode and the negative electrode of each sample of this example were the same as those for Sample 1A of Example 1.

Specifically, in the negative electrode of each sample of this example, spherical natural graphite was used as a negative electrode active material, and CMC-Na and SBR were used for a binder. In the positive electrode of each sample of this example, LiFePO₄ was used as a positive electrode active material, PVdF was used as a binder, and acetylene black was used as a conductive additive.

Table 7 lists the averages of the active material loadings, the thicknesses, and the densities of each of the positive electrode active material layers and the negative electrode active material layers that were formed.

TABLE 7

| | | | | | Com- |
|---|---|---|---|---|---|
| | | Sample | Comparative | Comparative | parative |
| | | 4A | sample 4B | sample 4C | sample 4D |
| Positive | Loading | 7.7 | 7.6 | 7.8 | 7.8 |
| electrode | (mg/cm²) | | | | |
| | Thickness | 57 | 59 | 60 | 62 |
| | (μm) | | | | |
| | Density | 1.61 | 1.29 | 1.29 | 1.26 |
| | (g/cc) | | | | |
| Negative | Loading | 5.5 | 5.5 | 5.6 | 5.6 |
| electrode | (mg/cm²) | | | | |
| | Thickness | 60 | 60 | 61 | 59 |
| | (μm) | | | | |
| | Density | 0.95 | 0.93 | 0.91 | 0.95 |
| | (g/cc) | | | | |

The electrolytic solution used for Sample 4A was the same as that used in Example 1. Specifically, BMI-FSA was used as a solvent, and LiFSA was used as a salt. LiFSA was dissolved in BMI-FSA, so that an electrolytic solution with a LiFSA concentration of 1.8 mol/kg was prepared.

In an electrolytic solution of each of Comparative samples 4B to 4D, an organic solvent formed by mixing EC and DEC at a volume ratio of 3:7 was used as a solvent, and LiPF₆ was used as a salt. The electrolytic solution was prepared by dissolving LiPF₆ in the organic solvent at a concentration of 1.0 mol/L.

In Sample 4A fabricated using one embodiment of the present invention, a 46-μm-thick separator containing polyphenylene sulfide was used. In Comparative sample 4B, a 50-μm-thick separator containing cellulose was used. In Comparative sample 4C, one 25-μm-thick separator containing polyolefin was used. In Comparative sample 4D, a 25-μm-thick separator containing polyolefin that is different from that used in Comparative sample 4C was used.

As an exterior body, an aluminum film with opposite surfaces covered with a resin layer was used.

The fabricating methods and aging methods for the samples in this example were the same as those in Example 1 except for the following points; thus, detailed description of the methods is omitted. As for Comparative samples 4B to 4D, the step using a reduced pressure atmosphere after introduction of an electrolytic solution was performed not at −100 KPa but at −60 KPa.

The charge and discharge cycle performances at 100° C. of the samples in this example were measured with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charging and the discharging were performed at a rate of 0.3 C. Note that for calculation of the rate, 1 C was set to 170 mA/g, which was the current value per weight of the positive electrode active material. In addition, a 10-minute break was taken after each of the charging and the discharging.

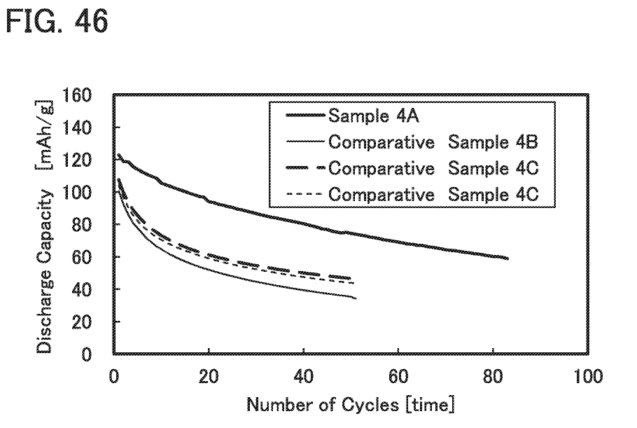

FIG. 46 shows the charge and discharge performances of the samples in this example. In FIG. 46, the horizontal axis represents the number of cycles (times), and the vertical axis represents discharge capacity (mAh/g).

The results of this example indicate that the power storage devices using a PPS separator and an electrolytic solution containing an ionic liquid, which is one embodiment of the present invention, had charge and discharge cycle performance at high temperature that was superior to those of the power storage device using a cellulose separator and an organic electrolytic solution and the power storage device using a polyolefin separator and an organic electrolytic solution.

### Example 5

In this example, a difference between the output characteristics of power storage devices that depend on the kind of cation in an ionic liquid was examined.

In this example, the battery cell 500 illustrated in FIG. 1A was fabricated.

In this example, the following two samples were used: Samples 5A and 5B.

The samples fabricated in this example each included one positive electrode in which a positive electrode active material layer was provided on one surface of a positive electrode current collector and one negative electrode in which a negative electrode active material layer was provided on one surface of a negative electrode current collector. Note that the area of a surface of the negative electrode on the active material side was larger than that of the positive electrode on the active material side.

First, methods for fabricating the electrodes will be described.

### [Fabricating Method for Negative Electrode]

Spherical natural graphite having a specific surface area of 6.3 m²/g and an average particle size of 15 μm was used as a negative electrode active material. For a binder, CMC-Na and SBR were used. The polymerization degree of CMC-Na that was used was 600 to 800, and the viscosity of a 1 wt % CMC-Na aqueous solution was in the range from 300 mPa·s to 500 mPa·s. A vapor-grown carbon fiber (VGCF (registered trademark)) was used as a conductive additive. The compounding ratio of graphite:VGCF (registered trademark):CMC-Na:SBR was set to 95:2:1.5:1.5 (wt %).

First, an aqueous solution was prepared in such a manner that CMC-Na was uniformly dissolved in pure water.

Next, a CMC-Na aqueous solution, an active material, and VGCF (registered trademark) were mixed and then kneaded using a mixer, so that first mixture was obtained.

After that, pure water serving as a solvent was added to the mixture until a predetermined viscosity was obtained, and mixing was performed.

Then, a 50 wt % SBR aqueous dispersion liquid was added to the mixture, and mixing was performed with a mixer.

Through the above steps, a slurry was formed.

Then, the slurry was applied to a negative electrode current collector with the use of a blade. The operating speed of the blade was set to 10 mm/sec. An 18-μm-thick rolled copper foil was used as the negative electrode current collector.

Subsequently, the negative electrode current collector to which the slurry was applied was heated using a hot plate at 50° C. in an air atmosphere for 30 minutes. After that, further heating was performed at 100° C. under a reduced pressure (−100 KPa) for 10 hours.

Through the above steps, the negative electrode active material layer was formed over one surface of the negative electrode current collector, so that the negative electrode was fabricated.

### [Fabricating Method for Positive Electrode]

LiFePO₄ with a specific surface area of 15.6 m²/g was used as a positive electrode active material, PVdF was used as a binder, and graphene was used as a conductive additive. Note that graphene was obtained by reducing graphene oxide, which was used to form the slurry, after application of the electrode. The compounding ratio was set to LiFePO₄:graphene oxide:PVdF=94.4:0.6:5.0 (wt %).

First, graphene oxide powder and NMP serving as a solvent were mixed with a mixer, so that a first mixture was obtained.

Then, the active material was added to the first mixture and the mixture was kneaded with a mixer, so that a second mixture was obtained.

Subsequently, PVdF was added to the second mixture and mixing was performed with a mixer, so that a third mixture was obtained.

After that, the solvent NMP was added to the third mixture and mixing was performed with a mixer. Through the above steps, a slurry was formed.

Subsequently, the slurry was applied to a positive electrode current collector with the use of a continuous coater. A 20-μm-thick aluminum current collector which had been covered with an undercoat in advance was used as the positive electrode current collector. The coating speed was set to 1.0 m/min.

Then, the solvent in the slurry applied to the positive electrode current collector was vaporized in a drying furnace. Solvent vaporization treatment was performed at 80° C. in an air atmosphere for 4 minutes.

Next, the graphene oxide was reduced. As the reduction, chemical reduction was first performed, followed by thermal reduction. A solution used for the chemical reduction was prepared as follows: a solvent in which NMP and water were mixed at 9:1 was used, and ascorbic acid and LiOH were added to the solvent to have a concentration of 77 mmol/L and 73 mmol/L, respectively. The chemical reduction was performed at 60° C. for 1 hour. After that, washing with ethanol was performed, and the solvent was vaporized in a reduced pressure atmosphere of −100 KPa at room temperature. Then, the thermal reduction was performed at 170° C. in a reduced pressure atmosphere of −100 KPa for 10 hours.

Subsequently, the positive electrode active material layer was pressed by a roll press method so as to be consolidated.

Through the above steps, the positive electrode active material layer was formed on one surface of the positive electrode current collector, so that the positive electrode was fabricated.

Table 8 lists the averages of the active material loadings, the thicknesses, and the densities of each of the positive electrode active material layers and the negative electrode active material layers that were formed.

TABLE 8

| | | Sample | Sample |
|---|---|---|---|
| | | 5A | 5B |
| Positive | Loading | 9.1 | 8.2 |
| electrode | (mg/cm²) | | |
| | Thickness | 53 | 50 |
| | (μm) | | |
| | Density | 1.81 | 1.73 |
| | (g/cc) | | |
| Negative | Loading | 4.5 | 4.1 |
| electrode | (mg/cm²) | | |
| | Thickness | 52 | 50 |
| | (μm) | | |
| | Density | 0.91 | 0.86 |
| | (g/cc) | | |

In an electrolytic solution used for Sample 5A, BMI-FSA was used as a solvent and lithium bis(trifluoromethanesulfonyl)amide (LiN(CF₃SO₂)₂N, abbreviation: LiTFSA) was used as a salt. LiTFSA was dissolved in BMI-FSA, so that an electrolytic solution with a LiTFSA concentration of 1.0 mol/kg was prepared.

In an electrolytic solution used for Sample 5B, 1-hexyl-3-methylimidazolium bis(fluorosulfonyl)amide (abbreviation: HMI-FSA) represented by the following structural formula was used as a solvent and LiFSA was used as a salt. LiTFSA was dissolved in HMI-FSA, so that an electrolytic solution with a LiTFSA concentration of 1.0 mol/kg was prepared.

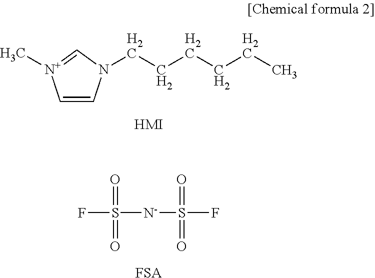

In each sample in this example, a 50-μm-thick separator containing cellulose was used.

As an exterior body, an aluminum film with opposite surfaces covered with a resin layer was used.

Next, fabrication methods for the samples will be described.

First, a positive electrode, a negative electrode, and a separator were cut. The areas of the positive electrode and the negative electrode were 8.19 cm² and 9.89 cm², respectively.

Then, the positive electrode active material and the negative electrode active material in tab regions were removed to expose the current collectors.

Then, the positive electrode, the negative electrode, and the separator were stacked. At this time, the positive electrode and the negative electrode were stacked such that the positive electrode active material layer and the negative electrode active material layer faced each other.

Then, lead electrodes were attached to the positive electrode and the negative electrode.

Then, facing parts of two of four sides of the exterior body were bonded to each other by heating.

After that, sealing layers provided for the lead electrodes were positioned so as to overlap with a sealing layer of the exterior body, and bonding was performed by heating. At this time, facing parts of a side of the exterior body except a side used for introduction of an electrolytic solution were bonded to each other.

Then, the exterior body and the positive electrode, the separator, and the negative electrode wrapped by the exterior body were heated at 80° C. under a reduced pressure atmosphere (−100 KPa) for 10 hours.

Subsequently, an electrolytic solution was introduced into a space surrounded by the exterior body in an argon gas atmosphere from one side that was not sealed. After that, the one side of the exterior body was sealed by heating in a reduced pressure atmosphere (−100 KPa). Through the above steps, each thin storage battery was fabricated.

An aging method for the samples in this example is the same as that in Example 1; thus, description thereof is omitted.

The discharge rate characteristics of the samples in this example were measured.

The measurement was performed with a charge-discharge measuring instrument (produced by TOYO SYSTEM Co., LTD.) at 25° C. Constant current charging was performed until the voltage reached an upper voltage limit of 4.0 V, and constant current discharging was performed until the voltage reached a lower voltage limit of 2.0 V. The charge rate was fixed at 0.1 C. The discharge rates were varied as follows: 0.1 C, 0.2 C, 0.3 C, 0.4 C, 0.5 C, and 1 C. Note that for calculation of the rate, 1 C was set to 170 mA/g, which was the current value per weight of the positive electrode active material.

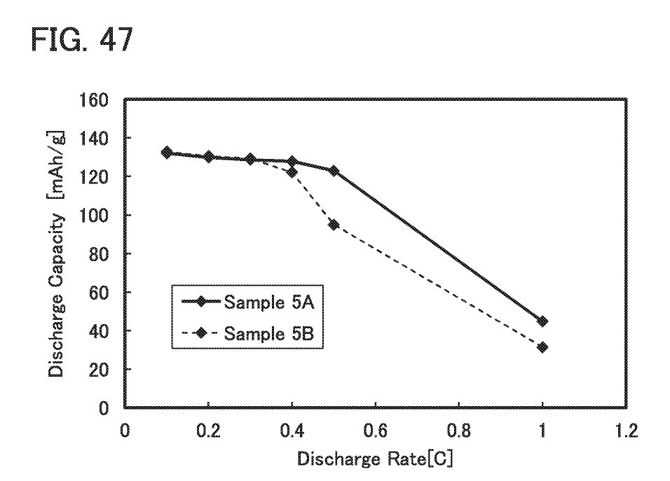

FIG. 47 shows discharge capacity with respect to rate. In FIG. 47, the horizontal axis represents discharge rate (C), and the vertical axis represents discharge capacity (mAh/g).

It is found from FIG. 47 that Sample 5A containing BMI cations had rate characteristics superior to those of Sample 5B containing HMI cations.

### Example 6

In this example, a difference between the charge and discharge cycle performances of power storage devices that depend on the kind of cation in an ionic liquid was examined.

In this example, the battery cell 500 illustrated in FIG. 1A was fabricated.

In this example, the following two samples were used: Samples 6A and 6B.

The samples fabricated in this example each included two positive electrodes in each of which a positive electrode active material layer was provided on one surface of a positive electrode current collector and one negative electrode in which negative electrode active material layers were provided on opposite surfaces of a negative electrode current collector. In other words, the samples in this example each included two positive electrode active material layers and two negative electrode active material layers.

Materials and forming methods for the positive electrode and the negative electrode of each sample of this example were the same as those for Sample 1A in Example 1. Specifically, spherical natural graphite was used as a negative electrode active material, and CMC-Na and SBR were used for a binder.

Materials and forming methods for the positive electrode and the negative electrode of each sample of this example were the same as those for the samples of Example 5. Specifically, LiFePO₄ was used as a positive electrode active material, PVdF was used as a binder, and graphene was used as a conductive additive.

Table 9 lists the averages of the active material loadings, the thicknesses, and the densities of each of the positive electrode active material layers and the negative electrode active material layers that were formed.

TABLE 9

| | | Sample | Sample |
|---|---|---|---|
| | | 6A | 6B |
| Positive | Loading | 9.9 | 9.3 |
| electrode | (mg/cm²) | | |
| | Thickness | 58 | 52 |
| | (μm) | | |
| | Density | 1.70 | 1.77 |
| | (g/cc) | | |
| Negative | Loading | 5.4 | 5.4 |
| electrode | (mg/cm²) | | |
| | Thickness | 58 | 58 |
| | (μm) | | |
| | Density | 0.93 | 0.93 |
| | (g/cc) | | |

In an electrolytic solution used for Sample 6A, 1-ethyl-3-methylimidazolium bis(fluorosulfonyl)amide (abbreviation: EMI-FSA) represented by the following structural formula was used as a solvent and LiFSA was used as a salt. LiFSA was dissolved in EMI-FSA, so that an electrolytic solution with a LiFSA concentration of 1.0 mol/kg was prepared.

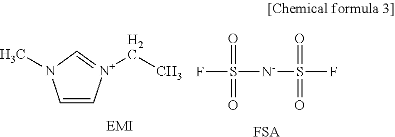

In an electrolytic solution used for Sample 6B, BMI-FSA was used as a solvent and LiFSA was used as a salt. LiTFSA was dissolved in BMI-FSA, so that an electrolytic solution with a LiTFSA concentration of 1.0 mol/kg was prepared.

In each sample in this example, a 50-μm-thick separator containing cellulose was used.

As an exterior body, an aluminum film with opposite surfaces covered with a resin layer was used.

Fabricating methods and an aging method for the samples in this example were the same as those in Example 1; thus, description thereof is omitted.

Next, the charge and discharge cycle performances at 25° C. of the samples in this example were measured. The measurement was performed with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charging and the discharging were performed at a rate of 0.3 C. Note that for calculation of the rate, 1 C was set to 170 mA/g, which was the current value per weight of the positive electrode active material. In addition, a 10-minute break was taken after each of the charging and the discharging.

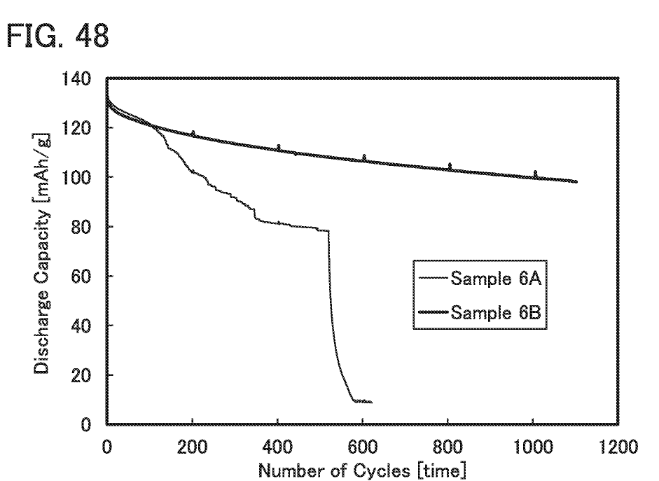

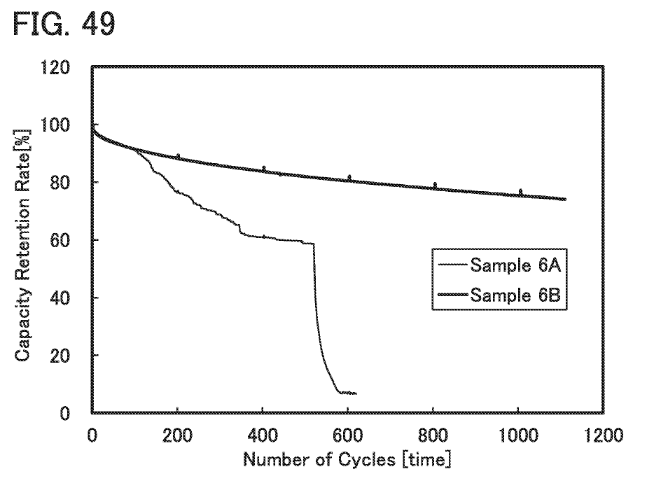

FIG. 48 and FIG. 49 each show the charge and discharge performances of the samples in this example. In FIG. 48, the horizontal axis represents the number of cycles (times), and the vertical axis represents discharge capacity (mAh/g). In FIG. 49, the horizontal axis represents the number of cycles (times) and the vertical axis represents the capacity retention rate (%).

Here, the capacity retention rate refers to the proportion of discharge capacity in each cycle to the initial discharge capacity.

The capacity retention rate of Sample 6A after 620 cycles was 7%. In contrast, the capacity retention rate of Sample 6B after 1110 cycles was 74%.

The results in this example indicate that the charge and discharge cycle performance of Sample 6B containing BMI cations was superior to that of Sample 6A using EMI cations.

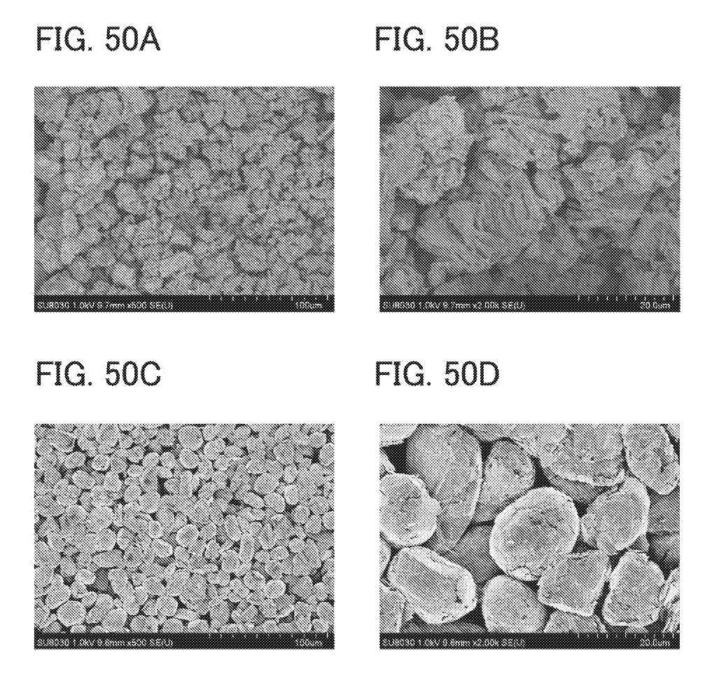

A surface of the negative electrode (graphite) after measurement of the charge and discharge cycle performance was observed with SEM. FIGS. 50A and 50B are SEM images of a negative electrode of Sample 6A, and FIGS. 50C and 50D are SEM images of a negative electrode of Sample 6B.

As shown in FIGS. 50A and 50B, graphite layers were separated from some graphite particles in the negative electrode of Sample 6A using EMI cations, and the graphite particles were expanded. This is presumably because not lithium ions but the EMI cations were intercalated between graphite layers of the graphite particles and the EMI cations were decomposed between the graphite layers, damaging the structures of the graphite particles. The expanded graphite particles cannot be involved in charge or discharges, leading to reduction in charge and discharge capacity. When the graphite particles are expanded, the specific surface areas thereof significantly increase; therefore, the decomposition of the electrolytic solution is probably more likely to occur.

In contrast, as shown in FIGS. 50C and 50D, expanded graphite particles were not observed in the negative electrode of Sample 6B containing BMI cations.

The results in this example show that when graphite was used in the negative electrode, the use of BMI cations more effectively inhibited generation of expanded graphite than the use of EMI cations.

In Example 5, Sample 5A containing BMI cations had rate characteristics superior to those of Sample 5B containing HMI cations. This also suggests that BMI cations are preferably used as cations in an ionic liquid.

In Example 1, an ionic liquid containing BMI cations was used for both the sample fabricated using one embodiment of the present invention and the comparative sample. The charge and discharge cycle performance at high temperature of the sample fabricated using one embodiment of the present invention was superior to that of the comparative sample. Furthermore, the results in Example 2 indicate that the PPS separator was significantly stable toward the ionic liquid containing BMI cations at high temperature. These imply that particularly favorable characteristics can be obtained when a separator containing polyphenylene sulfide is used in combination with an ionic liquid containing BMI cations and a negative electrode including graphite.

### Example 7

In this example, a difference between the output characteristics of power storage devices that depend on the kind and concentration of lithium salt in an ionic liquid was examined.

In this example, the battery cell 500 illustrated in FIG. 1A was fabricated.

In this example, the following four samples were used: Samples 7A, 7B, 7C, and 7D.

The samples fabricated in this example each included one positive electrode in which a positive electrode active material layer was provided on one surface of a positive electrode current collector and one negative electrode in which a negative electrode active material layer was provided on one surface of a negative electrode current collector. Note that the area of a surface of the negative electrode on the active material side was larger than that of the positive electrode on the active material side.

First, methods for fabricating the electrodes will be described.

Materials for negative electrodes of Sample 7A, Sample 7B, and Sample 7C were the same as those for the samples in Example 1. Specifically, spherical natural graphite was used as a negative electrode active material, and CMC-Na and SBR were used for a binder.

Fabricating methods for negative electrodes of Sample 7A, Sample 7B, and Sample 7C were the same as those for the samples in Example 1 except for the following points. In this example, a negative electrode active material layer was provided on one surface of a negative electrode current collector.

Materials and a fabricating method for a negative electrode of Sample 7D were the same as those for the samples in Example 5. Specifically, spherical natural graphite was used as a negative electrode active material, CMC-Na and SBR were used for a binder, and VGCF (registered trademark) was used as a conductive additive.

The same materials and the same fabricating method were used for positive electrodes of the samples in this example, and they were the same as those for the samples in Example 5. Specifically, in the positive electrode of each sample of this example, LiFePO₄ was used as a positive electrode active material, PVdF was used as a binder, and graphene was used as a conductive additive.

Table 10 lists the averages of the active material loadings, the thicknesses, and the densities of each of the negative electrode active material layers and the positive electrode active material layers that were formed.

TABLE 10

| | | Sample | Sample | Sample | Sample |
|---|---|---|---|---|---|
| | | 7A | 7B | 7C | 7D |
| Positive | Loading | 8.9 | 9.3 | 9.2 | 9.1 |
| electrode | (mg/cm²) | | | | |
| | Thickness | 55 | 50 | 55 | 53 |
| | (μm) | | | | |
| | Density | 1.71 | 1.97 | 1.77 | 1.81 |
| | (g/cc) | | | | |
| Negative | Loading | 4.6 | 4.4 | 4.6 | 4.5 |
| electrode | (mg/cm²) | | | | |
| | Thickness | 53 | 54 | 51 | 52 |
| | (μm) | | | | |
| | Density | 0.90 | 0.83 | 0.93 | 0.91 |
| | (g/cc) | | | | |

BMI-FSA was used as a solvent of an electrolytic solution.

LiFSA was used as a salt of Sample 7A. LiFSA was dissolved in BMI-FSA, so that an electrolytic solution with a LiFSA concentration of 1.8 mol/kg was prepared.

LiFSA was used as a salt of Sample 7B. LiFSA was dissolved in BMI-FSA, so that an electrolytic solution with a LiFSA concentration of 1.0 mol/kg was prepared.

Lithium bis(trifluoromethanesulfonyl)amide (abbreviation: LiTFSA) was used as a salt of Sample 7C. LiTFSA was dissolved in BMI-FSA, so that an electrolytic solution with a LiTFSA concentration of 1.8 mol/kg was prepared.

LiTFSA was used as a salt of Sample 7D. LiTFSA was dissolved in BMI-FSA, so that an electrolytic solution with a LiTFSA concentration of 1.0 mol/kg was prepared.

In e this example, a 50-μm-thick separator containing cellulose was used.

As an exterior body, an aluminum film with opposite surfaces covered with a resin layer was used.

Fabricating methods and an aging method for the samples in this example were the same as those in Example 5; thus, description thereof is omitted.

Next, the discharge rate characteristics of the samples in this example were measured.

The measurement was performed with a charge-discharge measuring instrument (produced by TOYO SYSTEM Co., LTD.) at 25° C. Constant current charging was performed until the voltage reached an upper voltage limit of 4.0 V, and constant current discharging was performed until the voltage reached a lower voltage limit of 2.0 V. The charge rate was fixed at 0.1 C. The discharge rates were varied as follows: 0.1 C, 0.2 C, 0.3 C, 0.4 C, 0.5 C, and 1 C. Note that for calculation of the rate, 1 C was set to 170 mA/g, which was the current value per weight of the positive electrode active material.

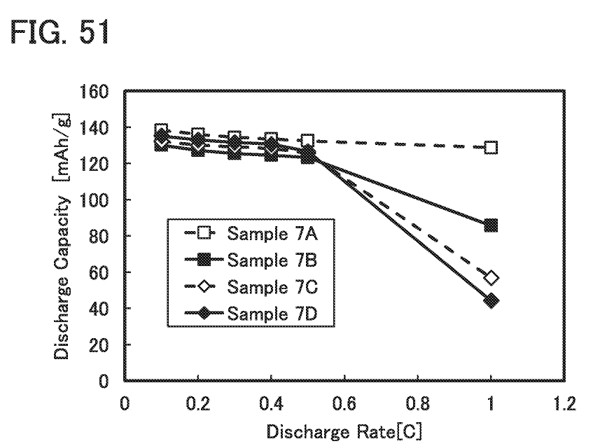

FIG. 51 shows discharge capacity with respect to rate. In FIG. 51, the horizontal axis represents discharge rate (C), and the vertical axis represents discharge capacity (mAh/g).

By comparing Sample 7A and Sample 7C and comparing Sample 7B and Sample 7D in FIG. 51, it is found that the rate characteristics of the samples using LiFSA were superior to those of the samples using LiTFSA.

Furthermore, by comparing Sample 7A and Sample 7B and comparing Sample 7C and Sample 7D in FIG. 51, it is found that the rate characteristics of the samples in which the concentration of the salt was 1.8 mol/kg were superior to those of the samples in which the concentration of the salt was 1.0 mol/kg.

The above results demonstrate that the rate characteristics of Sample 7A in which the concentration of LiFSA was 1.8 mol/kg were the most favorable.

In Example 1, the electrolytic solution in which the concentration of LiFSA was 1.8 mol/kg was used in both the sample fabricated using one embodiment of the present invention and the comparative sample. The charge and discharge cycle performance at high temperature of the sample fabricated using one embodiment of the present invention was superior to that of the comparative sample. Furthermore, the results in Example 2 indicate that the PPS separator was significantly stable toward the electrolytic solution containing LiFSA at high temperature. These imply that particularly favorable characteristics can be obtained when a separator containing polyphenylene sulfide is used in combination with an electrolytic solution containing LiFSA, preferably an electrolytic solution in which the concentration of LiFSA is 1.8 mol/kg.

### Example 8

In this example, evaluation results of the characteristics of the power storage device of one embodiment of the present invention that was fabricated will be described.

In this example, the battery cell 500 illustrated in FIG. 1A was fabricated.

In this example, Sample 8A fabricated using one embodiment of the present invention was used.

The sample fabricated in this example included two positive electrodes in each of which a positive electrode active material layer was provided on one surface of a positive electrode current collector and one negative electrode in which negative electrode active material layers were provided on opposite surfaces of a negative electrode current collector. In other words, the sample in this example included two positive electrode active material layers and two negative electrode active material layers.

Materials and forming methods for the positive electrode and the negative electrode of the sample of this example were the same as those for Sample 1A in Example 1. Specifically, in the negative electrode, spherical natural graphite was used as a negative electrode active material, and CMC-Na and SBR were used for a binder. In the positive electrode, LiFePO₄ was used as a positive electrode active material, PVdF was used as a binder, and acetylene black was used as a conductive additive.

Table 11 lists the averages of the active material loadings, the thicknesses, and the densities of each of the positive electrode active material layer and the negative electrode active material layer that were formed.

TABLE 11

| | | Sample |
|---|---|---|
| | | 8A |
| Positive | Loading | 7.8 |
| electrode | (mg/cm²) | |
| | Thickness | 64 |
| | (μm) | |
| | Density | 1.24 |
| | (g/cc) | |
| Negative | Loading | 5.5 |
| electrode | (mg/cm²) | |
| | Thickness | 58 |
| | (μm) | |
| | Density | 0.94 |
| | (g/cc) | |

The electrolytic solution used for Sample 8A was the same as that used in Example 1. Specifically, BMI-FSA was used as a solvent, and LiFSA was used as a salt. LiFSA was dissolved in BMI-FSA, so that an electrolytic solution with a LiFSA concentration of 1.8 mol/kg was prepared.

In Sample 8A fabricated using one embodiment of the present invention, a 46-μm-thick separator containing polyphenylene sulfide was used.

As an exterior body, an aluminum film with opposite surfaces covered with a resin layer was used.

Fabricating methods and an aging method for the sample in this example were the same as those in Example 1; thus, description thereof is omitted.

Next, the charge and discharge cycle performance at 130° C. of the sample in this example was measured. The measurement was performed with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charging and the discharging were performed at a rate of 0.3 C. Note that for calculation of the rate, 1 C was set to 170 mA/g, which was the current value per weight of the positive electrode active material. In addition, a 10-minute break was taken after each of the charging and the discharging.

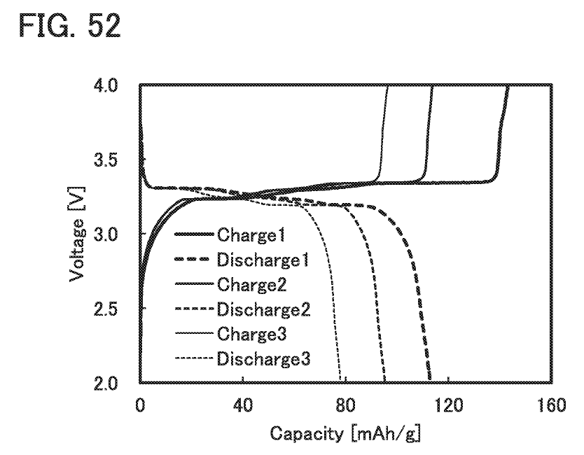

FIG. 52 shows charge and discharge curves of Sample 8A in the first to third cycles. In FIG. 52, the horizontal axis represents capacity (mAh/g), and the vertical axis represents voltage (V).

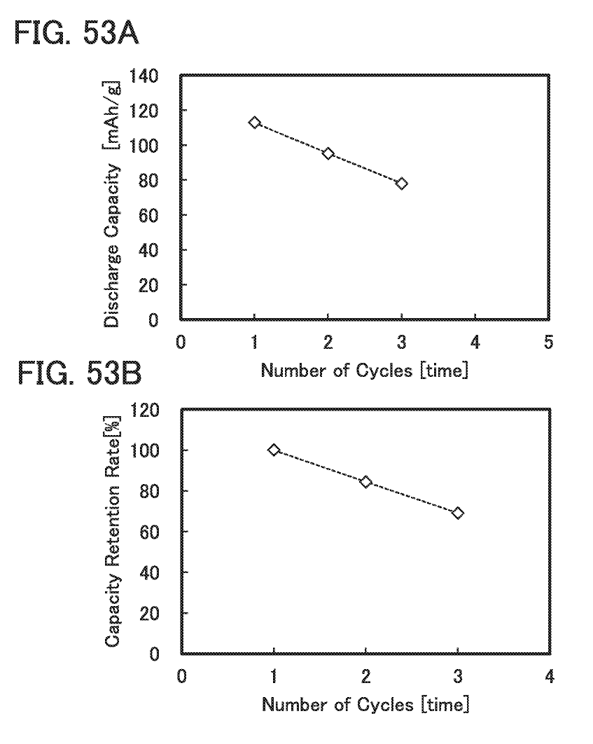

FIGS. 53A and 53B each show the charge and discharge performance of Sample 8A. In FIG. 53A, the horizontal axis represents the number of cycles (times), and the vertical axis represents discharge capacity (mAh/g). In FIG. 53B, the horizontal axis represents the number of cycles (times) and the vertical axis represents the capacity retention rate (%).

As shown in FIG. 53B, the capacity retention rate in the third cycle was approximately 70%.

The boiling points and flash points of general organic electrolytic solutions are low; for example, the boiling point of DEC is 126° C. A power storage device using DEC has a high risk of exploding when operated at higher than or equal to 126° C.; thus, it is almost impossible to operate the power storage device at higher than or equal to 126° C. In contrast, many ionic liquids do not have boiling points, are decomposed at approximately 300° C., and have a flash point of higher than or equal to 200° C.

It is found from the results in this example that the power storage device including the separator containing polyphenylene sulfide and the electrolytic solution containing an ionic liquid, which is one embodiment of the present invention, was capable of being charged and discharged at 130° C. That is to say, the use of one embodiment of the present invention enabled fabrication of the power storage device capable of operating at high temperature at which operation of a power storage device fabricated using an organic electrolytic solution is difficult.

### Example 9

In this example, light-emitting devices were each fabricated using the power storage device of one embodiment of the present invention and operated in ice-cooled water (approximately 0° C.) or boiling water (approximately 100° C.). The operation results will be described below.

In this example, the power storage device fabricated using one embodiment of the present invention, a light-emitting panel using an organic EL element, and a circuit board were fabricated. Then, the power storage device, the light-emitting panel, and the circuit board were disposed in a plastic case that transmits visible light. The plastic case was put in a plastic film that transmits visible light and sealed. Consequently, a light-emitting device was fabricated.

In this example, four kinds of light-emitting devices were fabricated using four light-emitting panels; each light-emitting panel includes a light-emitting element which emits a single color of red, blue, green, or orange.

The power storage devices in this example were fabricated using the same materials and fabricating method as those for Samples 3A to 3E in Example 3. Note that the size and weight of the power storage devices were 75 mm×60 mm×3.3 mm and approximately 16 g, respectively.

On the circuit board, a magnetic switch, a circuit capable of charging the power storage device without contact, an antenna, a circuit for driving the light-emitting panel, and the like were mounted. The light-emitting device of this example had a structure in which the light-emitting panel is capable of flashing when the magnetic switch is turned on.

In this example, to operate the light-emitting panel at high temperature, the light-emitting element was fabricated with an organic compound whose glass transition temperature was higher than or equal to a temperature at which the panel operated.

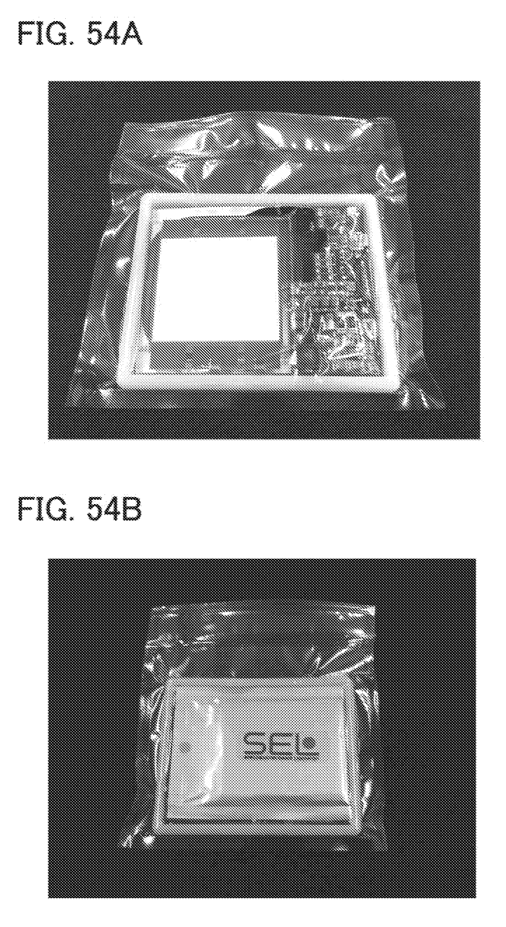

FIGS. 54A and 54B show a front surface (a light-emitting surface) and a rear surface (a surface opposite to the light-emitting surface) of the light-emitting device, respectively.

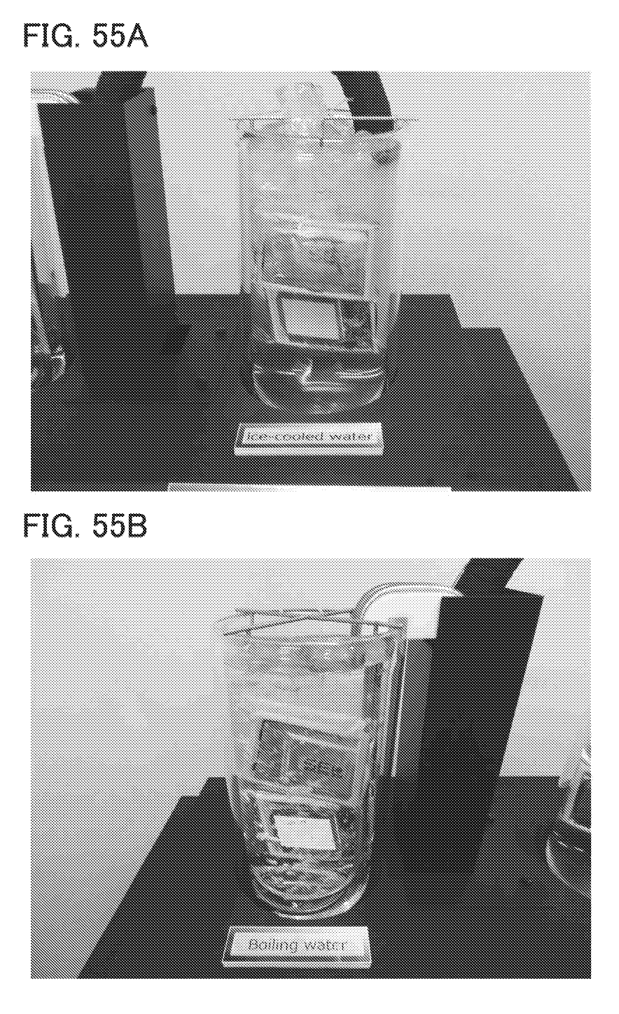

FIG. 55A is a photograph when the light-emitting device of this example emits light in ice-cooled water (approximately 0° C.). The light-emitting device emitted light (blinked) without any problem in an antifreeze solution (containing water and ethylene glycol) of approximately 0° C.

FIG. 55B is a photograph when the light-emitting device of this example emits light in boiling water (approximately 100° C.). The light-emitting device emitted light (blinked) without any problem in boiling water.

The light-emitting device of this example was capable of stably operating at high temperature and at low temperature.

As described above, the light-emitting device of this example was capable of operating in ice-cooled water (approximately 0° C.) and boiling water (approximately 100° C.).

### Example 10

In this example, evaluation results of the characteristics of the power storage device of one embodiment of the present invention that was fabricated will be described.

In this example, the battery cell 500 illustrated in FIG. 1A was fabricated.

In this example, three samples, Samples 10A, 10B, and 10C fabricated using one embodiment of the present invention, were used.

The samples fabricated in this example each included two positive electrodes in each of which a positive electrode active material layer was provided on one surface of a positive electrode current collector and one negative electrode in which negative electrode active material layers were provided on opposite surfaces of a negative electrode current collector. In other words, the samples in this example each included two positive electrode active material layers and two negative electrode active material layers.

Materials for the negative electrode of each sample in this example were the same as those for the sample in Example 1.

Specifically, in the negative electrode of each sample of this example, spherical natural graphite was used as a negative electrode active material, and CMC-Na and SBR were used for a binder.

### [Fabricating Method for Positive Electrode]

LiCoO₂ with an average particle size of 10 μm was used as a positive electrode active material, PVdF was used as a binder, and acetylene black was used as a conductive additive. The compounding ratio of LiCoO₂:acetylene black:PVdF was set to 90:5:5 (wt %).

First, acetylene black and PVdF were mixed in a mixer, so that a first mixture was obtained.

Next, the active material was added to the first mixture, so that a second mixture was obtained.

After that, a solvent NMP was added to the second mixture and mixing was performed with a mixer. Through the above steps, a slurry was formed.

Then, mixing was performed with a large-sized mixer.

Subsequently, the slurry was applied to a positive electrode current collector with the use of a continuous coater. A 20-μm-thick aluminum current collector was used as the positive electrode current collector. The coating speed was set to 0.2 m/min.

Then, the solvent in the slurry applied to the positive electrode current collector was vaporized in a drying furnace. Solvent vaporization treatment was performed at 70° C. in an air atmosphere for 7.5 minutes and then further performed at 90° C. in the air atmosphere for 7.5 minutes.

Subsequently, the positive electrode active material layer was pressed by a roll press method so as to be consolidated.

Through the above steps, the positive electrode active material layer was formed on one surface of the positive electrode current collector, so that the positive electrode was fabricated.

Table 12 lists the averages of the active material loadings, the thicknesses, and the densities of each of the positive electrode active material layers and the negative electrode active material layers that were formed.

TABLE 12

| | | Sample | Sample | Sample |
|---|---|---|---|---|
| | | 10A | 10B | 10C |
| Positive | Loading | 8.9 | 9.3 | 9.5 |
| electrode | (mg/cm²) | | | |
| | Thickness | 39 | 40 | 41 |
| | (μm) | | | |
| | Density | 2.30 | 2.35 | 2.33 |
| | (g/cc) | | | |
| Negative | Loading | 5.2 | 5.4 | 5.4 |
| electrode | (mg/cm²) | | | |
| | Thickness | 56 | 57 | 57 |
| | (μm) | | | |
| | Density | 0.93 | 0.95 | 0.96 |
| | (g/cc) | | | |

In an electrolytic solution, BMI-FSA was used as a solvent and LiFSA was used as a salt. LiFSA was dissolved in BMI-FSA, so that an electrolytic solution with a LiFSA concentration of 1.8 mol/kg was prepared.

In each of Samples 10A to 10C fabricated using one embodiment of the present invention, two 46-μm-thick separators containing polyphenylene sulfide were used.

As an exterior body, an aluminum film with opposite surfaces covered with a resin layer was used.

Fabricating methods for the samples in this example were the same as those in Example 1; thus, description thereof is omitted.

Next, aging was performed on the samples. Note that in aging, a 2-hour break was taken after each of the charging and the discharging. For calculation of the rate, 1 C was set to 170 mA/g, which was the current value per weight of the positive electrode active material.

First, constant current constant voltage charging was performed at a rate of 0.01 C at 25° C. Note that constant current constant voltage charging is a charging method in which a constant current is supplied to a sample to perform charging until the voltage reaches a predetermined voltage and then charging is performed at a constant voltage until the amount of current flow becomes small, specifically, the current value reaches a termination current value or the upper capacity limit. Here, the voltage was 4.1 V, and the upper capacity limit was approximately 10 mAh/g.

In an argon atmosphere, the exterior body was cut at one side to be opened, and degasification was performed. Then, the one side of the exterior body that was opened was sealed again in a reduced-pressure atmosphere (−100 KPa).

Next, constant current constant voltage charging was performed at a rate of 0.05 C at 25° C. The charging conditions were as follows: the upper charging voltage limit was 4.1 V, the upper capacity limit was approximately 127 mAh/g, and the lower current limit was a current value corresponding to 0.01 C.

Then, the samples were held at 40° C. for 24 hours. In an argon atmosphere, the exterior body was cut at one side to be opened, and degasification was performed. Then, the one side of the exterior body that was opened was sealed again in a reduced-pressure atmosphere (−100 KPa).

Next, constant current discharging was performed at a rate of 0.2 C at 25° C. The discharging was performed until the voltage reached a lower voltage limit of 2.5 V. Moreover, charging and discharging were performed three times at a rate of 0.2 C at 25° C. As the charging, constant current constant voltage charging was performed. The charging conditions were as follows: the upper charging voltage limit was 4.1 V, the upper capacity limit was approximately 137 mAh/g, and the lower current limit was a current value corresponding to 0.01 C. As the discharging, constant current discharging was performed. The discharging was performed until the voltage reached a lower voltage limit of 2.5 V.

Through the above steps, the samples were fabricated.

Next, the charge and discharge cycle performances of the samples in this example were measured.

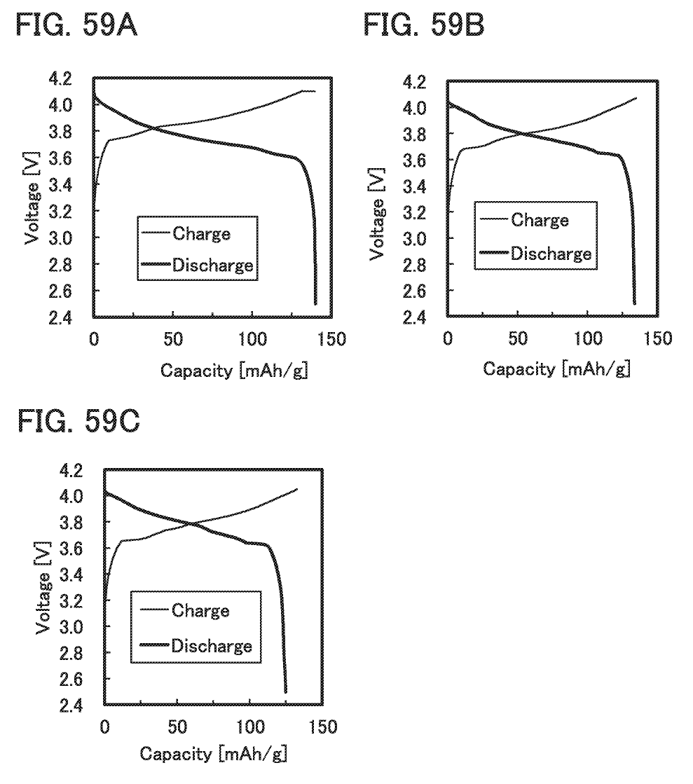

FIG. 59A shows charge and discharge curves of Sample 10A at 25° C. before measurement. FIG. 59B shows charge and discharge curves of Sample 10B at 25° C. before measurement. FIG. 59C shows charge and discharge curves of Sample 10C at 25° C. before measurement. In FIGS. 59A to 59C, the horizontal axis represents capacity (mAh/g), and the vertical axis represents voltage (V).

The charge and discharge cycle performance was measured with a charge-discharge measuring instrument (produced by TOYO SYSTEM Co., LTD.). Constant current charging was performed under the following conditions: the upper voltage limit was 4.1 V, and the upper capacity limit was 137 mAh/g. Constant current discharging was performed under the condition that the lower voltage limit was 2.5 V. Charge and discharge cycles were performed at 0.3 C, and a 10-minute break was taken after each of the charging and the discharging. Note that for calculation of the rate, 1 C was set to 137 mA/g, which was the current value per weight of the positive electrode active material.

The charge and discharge cycle performance of Sample 10A was measured at 25° C. The charge and discharge cycle performance of Sample 10B was measured at 60° C. The charge and discharge cycle performance of Sample 10C was measured at 100° C.

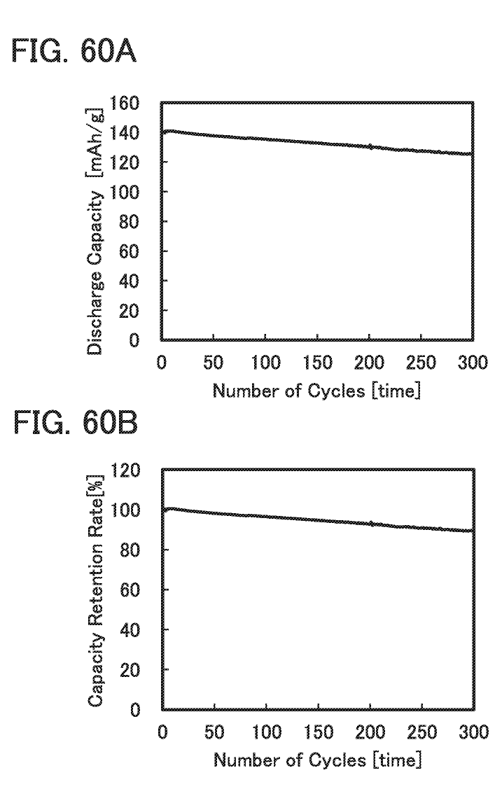

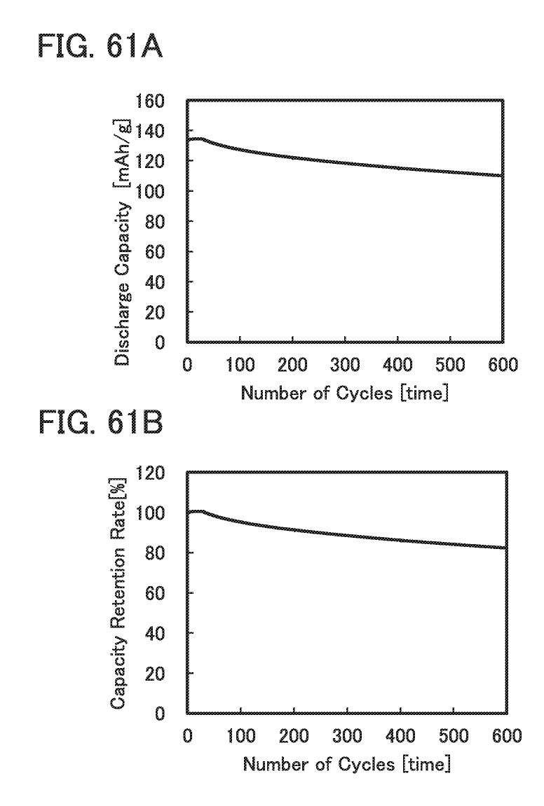

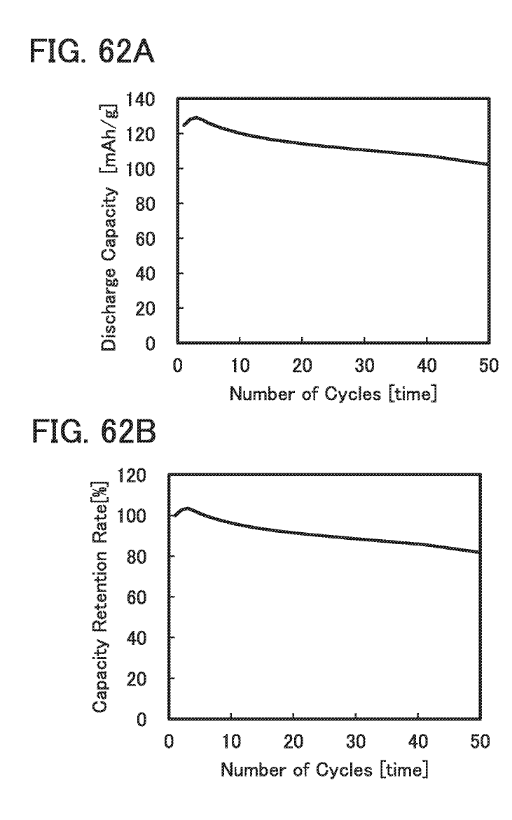

FIGS. 60A and 60B each show the charge and discharge performance of Sample 10A. FIGS. 61A and 61B each show the charge and discharge performance of Sample 10B. FIGS. 62A and 62B each show the charge and discharge performance of Sample 10C. In FIG. 60A, FIG. 61A, and FIG. 62A, the horizontal axis represents the number of cycles (times), and the vertical axis represents discharge capacity (mAh/g). In FIG. 60B, FIG. 61B, and FIG. 62B, the horizontal axis represents the number of cycles (times) and the vertical axis represents the capacity retention rate (%).

Table 13 lists the discharge capacities (mAh/g) and capacity retention rates (%) of the samples.

TABLE 13
25° C.

Sample 10A

| Number of cycles | Capacity | Capacity retention rate |
|---|---|---|
| [times] | [mAh/g] | [%] |
| Before measurement | 140.2 | 100 |
| 50 | 137.7 | 98.19 |
| 100 | 135.3 | 96.52 |
| 200 | 130.0 | 92.73 |
| 300 | 125.6 | 89.59 |

60° C.

Sample 10B

| Number of cycles | Capacity | Capacity retention rate |
|---|---|---|
| [times] | [mAh/g] | [%] |
| Before measurement | 133.7 | 100 |
| 50 | 131.5 | 98.38 |
| 100 | 127.3 | 95.25 |
| 200 | 122.2 | 91.40 |
| 300 | 118.3 | 88.52 |
| 400 | 115.2 | 86.15 |
| 500 | 112.5 | 84.13 |
| 600 | 110.0 | 82.30 |

100° C.

Sample 10C

| Number of cycles | Capacity | Capacity retention rate |
|---|---|---|
| [times] | [mAh/g] | [%] |
| Before measurement | 124.9 | 100 |
| 50 | 102.3 | 81.90 |

As shown in FIG. 60B and Table 13, the capacity retention rate of Sample 10A after 50 cycles at 25° C. was 98.19%, and the capacity retention rate thereof after 300 cycles at 25° C. was 89.59%. As shown in FIG. 61B and Table 13, the capacity retention rate of Sample 10B after 50 cycles at 60° C. was 98.38%, and the capacity retention rate thereof after 600 cycles at 60° C. was 82.30%. As shown in FIG. 62B and Table 13, the capacity retention rate of Sample 10C after 50 cycles at 100° C. was 81.9%.

Although LiFePO₄ was used as the positive electrode active materials in the samples in Example 3, LiCoO₂ was used as the positive electrode active materials in the samples in this example. It is found from the results of the samples in this example that the use of one embodiment of the present invention allowed fabrication of the power storage devices exhibiting favorable charge and discharge cycle performances at temperatures of 25° C., 60° C., and 100° C. even when LiCoO₂ was used as the positive electrode active materials.

### Example 11

In this example, evaluation results of the characteristics of the power storage device of one embodiment of the present invention that was fabricated will be described.

In this example, the battery cell 500 illustrated in FIG. 1A was fabricated.

In this example, two samples, Samples 11A and 11B fabricated using one embodiment of the present invention, were used.

The samples fabricated in this example each included one positive electrode in which a positive electrode active material layer was provided on one surface of a positive electrode current collector and one negative electrode in which a negative electrode active material layer was provided on one surface of a negative electrode current collector.

Materials for the positive electrode and the negative electrode in each sample of this example were the same as those of Sample 1A in Example 1.

Specifically, in the negative electrode of each sample of this example, spherical natural graphite was used as a negative electrode active material, and CMC-Na and SBR were used for a binder. In the positive electrode of each sample of this example, LiFePO₄ was used as a positive electrode active material, PVdF was used as a binder, and acetylene black was used as a conductive additive.

Table 14 lists the averages of the active material loadings, the thicknesses, and the densities of each of the positive electrode active material layers and the negative electrode active material layers that were formed.

TABLE 14

| | | Sample | Sample |
|---|---|---|---|
| | | 11A | 11B |
| Positive | Loading | 9.1 | 9.1 |
| electrode | (mg/cm²) | | |
| | Thickness | 72 | 72 |
| | (μm) | | |
| | Density | 1.26 | 1.27 |
| | (g/cc) | | |
| Negative | Loading | 5.5 | 5.5 |
| electrode | (mg/cm²) | | |
| | Thickness | 59 | 58 |
| | (μm) | | |
| | Density | 0.92 | 0.94 |
| | (g/cc) | | |

In the electrolytic solution, BMI-FSA was used as a solvent and LiFSA was used as a salt. LiFSA was dissolved in BMI-FSA, so that an electrolytic solution with a LiFSA concentration of 1.8 mol/kg was prepared.

In each of Samples 11A and 11B fabricated using one embodiment of the present invention, two 46-μm-thick separators containing polyphenylene sulfide were used.

As an exterior body, an aluminum film with opposite surfaces covered with a resin layer was used.

Fabricating methods for the samples in this example were the same as those in Example 5 except for the following points; thus, description thereof is omitted. In this example, the sizes of the positive electrodes and the negative electrode were each 8.19 cm².

An aging method for the samples in this example is the same as that in Example 1; thus, description thereof is omitted.

Next, measurement results of the characteristics of the samples will be described.

The discharge rate characteristics of Sample 11A were measured.

The measurement of the rate characteristics was performed with a charge-discharge measuring instrument (produced by TOYO SYSTEM Co., LTD.) at 25° C. Constant current charging was performed until the voltage reached an upper voltage limit of 4.0 V, and constant current discharging was performed until the voltage reached a lower voltage limit of 2.0 V. The charge rate was fixed at 0.1 C. The discharge rates were varied as follows: 0.1 C, 0.2 C, 0.3 C, 0.4 C, 0.5 C, 1 C, and 2 C. Note that for calculation of the rate, 1 C was set to 170 mA/g, which was the current value per weight of the positive electrode active material. In addition, a 30-minute break was taken after each of the charging and the discharging.

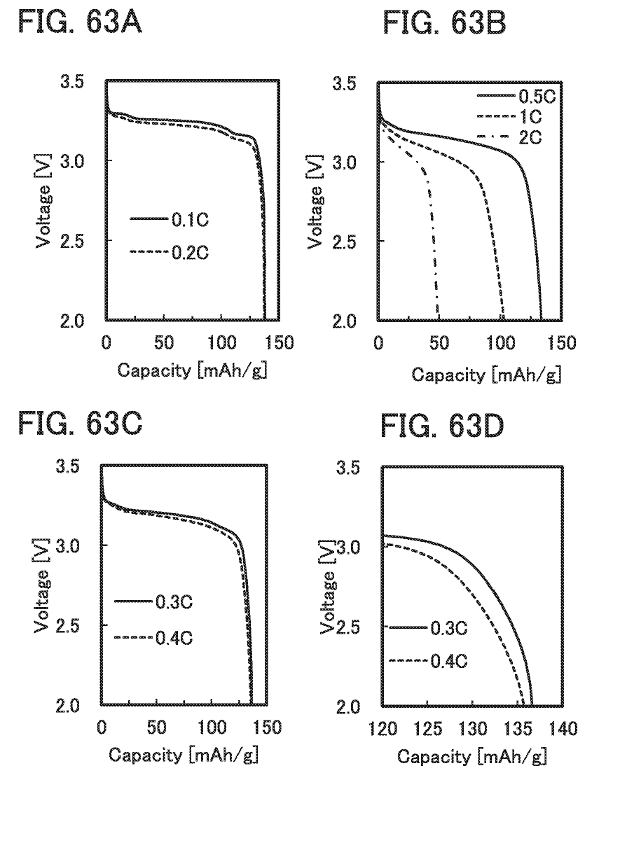

FIGS. 63A to 63D each show discharge curves of Sample 11A. In FIGS. 63A to 63D, the horizontal axis represents capacity (mAh/g), and the vertical axis represents voltage (V).

FIG. 63A shows the results obtained when the discharge rates were 0.1 C and 0.2 C. FIG. 63B shows the results obtained when the discharge rates were 0.5 C, 1 C, and 2 C. FIG. 63C shows the results obtained when the discharge rates were 0.3 C and 0.4 C. FIG. 63D is an enlarged graph of FIG. 63C.

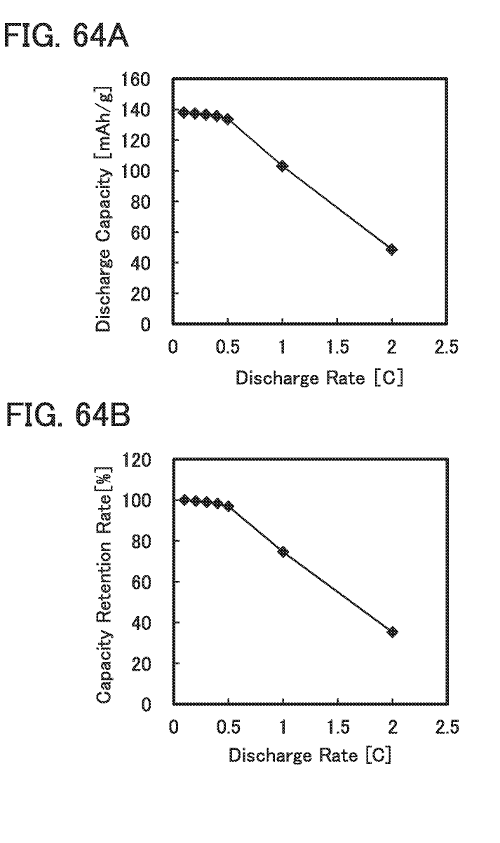

FIG. 64A shows discharge capacity with respect to rate. In FIG. 64A, the horizontal axis represents discharge rate (C), and the vertical axis represents discharge capacity (mAh/g). FIG. 64B shows capacity retention rate, which indicates the proportion of the discharge capacity at each rate to the discharge capacity at 0.1 C. In FIG. 64B, the horizontal axis represents discharge rate (C), and the vertical axis represents capacity retention rate (%).

Table 15 lists discharge capacities and capacity retention rates at respective rates.

TABLE 15

| | Capacity | Capacity retention |
|---|---|---|
| Rate [C] | [mAh/g] | rate [%] |
| 0.1 | 138.0 | 100.0 |
| 0.2 | 137.3 | 99.50 |
| 0.3 | 136.6 | 98.99 |
| 0.4 | 135.7 | 98.34 |
| 0.5 | 133.7 | 96.86 |
| 1 | 102.9 | 74.54 |
| 2 | 48.66 | 35.26 |

When discharging was performed at a rate of 0.1 C to 0.5 C inclusive, 95% or more of battery capacity was able to be discharged. The use of one embodiment allowed fabrication of the high-output power storage devices also when two separators were used for each power storage device.

The above results show that the power storage device fabricated using one embodiment of the present invention exhibited favorable rate characteristics.

Next, the temperature characteristics of Sample 11B in discharging were measured.

The temperature characteristics were measured with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charge rate was 0.1 C, and the discharge rate was 0.2 C. The temperature in charging was 25° C., and the temperatures in discharging were varied as follows: 25° C., 10° C., 0° C., −10° C., −25° C., 40° C., 60° C., 80° C., and 100° C. Note that for calculation of the rate, 1 C was set to 170 mA/g, which was the current value per weight of the positive electrode active material. In addition, a 30-minute break was taken after each of the charging and the discharging.

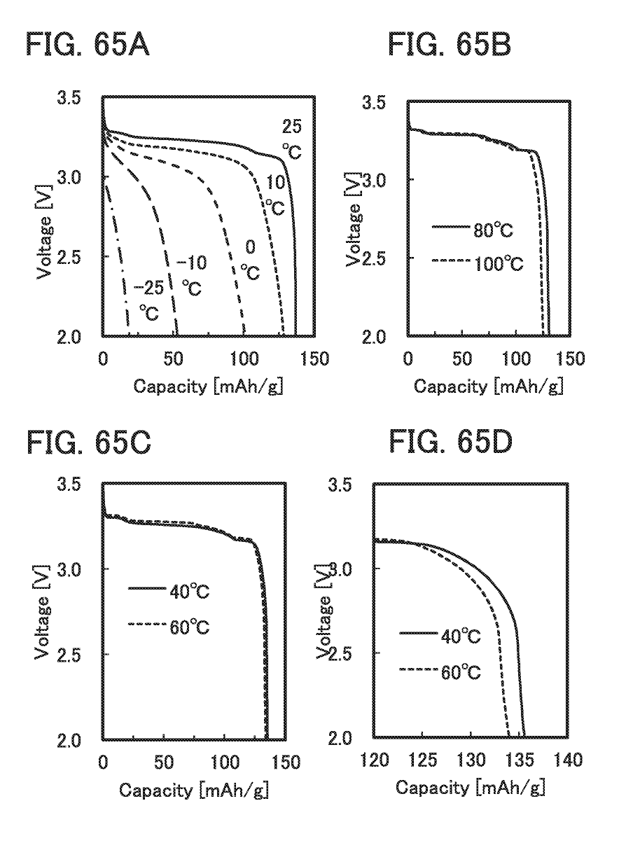

FIGS. 65A to 65D each show discharge curves of Sample 11B. In FIGS. 65A to 65D, the horizontal axis represents capacity (mAh/g), and the vertical axis represents voltage (V).

FIG. 65A shows, from the left side, the results obtained when the temperatures in discharging were −25° C., −10° C., 0° C., 10° C., and 25° C. FIG. 65B shows the results obtained when the temperatures in discharging were 80° C. and 100° C. FIG. 65C show the results obtained when the temperatures in discharging were 40° C. and 60° C. FIG. 65D is an enlarged graph of FIG. 65C.

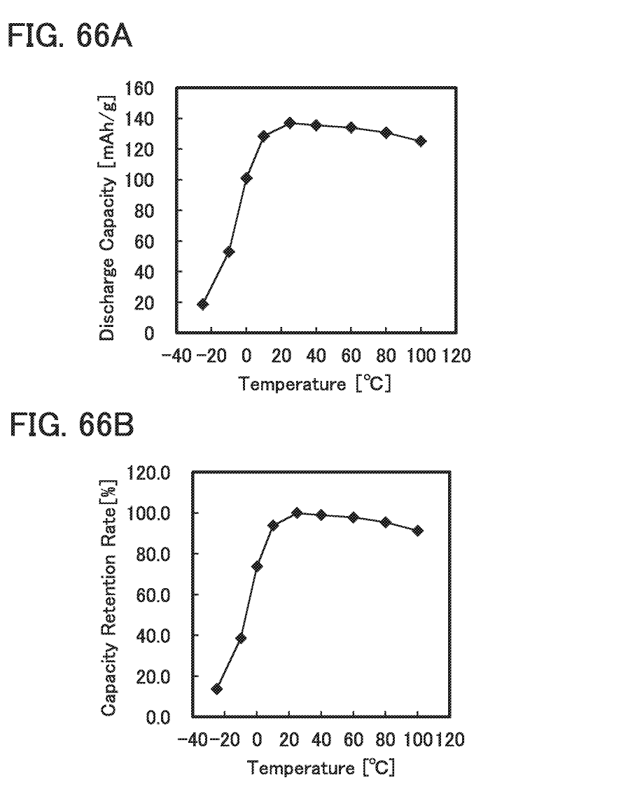

FIG. 66A shows discharge capacity with respect to rate. In FIG. 66A, the horizontal axis represents temperature (° C.), and the vertical axis represents discharge capacity (mAh/g). FIG. 66B shows capacity retention rate, which indicates the proportion of the discharge capacity at each temperature to the discharge capacity at 25° C. In FIG. 66B, the horizontal axis represents temperature (° C.), and the vertical axis represents capacity retention rate (%).

Table 16 lists discharge capacities and capacity retention rates at respective temperatures.

TABLE 16

| Temperature | Capacity | Capacity retention |
|---|---|---|
| [° C.] | [mAh/g] | rate [%] |
| −25 | 18.68 | 13.64 |
| −10 | 52.93 | 38.64 |
| 0 | 101.0 | 73.71 |
| 10 | 128.4 | 93.75 |
| 25 | 137.0 | 100 |
| 40 | 135.5 | 98.95 |
| 60 | 134.0 | 97.80 |
| 80 | 130.7 | 95.41 |
| 100 | 125.1 | 91.34 |

The discharge capacity at 100° C. was approximately 91% of the discharge capacity at 25° C. The discharge capacity at 0° C. was approximately 74% of the discharge capacity at 25° C. Thus, the power storage device fabricated using one embodiment of the present invention with the use of two separators also exhibited favorable charge and discharge characteristics at a wide range of temperature (e.g., at temperatures in the range of 0° C. to 100° C. inclusive).

In general, higher heat resistance of an electrolytic solution tends to make operation at low temperature more difficult; however, the power storage device of one embodiment of the present invention exhibited favorable discharge characteristics even at 0° C.

As described above, the use of one embodiment of the present invention allowed fabrication of the power storage devices that exhibited favorable rate characteristics and that was capable of stably operating at a wide range of temperature.

### Example 12

In this example, combustion test results of an ionic liquid and an electrolytic solution and measurement results of flash points and ignition points will be described.

In this example, the following four kinds of solutions were used.

A solution of Sample 12A was BMI-FSA, which is an ionic liquid.

A solution of Sample 12B was an electrolytic solution containing an ionic liquid. BMI-FSA and LiFSA were used as a solvent and a salt, respectively. LiFSA was dissolved in BMI-FSA, so that an electrolytic solution with a LiFSA concentration of 1.5 mol/kg was prepared.

A solution of Comparative sample 12C was an organic electrolytic solution. An organic solvent formed by mixing EC and EMC at a volume ratio of 3:7 was used as a solvent, and LiPF₆ was used as a salt. LiPF₆ was dissolved in the organic solvent, so that an electrolytic solution with a LiPF₆ concentration of 1.0 mol/kg was prepared.

A solution of Comparative sample 12D was an organic electrolytic solution. An organic solvent formed by mixing 0.5 wt % of PS, 0.5 wt % of VC, and a mixed solution containing EC, DEC, and EMC at a weight ratio of 3:6:1 was used as a solvent, and LiPF₆ was used as a salt. LiPF₆ was dissolved in the organic solvent, so that an electrolytic solution with a LiPF₆ concentration of 1.2 mol/kg was prepared.

Next, a combustion test method will be described.

First, filter paper made of glass was put on wire gauze made of stainless steel (SUS), and approximately 500 μL of each sample was dripped.

Then, the filter paper into which the solution soaked was exposed to a flame of a lighter.

Tests were finished when the filter paper caught fire or when the filter paper kept being exposed to a flame for 60 seconds and did not catch fire.

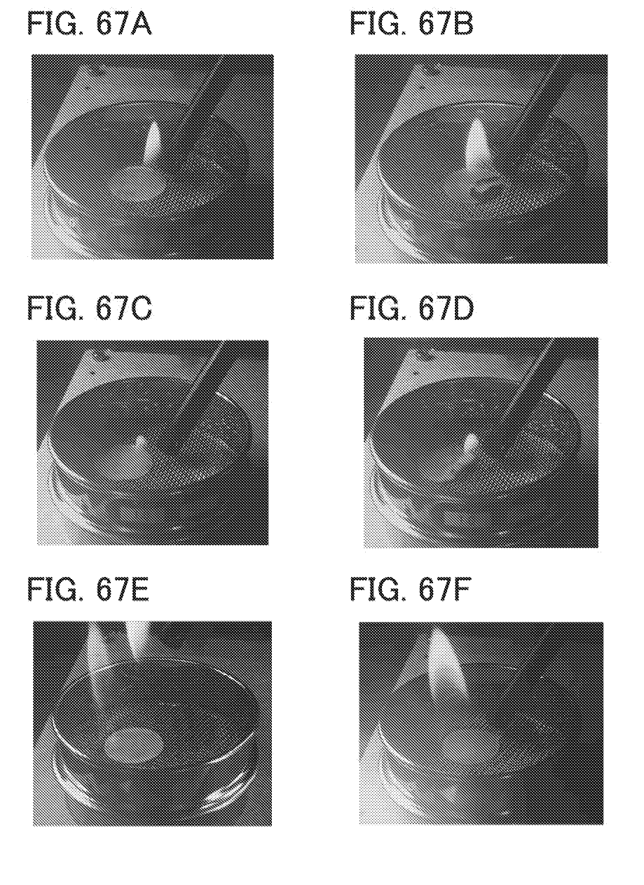

FIG. 67A is a photograph showing a state of Sample 12A just after being exposed to a flame, and FIG. 67B is a photograph showing a state of Sample 12A after being exposed to a flame for approximately 60 seconds.

FIG. 67C is a photograph showing a state of Sample 12B just after being exposed to a flame, and FIG. 67D is a photograph showing a state of Sample 12B after being exposed to a flame for approximately 60 seconds.

In the cases of Sample 12A using an ionic liquid and Sample 12B using an electrolytic solution containing an ionic liquid, the filter paper did not catch fire even when it kept being exposed to the flame for approximately 60 seconds.

FIG. 67E is a photograph showing a state of Comparative sample 12C just after being exposed to a flame, and FIG. 67F is a photograph showing a state of Comparative sample 12D just after being exposed to a flame.

In the cases of Comparative sample 12C using an organic electrolytic solution and Comparative sample 12D using an organic electrolytic solution, the filter paper burned just after or before being exposed to a flame.

The above results demonstrate that the electrolytic solution using an ionic liquid was more stable toward a flame than the organic electrolytic solution.

Next, the flash points and the ignition points of Samples 12A and 12B were measured.

The measurement of the flash points was performed using flash point tests employing a rapid equilibrium closed cup method.

First, the sample was placed in a sample cup and heated for 1 minute. Then, a burner was brought close to the sample and kept in the position for 2.5 seconds or more, and whether it caught fire was checked. The measurement was performed at 50° C. to 300° C., and different samples were used for different temperatures. In the tests, Samples 12A and 12B did not catch fire even when heated at 300° C.; thus, the flash points of each of the samples was found to be 300° C. or higher.

Flash points were measured using ASTM-E659. The measurement method will be described below.

First, each sample was put in a heat-resistant glass container, and the temperature was adjusted to be the set temperature ±1° C. Then, 100 μL of the sample was introduced into the container and whether it caught fire was observed.

When the sample did not catch fire in measurement, vapor in the container was removed with clean air, the set temperature was raised by approximately 30° C., and the above operations were repeated. When the sample caught fire in measurement, time from introduction of the sample to ignition was measured with a stop watch, and was recorded as delay time. The above operations were repeated while the temperature was lowered in steps of 3° C. until catching fire did not occur.

Next, the temperature was raised by approximately 30° C., 160 μL of the sample was introduced, and the above operations were repeated.

In the case where the lowest ignition temperature was lower in the sample of 160 μL than in the sample of 100 μL in the measurement tests, the amount of the sample was increased to 200 μL and then to 260 μL, and the tests were repeated to obtain the lowest ignition temperatures. In contrast, when the lowest ignition temperature was higher in the sample of 160 μL than in the sample of 100 μL in the measurement tests, the amount of the sample was decreased to 70 μL and then to 60 μL, and the tests were repeated to obtain the lowest ignition temperatures.

It is found from the measurement results of the ignition temperatures by the above method that the ignition temperature of Sample 12A was 453° C. and that of Sample 12B was 468° C.

### Example 13

In this example, bending test results of the power storage device of one embodiment of the present invention that was fabricated will be described.

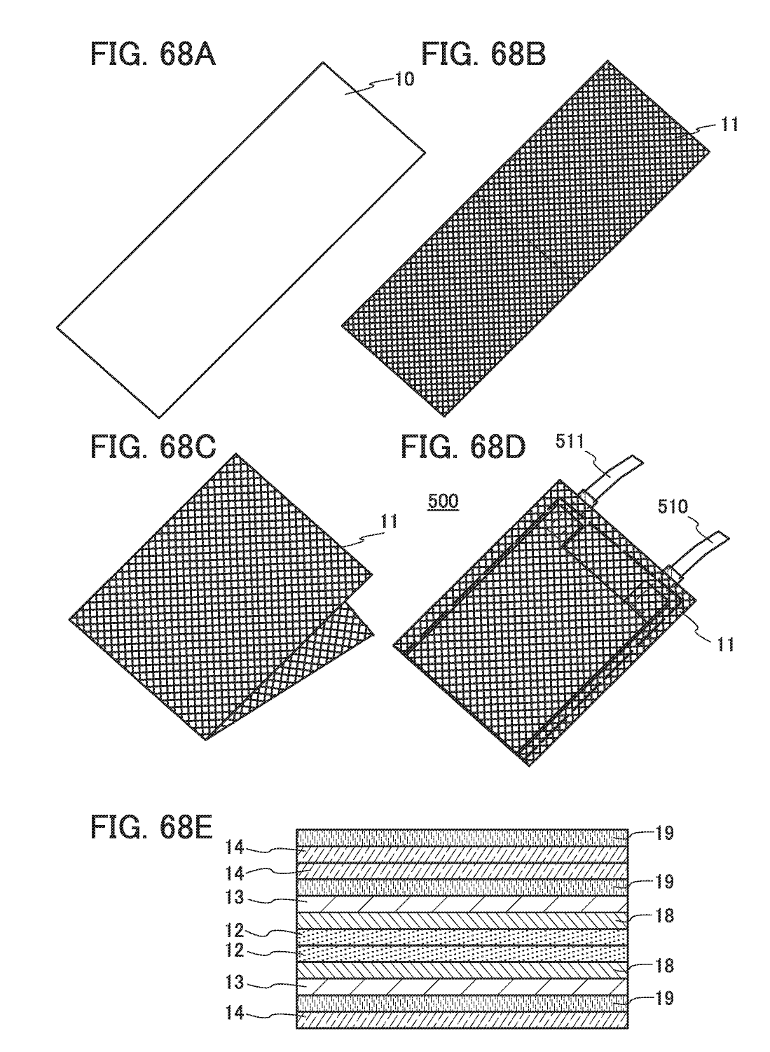

In this example, the battery cell 500 illustrated in FIG. 68A was fabricated. The battery cell 500 in FIG. 68A was different from that in FIG. 1A in that a film having a pattern of depressions or projections was used for an exterior body.

In this example, two samples, Samples 13A and 13B fabricated using one embodiment of the present invention, were used. In this example, a bending test was performed on Sample 13A, and the discharge capacities before and after the bending test were compared. Sample 13B was not subjected to a bending test, and was charged and discharged under the same conditions as those of Sample 13A. The discharge capacity of Sample 13B was compared with the discharge capacities of Sample 13A before and after the bending test.

First, the film having a pattern of depressions or projections and a forming method for the film will be described.

In one embodiment of the present invention, the pattern of the film is a geometric pattern in which lines slanted in two directions cross each other and which can be visually recognized. In the case of such a geometric pattern in which lines slanted in two directions cross each other, stress due to bending can be relieved in at least two directions. The depressions or projections are not necessarily arranged regularly and may be arranged randomly. Random arrangement enables stress due to two-dimensional bending, three-dimensional random bending, or twisting to be relieved. The film may partly include a plurality of regions having different patterns. For example, the film may be provided with different patterns in the end portion and at the center, providing one film with two types of patterns. Alternatively, the film may be provided with three or more types of patterns. The film may be provided with depressions or projections only in a bendable portion and may have a flat surface in the other portion. Note that there is no particular limitation on the shapes of depressions or projections.

The depressions or projections of the film can be formed by pressing (e.g., embossing). Note that embossing refers to processing for forming projections and depressions on a film by bringing an embossing roll whose surface has projections and depressions into contact with the film with pressure. The embossing roll is a roll whose surface is patterned.

A method that allows formation of a relief on part of the film may be employed to form the depression or projections on the film.

Examples of a film that can be used as the exterior body include a single-layer film selected from a metal film (e.g., a film using foil of a metal such as aluminum, stainless steel, nickel steel, gold, silver, copper, titanium, nichrome, iron, tin, tantalum, niobium, molybdenum, zirconium, or zinc or an alloy thereof), a plastic film, a hybrid material film containing an organic material (e.g., an organic resin or fiber) and an inorganic material (e.g., ceramic), and a carbon-containing inorganic film (e.g., a carbon film or a graphite film) or a layered film including two or more of the above films. A metal film is easy to be embossed. Metal films are easy to be embossed. Forming depressions or projections by embossing increases the surface area of the film exposed to outside air, achieving efficient heat dissipation.

In this example, a sheet made of a flexible material was prepared. As the sheet, a stack, a metal film provided with an adhesive layer (also referred to as a heat-seal layer) or sandwiched between adhesive layers, was used. As the adhesive layer, a heat-seal resin film containing, e.g., polypropylene or polyethylene was used. In this example, a sheet having a four-layer structure in which PET, a nylon resin, aluminum foil, and polypropylene were stacked in this order was used. This sheet is cut to obtain a film 10 illustrated in FIG. 68A.

Then, the film 10 was embossed to form a film 11 illustrated in FIG. 68B. As illustrated in FIG. 68B, a surface of the film 11 was provided with projections and depressions, whereby a visible pattern was formed. Although embossing was performed after the sheet was cut in this example, the order of steps is not particularly limited and the following procedure may be employed: embossing is performed before the sheet is cut, and then the sheet is cut to form the film 11 illustrated in FIG. 68B. Alternatively, the sheet may be cut after thermocompression bonding is performed with the sheet bent.

In this example, opposite surfaces of the film 10 were provided with a pattern of projections and depressions to form the film 11, the film 11 was folded in half as illustrated in FIG. 68C such that two end portions overlap with each other, and three sides were sealed with an adhesive layer as illustrated in FIG. 68D.

The samples in this example each included six positive electrodes in each of which a positive electrode active material layer was provided on one surface of a positive electrode current collector and six negative electrode in which a negative electrode active material layer was provided on one surface of a negative electrode current collector.

A layered structure with a positive electrode and a negative electrode in each sample in this example will be described with reference to FIG. 68E. The negative electrode active material layer 19 was provided on a first surface of the negative electrode current collector 14 and the separator 13 was stacked in contact with the negative electrode active material layer 19. A positive electrode active material layer 18 formed on a first surface of a positive electrode current collector 12 is in contact with a surface of the separator 13 that is not in contact with the negative electrode active material layer 19. A second surface of another positive electrode current collector 12 is in contact with a second surface of the positive electrode current collector 12. In other words, the current collectors with the same polarity are disposed such that their surfaces on each of which an active material layer is not formed are in contact with each other.

The surfaces of the current collectors on each of which an active material layer is not formed face each other and metal surfaces are in contact with each other; thus, friction force is not so strong and the surfaces on which the current collectors with the same polarity are in contact with each other slide easily. When the power storage device is bent, the metals slide in the power storage device, helping bend the power storage device.

Materials for the negative electrode of each sample in this example were the same as those for the sample in Example 1.

Specifically, in the negative electrode of each sample of this example, spherical natural graphite was used as a negative electrode active material, and CMC-Na and SBR were used for a binder.

Materials for the positive electrode of each sample in this example were the same as those for the samples in Example 10.

Specifically, in the positive electrode of each sample of this example, LiCoO₂ was used as a positive electrode active material, PVdF was used as a binder, and acetylene black was used as a conductive additive.

Table 17 lists the averages of the active material loadings, the thicknesses, and the densities of each of the positive electrode active material layers and the negative electrode active material layers that were formed.

TABLE 17

| | | Sample | Sample |
|---|---|---|---|
| | | 13A | 13B |
| Positive | Loading | 10.0 | 10.1 |
| electrode | (mg/cm²) | | |
| | Thickness | 52 | 52 |
| | (μm) | | |
| | Density | 1.94 | 1.95 |
| | (g/cc) | | |
| Negative | Loading | 5.6 | 5.7 |
| electrode | (mg/cm²) | | |
| | Thickness | 57 | 58 |
| | (μm) | | |
| | Density | 0.98 | 0.98 |
| | (g/cc) | | |

In an electrolytic solution, BMI-FSA was used as a solvent and LiFSA was used as a salt. LiFSA was dissolved in BMI-FSA, so that an electrolytic solution with a LiFSA concentration of 1.8 mol/kg was prepared.

In each of Samples 13A and 13B fabricated using one embodiment of the present invention, two 46-μm-thick separators containing polyphenylene sulfide were used.

As the exterior body, a film subjected to embossing in the aforementioned manner was used. Specifically, a film having a four-layer structure in which PET, a nylon resin, aluminum foil, and polypropylene were stacked in this order was used. Here, polypropylene was located inside a space enclosed by the exterior body.

Next, fabrication methods for the samples will be described.

First, positive electrodes, negative electrodes, and separators were cut. The area of each of the positive electrode and the negative electrode was 20.49 cm².

Then, the positive electrode active material and the negative electrode active material in tab regions were removed to expose the current collectors.

Then, the positive electrodes, the negative electrodes, and the separators were stacked. At that time, the positive electrode and the negative electrode were stacked such that the positive electrode active material layer and the negative electrode active material layer faced each other. In addition, two positive electrodes were provided such that their metal surfaces on each of which the positive electrode active material layers was not formed faced each other. Similarly, two negative electrodes were provided such that their metal surfaces on which the negative electrode active material layers were not formed faced each other.

Then, lead electrodes were attached to the positive electrode and the negative electrode.

Then, facing parts of two of four sides of the exterior body were bonded to each other by heating.

After that, sealing layers provided for the lead electrodes were positioned so as to overlap with a sealing layer of the exterior body, and bonding was performed by heating. At this time, facing parts of a side of the exterior body except a side used for introduction of an electrolytic solution were bonded to each other.

Then, the exterior body and the positive electrode, the separator, and the negative electrode wrapped by the exterior body were heated at 80° C. under a reduced pressure atmosphere (−100 KPa) for 10 hours.

Subsequently, an electrolytic solution was introduced into a space surrounded by the exterior body in an argon gas atmosphere from one side that was not sealed. After that, the one side of the exterior body was sealed by heating in a reduced pressure atmosphere (−100 KPa). Through the above steps, each thin storage battery was fabricated.

Next, aging was performed on the samples. Note that for calculation of the rate, 1 C was set to 137 mA/g, which was the current value per weight of the positive electrode active material.

First, constant current constant voltage charging was performed at a rate of 0.01 C at 25° C. The charging conditions were as follows: the upper charging voltage limit was 4.1 V, and the upper capacity limit was approximately 10 mAh/g. A 10-minute break was taken after the charging.

Then, in an argon atmosphere, the exterior body was cut at one side to be opened, and degasification was performed. After that, the one side of the exterior body that was opened was sealed again in a reduced-pressure atmosphere (−100 KPa).

First, constant current constant voltage charging was performed at a rate of 0.1 C at 25° C. The charging conditions were as follows: the upper charging voltage limit was 4.1 V, the upper capacity limit was approximately 127 mAh/g, and the lower current limit was a current value corresponding to 0.01 C. Note that in aging, a 2-hour break was taken after each of the charging and the discharging.

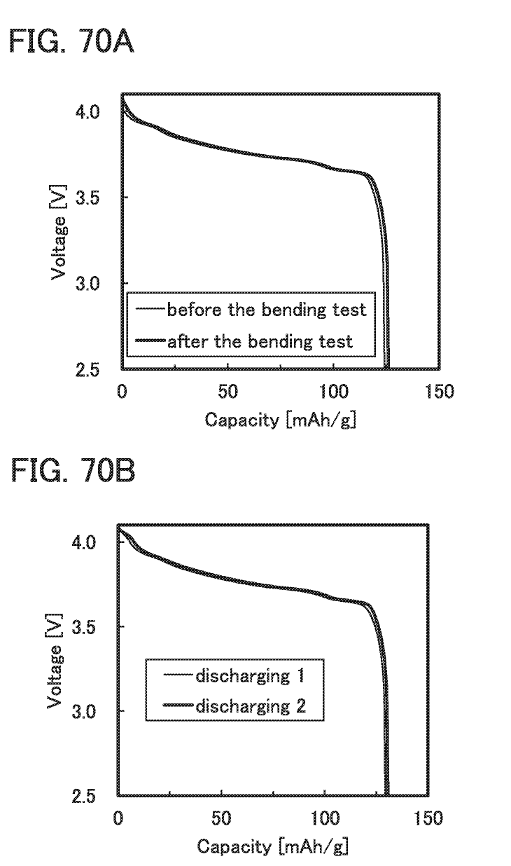

Next, constant current discharging was performed at a rate of 0.2 C at 25° C. The discharging was performed until the voltage reached a lower voltage limit of 2.5 V. Moreover, charging and discharging were performed three times at a rate of 0.2 C at 25° C. FIG. 70A shows discharge curves of Sample 13A at the time of the last discharging as results “before the bending test”. FIG. 70B shows discharge curves of Sample 13B at the time of the last discharging as results of “discharging 1”. As the charging, constant current constant voltage charging was performed. The charging conditions were as follows: the upper charging voltage limit was 4.1 V, the upper capacity limit was approximately 137 mAh/g, and the lower current limit was a current value corresponding to 0.01 C. As the discharging, constant current discharging was performed. The discharging was performed until the voltage reached a lower voltage limit of 2.5 V.

Through the above steps, the samples were fabricated.

A machine used in the bending test for this example will be described.

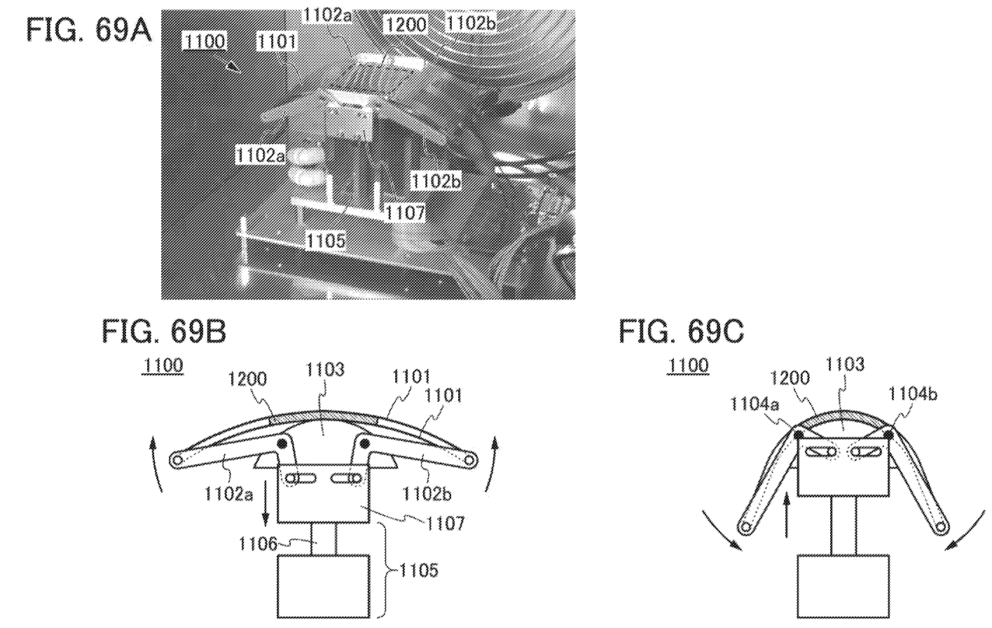

FIG. 69A is a photograph showing the appearance of a test machine 1100. FIGS. 69B and 69C are side views of the test machine 1100, which show the operation of the test machine 1100. In FIGS. 69B and 69C, some of the components of the test machine 1100 are omitted for the sake of clarity.

The fabricated power storage device 1200 (corresponding to Sample 13A) is disposed in the upper part of the test machine 1100, being interposed between a pair of support plates 1101. In FIG. 69A, the power storage device 1200 is blocked by the support plates 1101 and therefore cannot be seen directly. Thus, the power storage device 1200 is represented by a dashed line in FIG. 69A.

In the test machine 1100, a cylindrical support 1103 with a radius of 40 mm is provided directly below the power storage device 1200 to extend in the depth direction (see FIGS. 69B and 69C).

The test machine 1100 includes L-shaped arms 1102a and 1102b each having a long axis and a short axis. The test machine 1100 also includes an air cylinder 1105 having a rod 1106, and a component 1107.

The arm 1102a is provided on the left of the support 1103 with its long and short axes extending leftward and downward, respectively. The arm 1102b is provided on the right of the support 1103 with its long and short axes extending rightward and downward, respectively (see FIGS. 69B and 69C). The intersection of the long and short axes of the arm 1102a is mechanically connected to a pivot 1104a, and the intersection of the long and short axes of the arm 1102b is mechanically connected to a pivot 1104b. Note that the support 1103 and the pivots 1104a and 1104b are fixed.

The edge of the short axis of each of the arms 1102a and 1102b is mechanically connected to the component 1107. The edge of the long axis of the arm 1102a is mechanically connected to an end of the support plates 1101, and the edge of the long axis of the arm 1102b is mechanically connected to the other end of the support plates 1101.

The rod 1106 in the air cylinder 1105 can move with compressed air. For example, the rod 1106 in the air cylinder 1105 moves up and down in this example. The component 1107 is connected to the rod 1106 and moves up and down with the rod 1106.

When the component 1107 moves down, the arm 1102a rotates around the pivot 1104a, so that the edge of the long axis ascends. Also when the component 1107 moves down, the arm 1102b rotates around the pivot 1104b, so that the edge of the long axis ascends (FIG. 69B). When the component 1107 moves up, the arm 1102a rotates around the pivot 1104a, so that the edge of the long axis descends. Also when the component 1107 moves up, the arm 1102b rotates around the pivot 1104b, so that the edge of the long axis descends (FIG. 69C).

As described above, the edges of the long axes of the arms 1102a and 1102b are mechanically connected to the respective ends of the support plates 1101. When the edges of the long axes of the arms 1102a and 1102b move down, the support plates 1101 can be bent along the support 1103. In this example, the power storage device 1200 is bent while interposed between the pair of support plates 1101. Accordingly, when the edges of the long axes of the arms 1102a and 1102b move down (the component 1107 moves up), the power storage device 1200 can be bent along the cylindrical support 1103 (see FIG. 69C). Specifically, in this example, the support 1103 has a radius of 40 mm and the power storage device 1200 is bent with a curvature radius of 40 mm.

When the edges of the long axes of the arms 1102a and 1102b move up (the component 1107 moves down), there is less contact between the support 1103 and the power storage device 1200, which increases the aforementioned curvature radius (see FIG. 69B). Specifically, in this example, the aforementioned curvature radius is 150 mm when the edges of the long axes of the arms 1102a and 1102b rise highest.

Since the power storage device 1200 is bent while interposed between the pair of support plates 1101, unnecessary force can be prevented from being applied to the power storage device 1200. In addition, the whole power storage device 1200 can be bent with a uniform force.

The bending test was performed in the range of radius of curvature from 40 mm to 150 mm at intervals of 10 seconds. 1000 bending tests were performed in total. Charging and discharging were performed at 25° C. after the secondary battery was dismounted from the test machine.

As described above, in this example, the bending tests were performed on Sample 13A, and the discharge capacities before and after the bending tests were compared. Specifically, Sample 13A was discharged “before bending tests” (FIG. 70A), was charged and subjected to the bending tests, and then was discharged “after bending tests” (FIG. 70A). For comparison, Sample 13B was subjected to “discharging 1” (FIG. 70B), was not subjected to bending tests, and was charged and discharged under the same conditions as those of Sample 13A (see “discharging 2” shown in FIG. 70B). In FIGS. 70A and 70B, the horizontal axis represents capacity (mAh/g), and the vertical axis represents voltage (V).

Charging and discharging were performed at a rate of 0.2 C (34 mA) at 25° C. As the charging, constant current constant voltage charging was performed. The charging was performed as follows: constant current charging was performed until the voltage reached an upper voltage limit of 4.1 V and then constant voltage charging was performed at 4.1 V until the power storage device was fully charged. Note that the power storage device was fully charged when the charge capacity reached approximately 137 mAh/g or when the current value reached 0.01 C (1.7 mA). The discharging was performed until the voltage reached a lower voltage limit of 2.5 V. In addition, a 30-minute break was taken after each of the charging and the discharging.

As shown in FIG. 70A, the discharge capacity of Sample 13A scarcely decreased even after 1000 bending tests. Comparison between the results of Sample 13A and Sample 13B not subjected to the bending tests that are shown in FIGS. 70A and 70B also demonstrates that the discharge capacity of Sample 13A scarcely decreased by the bending tests.

X-ray CT images of Sample 13A before and after the bending tests were shot to examine whether there was a damage inside.

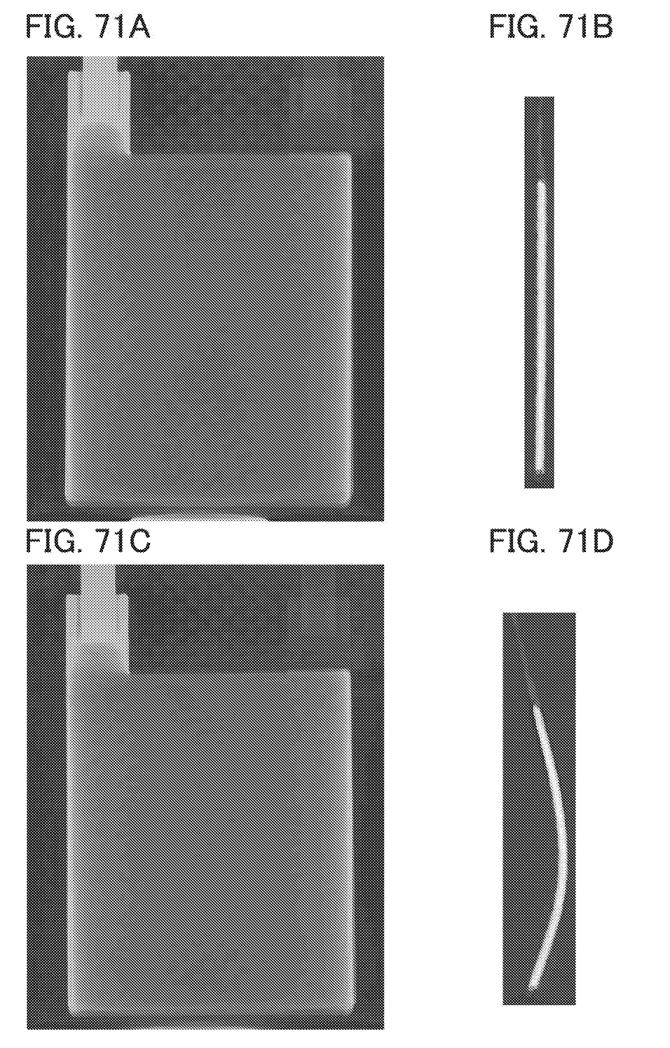

FIGS. 71A and 71B show X-ray CT images of the front surface and a side surface of Sample 13A before the bending tests. FIGS. 71C and 71D show X-ray CT images of the front surface and a side surface of Sample 13A after 1000 bendings.

The lithium-ion secondary battery using the embossed film as the exterior body did not have any damage to its appearance or its internal structure even after being subjected to 1000 bending tests.

The above results of this example show that the use of one embodiment of the present invention allowed fabrication of the flexible power storage device resistant to bending damage.

### Example 14

In this example, evaluation results of the characteristics of the power storage device of one embodiment of the present invention that was fabricated will be described.

In this example, the battery cell 500 illustrated in FIG. 1A was fabricated.

In this example, Sample 14A fabricated using one embodiment of the present invention was used.

The sample fabricated in this example included two positive electrodes in each of which a positive electrode active material layer was provided on one surface of a positive electrode current collector and one negative electrode in which negative electrode active material layers were provided on opposite surfaces of a negative electrode current collector. In other words, the sample in this example included two positive electrode active material layers and two negative electrode active material layers.

Materials and forming methods for the positive electrode and the negative electrode of the sample of this example were the same as those for Sample 1A in Example 1. Specifically, in the negative electrode, spherical natural graphite was used as a negative electrode active material, and CMC-Na and SBR were used for a binder. In the positive electrode, LiFePO₄ was used as a positive electrode active material, PVdF was used as a binder, and acetylene black was used as a conductive additive.

Table 18 lists the averages of the active material loadings, the thicknesses, and the densities of each of the positive electrode active material layer and the negative electrode active material layer that were formed.

TABLE 18

| | | Sample |
|---|---|---|
| | | 14A |
| Positive | Loading | 9.8 |
| electrode | (mg/cm²) | |
| | Thickness | 74 |
| | (μm) | |
| | Density | 1.32 |
| | (g/cc) | |
| Negative | Loading | 6.0 |
| electrode | (mg/cm²) | |
| | Thickness | 64 |
| | (μm) | |
| | Density | 0.95 |
| | (g/cc) | |

The electrolytic solution used for Sample 14A was the same as that used in Example 1. Specifically, BMI-FSA was used as a solvent, and LiFSA was used as a salt. LiFSA was dissolved in BMI-FSA, so that an electrolytic solution with a LiFSA concentration of 1.8 mol/kg was prepared.

In Sample 14A fabricated using one embodiment of the present invention, a 46-μm-thick separator containing polyphenylene sulfide was used.

As an exterior body, an aluminum film with opposite surfaces covered with a resin layer was used.

A fabricating method for the sample in this example was the same as that in Example 1; thus, description thereof is omitted.

Next, aging was performed on the sample. Note that in aging, a 2-hour break was taken after each of the charging and the discharging.

First, constant current charging was performed at a rate of 0.01 C at 25° C. The charging was performed until the voltage reached an upper voltage limit of 3.2 V. Here, the rate was calculated using the theoretical capacity (170 mAh/g) of LiFePO₄ which is a positive electrode active material as a reference.

In an argon atmosphere, the exterior body was cut at one side to be opened, and degasification was performed. Then, the one side of the exterior body that was opened was sealed again in a reduced-pressure atmosphere (−100 KPa).

Next, constant current charging was performed at a rate of 0.05 C at 25° C. The charging was performed until the voltage reached an upper voltage limit of 4.0 V. Then, constant current discharging was performed at a rate of 0.2 C at 25° C. The discharging was performed until the voltage reached a lower voltage limit of 2.0 V. Moreover, charging and discharging were performed twice at a rate of 0.2 C at 25° C. The charging was performed until the voltage reached an upper limit of 4.0 V, and the discharging was performed until the voltage reached a lower limit of 2.0 V.

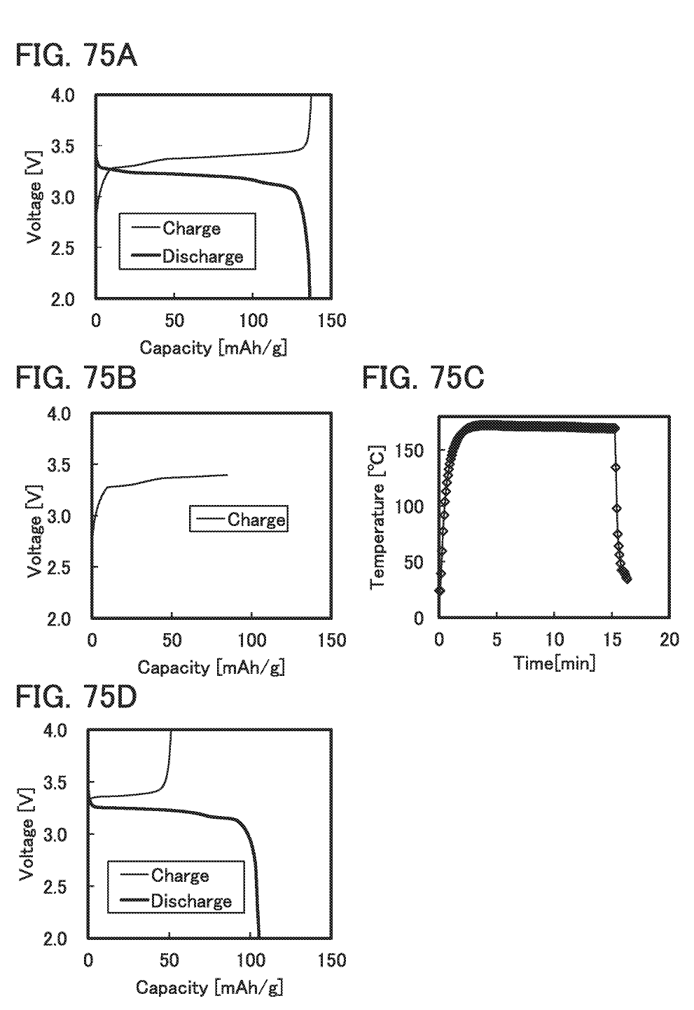

FIG. 75A shows charge and discharge curves at the time of the last charging and discharging in aging. As shown in FIG. 75A, the discharge capacity of Sample 14A was 136.3 mAh/g.

After the aging, constant current charging was performed on Sample 14A at 25° C. at a rate of 0.2 C until a capacity of 0.5 C (13.5 mAh) was stored. FIG. 75B shows a charge curve. As shown in FIG. 75B, the charge capacity of Sample 14A was 84.8 mAh/g.

The lower the potential of the negative electrode is, the decomposition of an ionic liquid is less likely to occur. Thus, in the case where the power storage device of one embodiment of the present invention is held at high temperature, it is preferably held in the state of being charged even if only slightly (not limited to the state of fully charged) compared with the fully discharged state. In this example, the sample subjected to constant current charging until a capacity of 0.5 C was stored was held at high temperature.

After a 10-minute break, Sample 14A was held at 170° C. for 15 minutes. Specifically, Sample 14A was put in a chamber where the temperature was raised to 170° C., and was held for 15 minutes. FIG. 75C shows the surface temperature of Sample 14A held at 170° C. The average surface temperature of Sample 14A after being held for 2 to 15 minutes was 170.86° C.

The charge and discharge characteristics of Sample 14A after being held at 170° C. were measured. The measurement was performed after the temperature of Sample 14A was sufficiently lowered. Specifically, Sample 14A was held at room temperature for approximately 30 minutes, and then the measurement was performed. The measurement was performed with a charge-discharge measuring instrument (produced by TOYO SYSTEM Co., LTD.). Constant current charging was performed until the voltage reached an upper voltage limit of 4.0 V, and constant current discharging was performed until the voltage reached a lower voltage limit of 2.0 V. The charging and the discharging were performed at a rate of 0.1 C. Note that a 2-hour break was taken after each of the charging and the discharging.

FIG. 75D shows charge and discharge curves of Sample 14A. In FIG. 75D, the horizontal axis represents capacity (mAh/g), and the vertical axis represents voltage (V).

As shown in FIG. 75D, the discharge capacity of Sample 14A after being held at 170° C. was 105.5 mAh/g.

Even when the power storage device of this example was held at high temperature, the PPS separator was not dissolved and the porosity of the separator was maintained. Furthermore, an electrolytic solution containing an ionic liquid was not decomposed so much. The power storage device of this example was capable of operating even after being held at high temperature.

It is found from the results in this example that the power storage device including the separator containing polyphenylene sulfide and the electrolytic solution containing an ionic liquid, which is one embodiment of the present invention, was capable of operating even after being held at 170° C.

### Reference Example

An example of synthesizing HMI-FSA used in the above example will be described.

Into a 200-mL conical flask were put 22.7 g (91.9 mmol) of 1-hexyl-3-methylimidazolium bromide, 22.1 g (101 mmol) of potassium bis(fluorosulfonyl)amide, and 40 mL of water. The resulting solution was stirred for 19 hours at room temperature. After the stirring, an aqueous layer of the mixture was subjected to extraction with dichloromethane. The extracted solution and an organic layer were combined and the mixture was washed with water, and then, the organic layer was dried with magnesium sulfate. The mixture was gravity filtered, and the obtained filtrate was concentrated to give a liquid. The liquid was dried, so that the 28.6 g of the target yellow liquid was obtained with a yield of 89%.

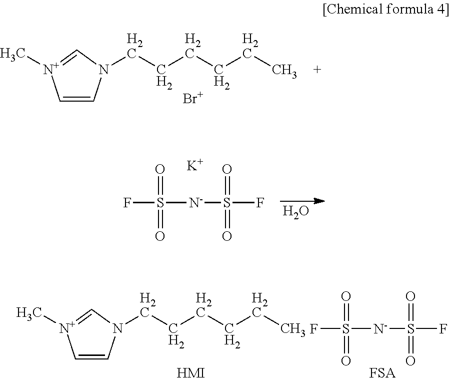

By a nuclear magnetic resonance (NMR) method, the compound synthesized through the above steps was identified as the target HMI-FSA.

¹H NMR data of the obtained compound is shown below. ¹H NMR (CDCl₃, 300 MHz): δ=0.86-0.91 (m, 3H), 1.33-1.37 (m, 6H), 1.83-1.91 (m, 2H), 3.96 (s, 3H), 4.18 (t, J=7.8 Hz, 2H), 7.27-7.30 (m, 2H), 8.66 (s, 1H).

This application is based on Japanese Patent Application serial no. 2015-045692 filed with Japan Patent Office on Mar. 9, 2015 and Japanese Patent Application serial no. 2015-110615 filed with Japan Patent Office on May 29, 2015, the entire contents of which are hereby incorporated by reference.

What is claimed is:

1. A power storage device comprising:
a positive electrode;
a negative electrode;
a separator; and
an electrolytic solution,
wherein the separator is located between the positive electrode and the negative electrode,
wherein the separator contains polyphenylene sulfide, and
wherein the electrolytic solution contains an ionic liquid and an alkali metal salt.

2. The power storage device according to claim 1,
wherein the alkali metal salt is a lithium salt.

3. The power storage device according to claim 1,
wherein the ionic liquid contains a cation and an anion,
wherein the cation contains a five-membered heteroaromatic ring with one or more substituents, and
wherein a total number of carbons in the one or more substituents is more than or equal to 2 and less than or equal to 10.

4. The power storage device according to claim 3,
wherein the cation is an imidazolium cation.

5. The power storage device according to claim 3,
wherein the cation is a 1-butyl-3-methylimidazolium cation.

6. The power storage device according to claim 1,
wherein the negative electrode contains graphite.

7. The power storage device according to claim 1,
wherein the power storage device has flexibility.

8. The power storage device according to claim 1,
wherein discharge capacity at 0° C. is 80% or more of that at 25° C., and
wherein discharge capacity at 100° C. is 80% or more of that at 25° C.

9. An electronic device comprising:
the power storage device according to claim 1; and
a display device, an operation button, an external connection port, an antenna, a speaker, or a microphone.
